(19) United States
(12) Patent Application Publication
(10) Pub. No.: US 2019/0066204 A1
(43) Pub. Date: Feb. 28, 2019

(54) SYSTEM FOR ISSUING AND MANAGING EXCHANGE TRADED PRODUCTS AS FINANCIAL INSTRUMENTS AND ASSOCIATED METHOD

(71) Applicant: FlexFunds Ltd., Grand Cayman (KY)

(72) Inventors: Bernardo Teixeira, North Miami Beach, FL (US); Mario Rivero, Miami, FL (US)

(21) Appl. No.: 15/692,025

(22) Filed: Aug. 31, 2017

(51) Int. Cl. G06Q 40/04; G06Q 40/06; G06Q 20/10

(52) U.S. Cl. CPC G06Q 40/04; G06Q 20/10; G06Q 40/06

(57) ABSTRACT

A system of issuing and managing financial assets for a plurality of clients includes a transaction server, a securities issuance server, and a communications network coupling both. The transaction server generates client financial data and client documentation and stores client documentation in a database server network located remote from the transaction server. Client financial data is stored in a non-relational database. The securities issuance server issues the ETP series and includes issued series data. A relational database stores the issued series data. Changes in the issued series data and client financial data are tracked over time and the relational and non-relational databases are periodically updated.

### FIELD OF THE INVENTION

The present invention relates to the field of financial assets, and more particularly, this invention relates to controlling financial assets by improving computer operation with increased functionality, speed and efficiency in computer processing and its use of non-relational and relational databases, cloud-based storage networks, data transfer, data generation, client reporting, and asset accounting.

### BACKGROUND OF THE INVENTION

Exchange Traded Products (ETP's), sometimes referred to as Exchange Traded Funds (ETF's) can be a basket of stocks that are traded within the day. They can be shorted and purchased on margin. There are even options on some ETP's. They are a type of security that is derivatively priced and trades intra-day on a National Securities Exchange whether in the United States, Europe or other countries, and are usually priced so the value is derived from other investment instruments, such as a share price, currency, commodity or even interest rate. They are usually benchmarked to stocks, commodities or indices in most cases, but some issuers have been branching out so their ETP's cover other investments. They also can be close-ended funds or open-ended funds, and either passively or actively managed.

Although the Exchange Traded Product is the general term to cover these types of products, according to some issuers and investors, the categories may include Exchange-Traded Funds (ETF's), Exchange-Traded Vehicles (ETV's), Exchange-Traded Notes (ETN's), and Exchange-Traded Certificates as examples. Growth has been rapid in the last few years and as of June 2016, there are about 1.26 trillion in total Assets Under Management (AUM) for ETF's. Global Exchange Traded Product assets may top 3 trillion soon according to some estimates. These investments have a low-cost structure because many are lower-cost index funds and not actively managed.

Usually an ETP trades close to its Net Asset Value (NAV) over the course of a trading day. In many cases, ETP distributors buy or sell ETP's directly from or to authorized participants, which typically are large broker-dealers. Large blocks of ETP shares are exchanged in-kind with baskets of the underlying securities. Other investors may use a retail broker to trade ETP shares. One aspect to help understand the structure is that an ETP is a type of fund owning assets such as bonds, stocks, gold, other commodities, or even real estate, and divides the ownership into shares that are held by the shareholders, investors or clients. The structure for the issuer as an example could be a corporation or trust, which may vary by country. There may be multiple structures in some cases, however. There are many reporting requirements associated with the issuance, maintenance and sale of ETP's, different regulations per jurisdiction, and different countries and participants may require different reports with different standards. Example participants may include the issuer, trustee, auditor, issuing agent, a paying agent, and a depository, and an arranger of the funds, a program manager and a broker. Clients may vary from large to small companies to individuals. The database requirements for the entire ETP process are complex. Often dates are missed for interest payments, collections, or other critical and non-critical matters. Even data processing bogs down each day because of the ETP process complexity. A more enhanced and efficient system that allows computers, cloud-based services and databases related to the ETP process to operate better and more efficiently would be advantageous.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

A system of issuing and managing financial assets for a plurality of clients comprises a transaction server comprising a processor, memory and communications module, a securities issuance server, and a communications network coupling the transaction server and securities issuance server. The transaction server is configured to receive over the communications network client data relating to a client request for an issuance of an exchange traded product (ETP) series as a security for derivatively priced investment assets. The processor is configured to process the client data and generate client financial data and client documentation related to the request for the issuance of the ETP series based on the client data. A database server network is connected to said communications network and located remote from said transaction server. The processor at the transaction server is configured to transmit via the communications module the client documentation over the communications network to the database server network and store the client documentation therein. A non-relational database is structured within the memory of the transaction server into which the client financial data is stored.

The processor at the transaction server is configured to transmit via the communications module a request to the securities issuance server to issue the ETP series for the client, and in response, the securities issuance server issues the ETP series, wherein the issued ETP series comprises issued series data. A relational database is structured within the memory of the transaction server into which the issued series data regarding the issued ETP series is stored. The processor is configured to track the changes in the issued series data and client financial data over time due to changes in the financial markets, the issued ETP series or the client financial data and periodically update the issued series data and client financial data within the relational and non-relational databases for maintenance and report generation.

In an example, the client documentation may comprise legal documentation, Term Sheets, and Know-Your-Client (KYC) information for the issued ETP series. The database server network may comprise an on-demand cloud computing platform comprising at least one memory and database structured to store the client documentation for the plurality of clients. The data corresponding to client documentation may be organized as scalable objects into data buckets and each identified with a user-assigned key for individual clients, and wherein a descriptive property is associated with objects to aid in tracking the client documentation for each client. The database server network may further comprise an access control list associated with each bucket and object and accessible via a user interface displayed at a user terminal in communication with said transaction server. The relational database may comprise a plurality of tables, wherein each table comprises an entity type for the issued ETP series. The relational database may comprise a structured query language database, wherein said processor at the transaction server is configured to access the issued series data by querying the relational database using a structured query language to retrieve the issued series data. The client financial data may be configured into primary and secondary data categories and the non-relational database may include a primary and secondary index that is queried by field and range queries. The securities issuance server may comprise a server operated by a trustee authorized to issue an ETP series, wherein said issued ETP series includes an assigned ISIN.

In yet another example, a method of issuing and managing financial assets for a plurality of clients comprises receiving over a communications network from each client and within a transaction server comprising a processor, memory, and communications module, client data relating to a client request for an issuance of an exchange traded product (ETP) series as a security for derivatively priced investment assets, processing the client data within the processor at the transaction server and generating client financial data and client documentation related to the request of the ETP series based on the received client data. The method further includes transmitting the client documentation via the communications module over the communications network to a database server network located remote from the transaction server and storing the client documentation therein. The method includes storing the client financial data within a non-relational database structured within the memory of the transaction server. The method includes issuing the ETP series for each client, wherein the issued ETP series for each client comprises issued series data, and storing the issued series data regarding the issued ETP series within a relational database structured within the memory of the transaction server. The method tracks the changes in the issued series data and client financial data over time due to changes in the financial markets, the issued ETP series, or the client financial data and periodically updating the issued series data and client financial data within the relational and non-relational database for maintenance and report generation.

In yet another example, the client documentation may comprise legal documentation, Term Sheets, and Know-Your-Client (KYC) information for the issued ETP series. The method may further include transmitting the client data from a remote client computer over the communications network to the transaction server. The database server network may comprise an on-demand cloud computing platform comprising at least one memory and database structured to store the client documentation for the plurality of clients, wherein data corresponding to client documentation is organized as scalable objects into data buckets and each identified with a user-assigned key for individual clients, and wherein a descriptive property is associated with objects to aid in tracking the client documentation for each client. The database server network may further comprise an access control list associated with each bucket and object and accessible via a user interface displayed at a user terminal in communication with said transaction server. The relational database may comprise a plurality of tables, wherein each table comprises an entity type for the issued ETP series. The relational database may comprise a structured query language database, wherein said processor at the transaction server is configured to access the issued series data by querying the relational database using a structured query language to retrieve the issued series data. The ETP series may be issued by transmitting from the transaction server via the communications module a request for issuing the ETP series over the communications network to a securities issuance server, and in response, issuing the ETP series at the securities issuance server.

In yet another example, a method of issuing and managing financial assets for a client comprises accessing a transaction server from a remote computer operated by a client, wherein the transaction server comprises a processor, memory and communications module, inputting at the remote computer client data and a request for an issuance of an exchange traded product (ETP) series as a security for derivatively priced investment assets, and transmitting the client data and the client request for the issuance of the ETP series from the remote computer of the client over a communications network to the transaction server. The method includes processing the client data in the processor at the transaction server and generating client financial data and client documentation related to the ETP series based on the received client data.

The method further includes transmitting the client documentation via the communications module over the communications network to a database server network and storing the client documentation therein, and storing the client financial data within a non-relational database structured within the memory of the transaction server. The client financial data is configured into primary and secondary data categories and the non-relational database includes primary and secondary indexes accessible via field and range queries. The method includes transmitting a request for issuing the ETP series from the transaction server via the communications module over the communications network to a securities issuance server, and in response, issuing the ETP series at the securities issuance server, wherein the issued ETP series comprises issued series data and storing the issued series data regarding the issued ETP series within a relational database structured within the memory of the transaction server. The relational database may comprise a plurality of tables, wherein each table comprises an entity type for an issued ETP series and accessible via a structured query language. The method includes tracking the changes in the issued series data and client financial data over time due to changes in the financial markets, the issued ETP series, or the client financial data and periodically updating the issued series data and client financial data within the relational and non-relational databases for maintenance and report generation.

### BRIEF DESCRIPTION OF THE DRAWINGS

Other objects, features and advantages of the present invention will become apparent from the detailed description of the invention which follows, when considered in light of the accompanying drawings in which:

FIG. 1 is a block diagram of a financial system architecture and the FlexETP system and its relation among various participants in accordance with a non-limiting example.

FIG. 2 is a flowchart of the data flow for the FlexManager module showing how data is saved and extracted to and from different databases in accordance with a non-limiting example.

FIG. 3 is a flowchart of the data flow for the Control Panel operating the databases and FlexManager module and its interfaces in accordance with a non-limiting example.

FIGS. 4A through 4C show an entity relationship diagram in the architecture of the relational database for the FlexETP system in accordance with a non-limiting example.

FIG. 5A is a flowchart showing a high-level model of the data processing and data flow sequence for the FlexFunds accounting module in accordance with a non-limiting example.

FIG. 5B is a flowchart showing the invoices set-up and data flow for the FlexFunds accounting module in accordance with a non-limiting example.

FIG. 5C is a flowchart showing the maintenance fees and invoices processing for the FlexFunds accounting module in accordance with a non-limiting example.

FIG. 5D is a flowchart showing an interest payment and invoices process for the FlexFunds accounting module in accordance with a non-limiting example.

FIG. 5E is a flowchart showing the extraordinary fees and invoices processing for the FlexFunds accounting module in accordance with a non-limiting example.

FIG. 6A is a block diagram of the system such as shown in FIG. 1 and showing other details and components that are described with reference to the flowcharts shown in FIGS. 6B through 6D in accordance with a non-limiting example.

FIG. 6B is a flowchart for an example method of issuing and managing financial assets in accordance with a non-limiting example.

FIG. 6C is a flowchart illustrating an example of the method of managing the financial assets of a plurality of clients and issuing financial reports in accordance with a non-limiting example.

FIG. 6D is a flowchart showing an example method of managing the financial assets and associated fees for a plurality of clients in accordance with a non-limiting example.

FIG. 7A is a chart illustrating how purchased shares can be optimized by the FlexFunds FlexInvest module in accordance with a non-limiting example.

FIG. 7B is a flowchart showing the set-up processing and data flow for the FlexInvest module as conducting and balancing a secure transaction in accordance with a non-limiting example.

FIG. 7C is a block diagram showing basic components of the system such as shown in FIGS. 1 and 6A that may be used to understand better the flowcharts shown in FIG. 7D in accordance with a non-limiting example.

FIG. 7D is a flowchart showing an example method of conducting and balancing in a secure transaction a financial investment of a client in accordance with a non-limiting example.

FIGS. 8A through 8H are example screenshots of generated reports for the FlexInvest module in accordance with a non-limiting example.

FIG. 9 is a screenshot for a FlexFunds series Factsheet displayed, for example, by the FlexManager module in accordance with a non-limiting example.

FIGS. 10A through 10F are screenshots showing how a FlexETP series may be established and monitored using the FlexManager module in accordance with a non-limiting example.

FIGS. 11A and 11B are screenshots showing a portion of the set-up process for the FlexManager module in accordance with a non-limiting example.

FIGS. 12A through 12E show an example term sheet for a FlexFunds series and can be retrieved such as from the FlexFunds module in accordance with a non-limiting example.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

There now follows details of an investment system related to FlexFunds Exchange-Traded Products (FlexETP's) in accordance with a non-limiting example. The example system provides investments as FlexETP products using a FlexETP system, which provides an efficient asset management program for the FlexETP products, improving computer operation, its functions and processing, while also improving data storage and retrieval using different databases. It improves computer report generation and fee payments related to the FlexETP's, while concentrating on price, speed and flexibility. In the following description, the operator of the FlexETP system is FlexFunds and includes different branches related to FlexFunds Operations, Accounting and Sales. Underlying investments are wrapped and distributed through a Euroclearable listed security in a non-limiting example. The FlexETP system provides price (NAV) calculation and distribution with an ISIN/CUSIP and a Bloomberg page and facilitates operation and cooperation with a trustee, audit services, an issuer, an issue agent, paying agent, depository, and of course, with internal components of the arranger such as FlexFunds operating the FlexETP system. An example collaboration may be with IA Capital Structures as Issuer, a bank as an Issue and Paying Agent, e.g., in one example Bank of New York Melon, Price Waterhouse Coopers (PWC) as an Auditor, Euroclear as a Depository, and Sanne Group as a Trustee.

In one non-limiting example, a FlexETP product (or FlexETP) as used herein may be referred to as an Exchange-Traded Product (in the form of a Note) that provides for investment management and distribution. The FlexETP's price may be linked to the value of the underlying assets or portfolio and different groups may issue a FlexETP. In one example, IA Capital Structures (Ireland) Plc. is the Issuer for the FlexETP that operates and manages the FlexETP system and Sanne may be the Trustee. The Issuer is incorporated in Ireland as a public limited liability company and has been established as a Special Purpose Vehicle (SPV). The principal activity of the Issuer in this instance is the issuance of the FlexETP Notes.

A Special Purpose Vehicle (SPV) may also be termed a special purpose entity and fulfills a narrow but specific objective, and may separate different layers of equity infusion, providing isolation of assets as a comfort to different investors. A relevant standard for reporting in some cases may be IAS 27 in one example. The characteristics of the Issuer as an orphan SPV (owned by Charitable Trust Companies in this example) ensures that there is no Issuer risk related to actions by the Issuer or any of its shareholders. Furthermore, the underlying assets of FlexETPs and the rights and benefits resulting from them are secured to the Trustee for the benefit of Noteholders (investors).

The Arranger for the Notes is FlexFunds that operates the FlexETP system and may be the calculation agent, sales agent and placing agent, and is responsible for the management and administration of the Notes. In a non-limiting example, a broker dealer may be used, such as GWM Group, Inc., as a full service broker dealer that is a member of the Financial Industry Regulatory Authority (FINRA) and the Securities Investor Protection Corporation (SIPC).

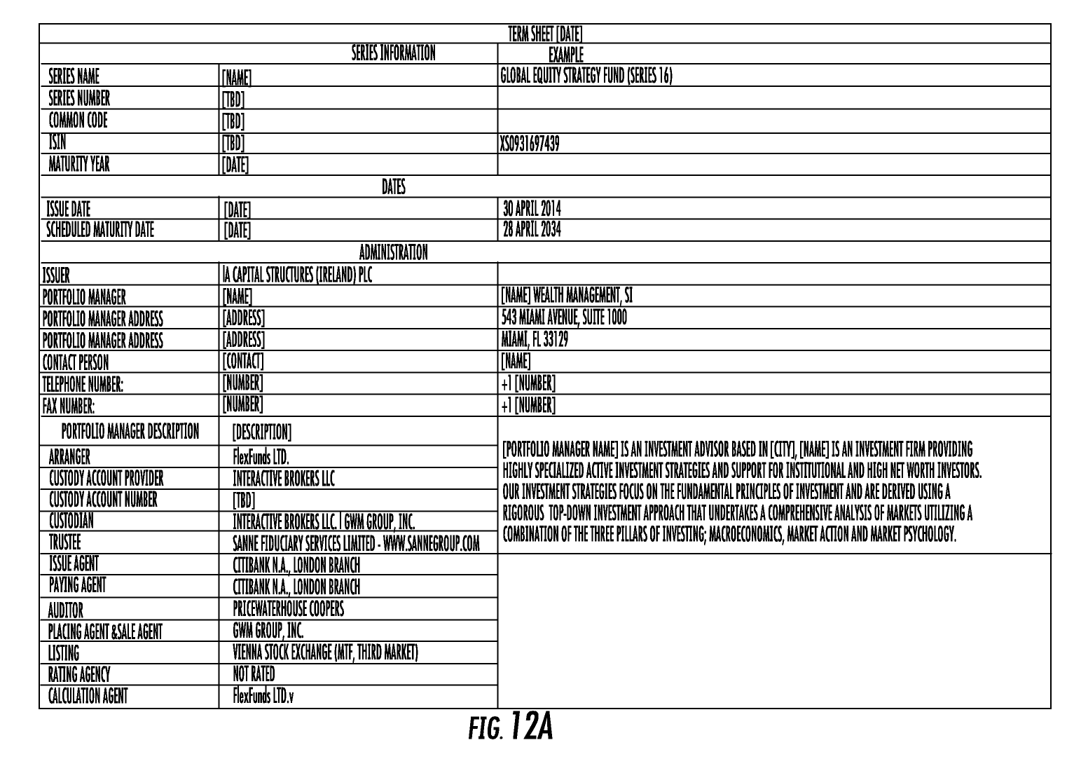

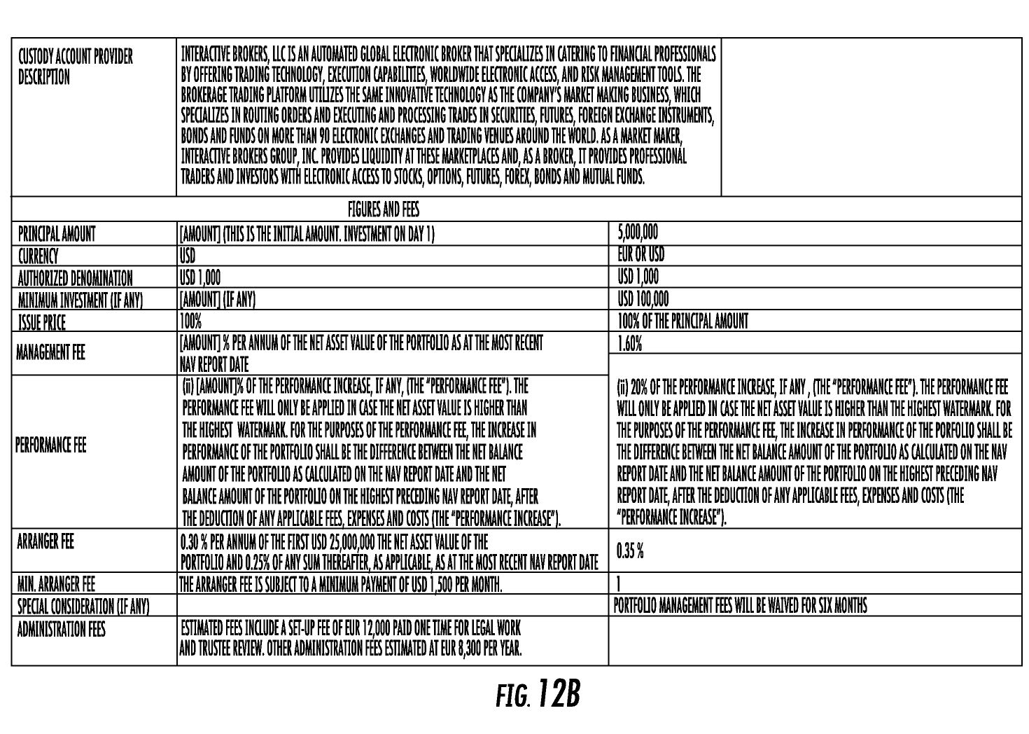

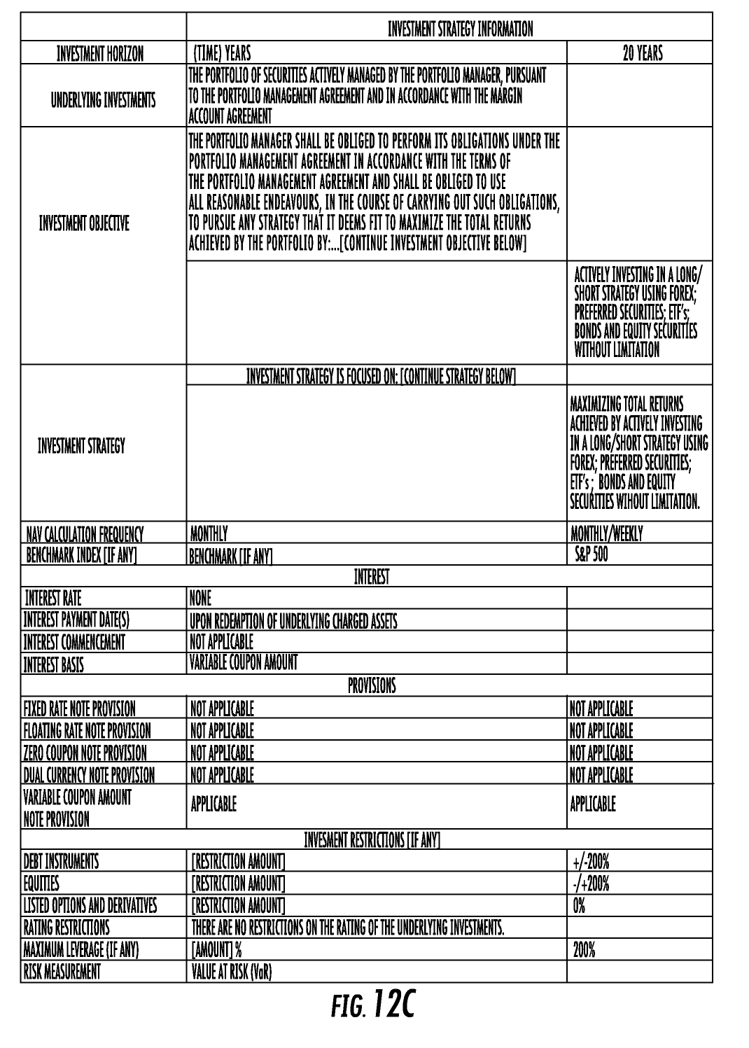

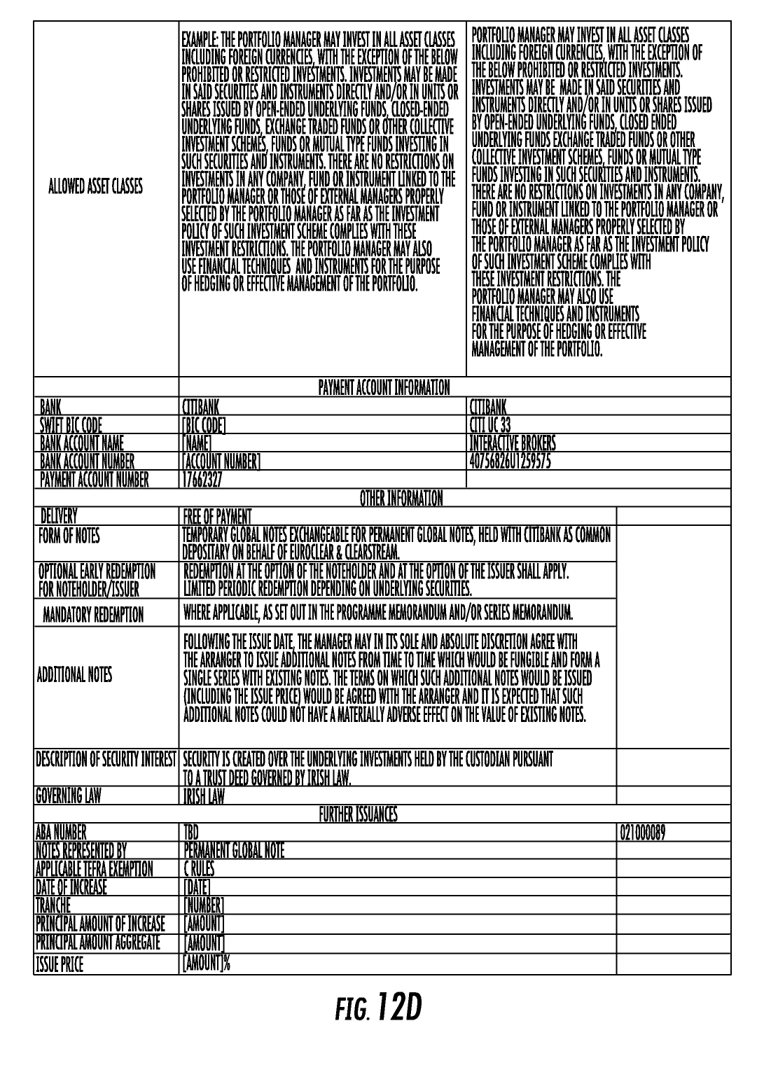

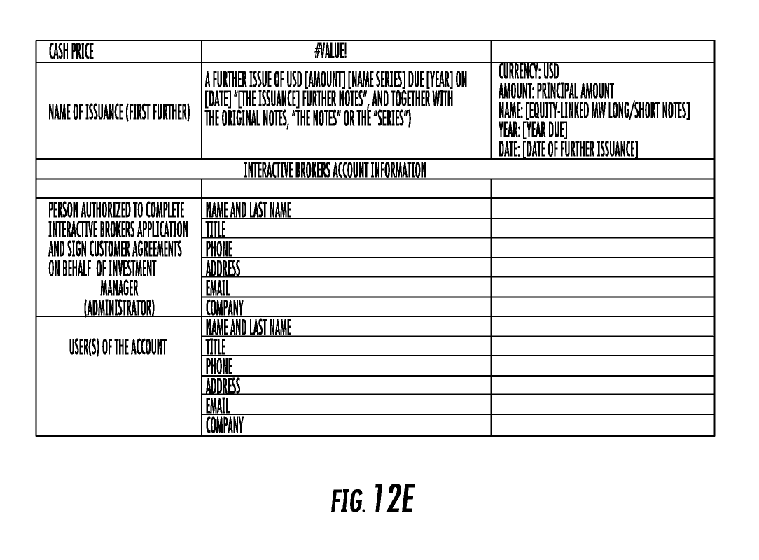

The program's Issuer may issue a FlexETP Series at the request of an investment advisor, developer or project manager as a portfolio manager in one example, which has full control of the investment strategy, though for legal purposes it has no issuer-related liability. FlexFunds via its FlexETP system as described below may arrange a FlexETP issuance for many kinds of investment professionals, such as registered investment advisors, portfolio managers, broker-dealers, family offices, and other money and asset managers. As will be explained in greater detail below, investments may include a FlexETP Fund, a FlexETP Wrapper, a FlexETP Loan or FlexETP Hybrid. In one example, the timing to complete an issuance may be around four weeks for a FlexETP Fund and about six weeks for a FlexETP Wrapper and FlexETP Loan. Issuance timing may depend on a timely completion of an initial term sheet by a portfolio manager. An example term sheet for a FlexETP Series is shown in FIGS. 12A to 12E and explained in greater detail below. It may take about eight business days to issue an additional tranche on an existing FlexETP Series.

It should be understood that the FlexETP system may manage a FlexETP Fund that securitizes a portfolio of publicly traded assets, where the portfolio is actively managed by an appointed portfolio manager. In a FlexETP Fund, the participations may be globally distributed in one example through a Euroclearable listed security. Investors may access these securities from their existing brokerage accounts. With the FlexETP system, no additional Know Your client (KYC) or Anti-Money Laundering (AML) is required and assets may stay within existing custodial accounts. Any redemptions or distributions may be delivered directly to investors. Each issuance may be signed according to customizable terms and conditions and include a price (NAV) calculation and distribution, an International Securities Identification Number (ISIN), a Bloomberg listing, a trustee and audit services.

As is well known, the KYC refers to the due diligence activities that the financial institutions and other regulated companies perform to ascertain relevant information from their clients for purposes of doing business with them. Usually, the KYC falls under the responsibility of each financial institution and/or regulated company. KYC controls include the collection and analysis of basic identity information. In many countries, this may include a “customer identification program” (CIP) with name matching against lists of known parties and determination of customer's risk, and a creation of an expectation of a customer's transactional behavior. Usually KYC regulations are local and differ from country-to-country. The FlexETP system may provide the necessary functionality and operational requirements to meet the local KYC regulations.

As to “anti-money laundering” (AML), it is a set of procedures, laws or regulations that stop the practice of generating income through what may be illegal actions and in one example may follow the requirement of the 1989 Paris G-7 Summit and Financial Action Task Force on money laundering (FATF). AML regulations are also local and the FlexETP system, in accordance with the non-limiting example, provides the necessary functionality and operational requirements to meet the local regulations. As noted before, an ISIN is assigned a FlexETP Series and uniquely identifies this security as defined by ISO 6166. The securities may include underlying bonds, commercial paper, stocks, warrants and similar examples. The ISIN code typically is a 12-character alpha-numerical code and uniformly identifies a FlexETP through an assigned national number at trading and settlement and may be issued to debt securities, shares, options, derivatives, futures and other instruments. It is also possible that a trading location may be identified with a Market Identifier Code (MIC). If in an example, a North American financial securities investment is used, then a CUSIP may be used and assigned.

The FlexETP Wrapper securitizes private shares of a company or fund. Private subscription participations may be globally distributed through a Euroclearable listed security. The investors access the securities from their existing brokerage accounts. No additional KYC or AML is required and the assets stay within existing custodial accounts where redemptions or distributions are delivered directly to investors. Each issuance is designed according to the customizable terms and conditions and the FlexETP system provides price (NAV) calculation and distribution with the ISIN, the Bloomberg listing, and the Trustee and Audit services.

FlexETP Funds develop funds that may implement many different strategies and are managed as a fund. Participations may be purchased as bonds with the advantages as part of the FlexETP system where the funds create investment products for clients that can be managed internally by the FlexETP system and manage a single client's portfolio. No additional KYC or AML is required.

The FlexETP Loan is a loan participation that is globally distributed through a Euroclearable listed security. No additional KYC or AML is required as with the FlexETP Fund or FlexETP Wrapper. FlexFunds may subcontract the underlying portfolio management to a third party and the FlexETP system may wrap a fund or investment product for better distribution since the FlexETP system makes the computer operate better and allows quicker platform acceptance while ensuring limited regulatory oversight. It is possible an advisor may determine investment product characteristics. It is also possible to make a private placement where an investment vehicle raises capital for a private purpose such as real estate purchases or private shares and the products may have a greater degree of complexity and include special purpose vehicles.

As to the price (NAV) calculation, it may be provided on a monthly or weekly basis. A monthly NAV report may be shared with a manager of the FlexETP system. Different reports may include performance data and examples are explained later. Prices may be distributed through Bloomberg, Six Financial and/or a European Stock Exchange. Using the European Stock Exchange may comply with the EuroBond exemption. The Bloomberg page may display the price of the security. Prices may be distributed periodically through Six Financial as a multi-national financial data vendor with its database having structured and encoded securities administration data, and the European Stock Exchange as a non-limiting examples.

As will be explained in greater detail below, managers of the FlexETP system such as associated with FlexFunds Operations, Accounting and Sales may control the composition and management of the FlexFunds' underlying assets using the FlexFunds FlexManager module, FlexFunds accounting module, FlexInvest module via different user interfaces and other techniques. A formally appointed portfolio manager may operate as an authorized party that controls the composition and trading account for the holder of the FlexETP's underlying assets, which can be numerous and include debt, equities, receivables and derivatives, all of which may be acquired pursuant to the terms of the documentation issued by FlexFunds. In the FlexETP system, the composition and trading in an account and the investor's identity and information are maintained confidential. The portfolio manager may determine whether or not the composition and trading activity of an investment account is disclosed to investors. It is possible that the composition and activity in an account that is traded uses proprietary techniques that may remain confidential. Investors receive the value of the security on their brokerage account statement, which may be reported periodically by FlexFunds via the FlexETP system since FlexFunds may be a calculating agent for Net Asset Value (NAV) and report generator. Any participations may be purchased through Euroclear and the investor's identity may remain confidential.

The investing strategy may be managed by an appointed portfolio manager and the strategy is defined in the Issuance Documentation according to the portfolio manager's direction. Also, the portfolio manager may establish the terms for any management fee, which will be disclosed in the Issuance Documentation. Administration costs typically inherent in managing the investment portfolios average less than one percent of assets under management, exclusive of management fees. Using the FlexETP system and a FlexETP product as an investment management vehicle, the portfolio manager can reduce administrative costs by as much as forty percent or more with the savings passed to the client or retained by the advisor in the form of an increased management fee, depending on contractual arrangements and other circumstances. In addition, the FlexETP's distribution advantages and its efficient administration from the FlexETP system allows managers to focus on growing the assets that are under their management. The cost to establish a FlexETP is competitive and designed to allow for low risk launch and inexpensive maintenance. Final costs depend upon several factors, such as the types of underlying assets and their issue size.

For a manager, the FlexETP system provides complete administration services in association with selected financial institutions, allowing a manager to concentrate entirely on managing the assets and growing the size of the portfolio. Furthermore, investors in partnerships and limited liability companies are required, in most jurisdictions, to realize capital gains and losses in the year of the transaction. However, when an investor invests in a managed portfolio via a FlexETP, the investor will not realize a taxable event until the Note is sold or redeemed.

There now follows a general description of a FlexETP as a Note as managed via the FlexETP system. In an example, it is a regularly priced security that trades during the day on a national stock exchange and may embed derivatives, although it is not required. The underlying securities in many examples are stocks and bonds, which are not considered the FlexETP per se, but only the underlying security. Different FlexETP products may be benchmarked to indices, stocks and commodities that could be actively managed and may include open-ended or close-ended funds, Exchange-Traded Derivative Contracts, Exchange-Traded Funds (ETF's) and Exchange-Traded Notes (ETN's), including Exchange-Traded Certificates, Exchange-Traded Currencies, and Exchange-Traded Commodities.

It is possible for the FlexETP system to operate with a close-ended fund as a collective investment model based on issuing a fixed number of shares that are not redeemable from a fund where the price per share is determined by the market and usually different from the underlying value or net asset value (NAV) per share of the investments held by the fund. The price may be a discount or premium to the NAV when it is below or above the NAV, respectively. In any event, the NAV is the value of the entity's assets minus the value of its liabilities. The Net Asset Value may correspond to any open-ended funds. In contrast, the close-ended funds may be traded in the open market between investors. Thus, the price of the shares or interests in the close-ended fund could be an agreement reached by the parties, which may not correspond to the fund's NAV.

The FlexETP product could be an open-ended investment listed on an exchange and traded and settled similar to shares. They could be formed as passive investments that replicate the performance of a given market, generally by tracking an underlying benchmark index and trade at or close to the NAV. In some examples as noted before, they may be structured and referred to as Exchange-Traded Vehicles (ETVs). Often those skilled in the art may consider the term Exchange-Traded Fund (ETF) and Exchange-Traded Product (ETP) to be interchangeable. It is possible to have Exchange-Traded Notes that are generally senior, unsecured, subordinated debt issued by, for example, a single bank and listed on the exchange and may not be asset-backed in some cases. These may be collateralized and uncollateralized Notes and positioned partly or fully against counterparty risk while uncollateralized Notes may be fully exposed to counterparty risk.

There now follows a more basic description of the financials of Exchange-Traded Products and referring generally to an Exchange-Traded Fund (ETF). It should also be understood that it is possible an ETF's market price may be more or less the funds' NAV per share since the market price fluctuates during the trading day as a result of a variety of factors, including the underlying prices of the assets and a demand for the ETF's. The ETF's NAV may be the value of the ETF's assets minus its liabilities, as calculated by the ETF at the end of each business day, but that is not necessary in the FlexETP system. Usually the ETF's market prices are generally kept close to the ETF's end-of-day NAV because of the arbitrage function inherent to the structure of an ETF, which may hold true for open-ended funds. Usually the arbitrage takes advantage of a price differential between two or more markets and the opportunity is inherent in many ETF structures because the ETF's intraday market price fluctuates during the trading day and may not be equal to the ETF's end-of-day NAV. Participants may arbitrage this difference and make a profit.

Different ETF's may be issued an index or stock ETF as a bond ETF, or a commodity ETF with underlying assets as precious metals, agricultural products, or hydrocarbons. A currency ETF may include a Eurocurrency trust. An actively managed ETF may be transparent and publishes the current securities portfolios on websites daily and is of course at risk from the arbitrage activities. It is even possible to have an inverse ETF or a leverage ETF.

As noted before, individual investors may purchase a FlexETP via the FlexETP system. FlexETP products (also referred herein as “Notes”) are registered in this example with Euroclear or Clearstream and are assigned a unique ISIN/CUSIP number, permitting the investors to purchase the Note directly through an existing brokerage account. Euroclear and Clearstream may be considered in an example to be post-trade service providers and provide settlement, custody and other related services for the securities across different asset classes. Both are the European International Central Securities Depositories. Clearstream operates security settlement systems in Luxembourg and Germany, with its ICSD from Luxembourg. Euroclear is a Belgian-based financial services company and also an ICSD, acting as a Central Securities Depository (CSD) for Belgian, Dutch, Finnish, French, Irish, Swedish and UK securities. FlexETP Notes may be listed on the Vienna Stock Exchange and cleared through Euroclear. For a FlexETP Fund, the custody accounts may be opened via a financial institution such as Interactive Brokers Group and Bank of New York Melon. Portfolio managers can invest directly through these platforms. The Interactive Broker's Group (IBG) is a global electronic market maker and broker as a corporate group.

FlexETP Notes may be subject to selling restrictions in several jurisdictions. In the United States, the Notes typically fall under Regulation S and cannot be purchased by U.S. persons. Some restrictions apply to investors in the European Union in accordance with a prospectus directive regulation. FlexETP Notes have therefore been typically designed for non-U.S. investors. In the United States, they may be considered a Regulation S security and therefore subject to special restrictions.

FlexETP Notes are listed with the registered depository such as Euroclear or Clearstream, and therefore, a FlexETP Note can be purchased by non-U.S. investors worldwide, significantly easing the flow of foreign capital into U.S. projects for the benefit of the economy and acting as a capital generator. Thus, it is possible for foreign investors to invest in a U.S. project or a U.S. money manager's strategy quickly and directly through their existing brokerage account. Once issued, the FlexETP Notes can be transferred between investors. However, investors may be subject to selling restrictions applicable in their jurisdiction.

The minimum investment for a FlexETP Note varies depending on the residence of the investor. In most Central and South American countries, there is no regulatory minimum. An advisor for whom a FlexETP Note is issued, however, may establish their own minimums. Investors within the European Union as an example may be required to invest a minimum of 100,000 Euros and other requirements may be present for specific jurisdictions. It should be understood that typically there is no secondary market available for FlexETP Notes and participations may be issued and redeemed, or existing FlexETP Notes may be transferred from one investor to another. An investor may liquidate a FlexETP Note in accordance with the terms set forth in the Issuance Documentation, which may include holding the FlexETP Note until maturity or liquidating the FlexETP Note at specified time windows that are stipulated by the portfolio manager. In general, if there are no liquidity restrictions, investors may redeem their FlexETP Note within 5 business days.

As noted before, a FlexETP Note may be priced, in an example, based on the NAV, which may be calculated on a regular basis (monthly/weekly) in accordance with the composition of the portfolio. The NAV is published in Bloomberg pages as well as distributed to the investors' brokerage accounts. The calculation agent may be the GWM Group in an example.

Investors who purchase a FlexETP Note through their brokerage account may see the security price reflected on their brokerage account statement on a regular basis via the FlexETP system. It should be understood that the value of a FlexETP Note on a brokerage account statement depends on the composition of the portfolio. Thus, a portfolio based on market-priced securities will reflect the NAV (Net Asset Value) of the FlexETP Note's underlying securities minus any operating expenses and fees. However, a portfolio based on non-marketable securities or assets may be reflected at cost. The price may be distributed to investors and the price (NAV) of the FlexETP Note may be distributed to the investor's account through any of the FlexETP system's partners on a predetermined, regular basis. As noted before, each FlexETP Series will have a unique ISIN number and Bloomberg page.

A portfolio manager in one example can arrange for the origination of a FlexETP Series with as little as one million in assets under management in a non-limiting example. The appointed portfolio manager as the advisor may establish the terms for the management fee in the Series Documentation, and this management fee may be deducted periodically from the Portfolio. Managers may also charge performance fees (i.e., 2/20 structure). In essence, the FlexETP system permits the fee arrangement that best suits the portfolio manager and its clients.

It should be understood that investors typically are not invoiced for an advisory fee. The management fee may be paid directly by the administrative paying agent from the assets held within the FlexETP Note's underlying account. Investors as clients typically are not invoiced separately, nor are they required to pay any of the account's fees or expenses directly, all of which are deducted from the custody account under review by the Custodian and Trustee.

The portfolio manager may be a regulated entity in its specific jurisdiction and may be designated when the Series is created and will abide by the determined strategy in a portfolio management agreement. The portfolio manager may get paid directly by a paying agent from the assets held within the Note's underlying account.

The FlexETP system may adopt custom names, also referred to as white-label names, and the name of a FlexETP Series may have a custom name for each series. However, some custody platforms may show the name of the Issuer in combination with an assigned name. A FlexETP Series may be open-ended by default and allow for additional increases over the life of such series. However, a portfolio manager may choose to create a close-ended Series as described above.

FlexETPs offer greater flexibility in the type of allowed underlying assets since investments may be made in either listed or unlisted securities and assets, and underlying assets may originate from different countries (although with some restrictions). FlexETPs can mature in 2 to 20 years, and depending on the Notes, the maturity can be extended indefinitely. The Notes can be called or redeemed pursuant to the terms set forth in the Issuance Documentation. An advisor or investor has significant flexibility with respect to the terms of the FlexETP Series issued on their behalf and there is no requirement to make interest payments at any certain rate or at any specific times, unless set forth in the Prospectus and Issuance Documentation. The distribution of gains, losses and earned interest is determined by an advisor as are the procedures and valuation methods to be applied for early redemptions, liquidations, and at the FlexETP Note's maturity.

It should be understood that there is no subscription agreement because FlexETP Notes are Exchange-Traded Products, which are purchased directly from the investor's brokerage account. There may be, however, a Series Memorandum, i.e., “Series,” which specifies the conditions of the Notes (terms of investment) and identifies the risks and provides information on the transaction parties and Series assets.

As noted before, the Issuer for a FlexETP in an example may be IA Capital Structures (Ireland) PLC (IAC) as an orphan Special Purpose Vehicle (SPV) that is created to issue in a FlexETP Series. Activities may include the issuance of the Notes, the acquisition of financial assets, and entering into legally binding arrangements. The Trustee for the FlexETP system may in an example be Sanne Fiduciary Services Limited (Sanne Group) operating in conjunction with the FlexETP system as an administrator for the Issuer's operations. As a fiduciary, its duties may be focused on maintaining and protecting the interests of various investors as clients and arrange the legal review of all Issuance Documentation and ensure that the activities of FlexFunds operating the FlexETP system and any managing parties such as a portfolio manager do not deviate from the Series documentation. The Sanne Group is a public listed company on the London Stock Exchange and an independent fiduciary service company operating in Europe, Asia and the Middle East.

The Issue Agent and Principal Paying Agent (Issue Agent) in an example may be Bank of New York Melon N.A., for example, the London Branch. As the Issue Agent, it manages the issuance process, registers a security with an ISIN in Euroclear, and executes any matching of investor's funds with issued securities. Different money investments such as subscriptions and redemptions between investors as clients and the FlexETP system's custodial account may be executed by the Issue Agent, as in this example, Bank of New York Melon. In addition, the Issue Agent also operates as a Principal Paying Agent, and will execute delivery of any interest payments to investors as the clients through Euroclear as a non-limiting example.

An auditor operates to examine and verify accounting, and in this example, may be Price Waterhouse Coopers, which reviews the entire program on an annual basis and also ensures that each FlexETP Series is backed by the stated underlying assets. A Depository such as Euroclear provides transactions and domestic and cross-banker settlement. The Arranger as noted before is FlexFunds that operates the FlexETP system and may be appointed as the calculation agent and responsible for various management and administrative functions in relation to the Notes, including, but not limited to, coordinating the development and structure for the issuances, organizing the stock exchange listing, the custody account and opening increases, allowing for the redemptions of the principal issued amount, provisioning and distributing the NAV, and generating reports.

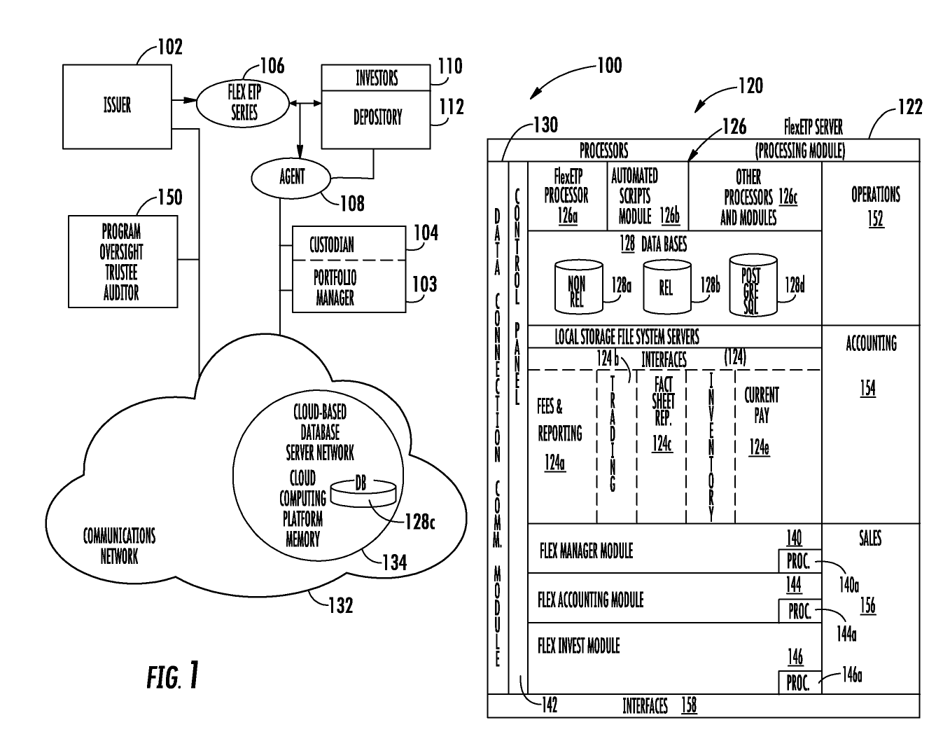

Referring now to FIG. 1, there is illustrated a high-level block diagram of the different FlexETP program participants for the illustrated financial system that includes the FlexETP system as a manager for a FlexETP Series. The overall architecture for the financial system is illustrated generally at 100 and includes the Issuer 102 that issues a FlexETP strategy determined by a portfolio manager 103 that may be associated with the custodian 104 in this example and operating in an example as a client. The Issuer 102 in this example is IA Capital Structures (Ireland) PLC, which issues the FlexETP Series 106 via an Issue Agent and Principal Paying Agent 108 such as Bank of New York Melon. Investors 110 use the FlexFunds system to make investments and transactions via Euroclear as an example for a Depository 112. The Custodian 104 provides an investment account with the underlying assets and may provide a NAV in cooperation with the FlexETP system that is illustrated generally at Block 120, which includes a FlexETP server 122 that operates numerous FlexETP data interfaces 124 to transmit and receive data to and from the FlexETP server and an associated processing module 126 that includes a FlexETP processor 126a as part of the overall computer system, and which also interoperates with the various databases 128 as explained below.

The interfaces 124 may include an Interest, NAV's, Fees and Reporting Interface generally referred to as a Fees and Reporting Interface 124a, a Trades Interface 124b, a Factsheet Reporting Interface 124c, an Inventory Interface 124d, and current payments interface 124e. The various components as described connect to a communications module as a communications data connection 130 (or database connection), and in turn, to a communications network 132 and cloud-based database server network 134 as a cloud computing platform in an example. The FlexETP server 122 includes the FlexETP processor 126a and an automated script module 126b that includes a Jenkins plug-in in this example and other processor modules 126c. The databases 128 include a non-relational database 128a such as a Mongo database, a relational database 128b such as a SQL database, a database 128c as part of a cloud-based storage network as a file depository, such as part of a Cloud Services group like Amazon, and a POSTGRE SQL database 128d. These components are explained in much greater detail below. The FlexManager module 140 interacts with a Control Panel 142, which also interacts with the FlexFunds accounting module 144 and FlexInvest module 146, as explained in greater detail below. The FlexETP system 120 may include various modules that operate as part of FlexFunds Operations 152, Accounting 154 and Sales 156 that are operational with the associated personnel and managers.

Program oversight 150 may be provided by a trustee and Auditor such as the Sanne Group for the trustee and Price Waterhouse Cooper (PWC) auditors as an example. Advisors may control the underlying assets and define the investment product characteristics to allow efficient issuance process and distribution with a private label and an advisor's choice of the security's name and asset protection.

There now follows a general description of this FlexETP system 120 infrastructure as shown in FIG. 1 and its internal and external data flow with program participants, which is explained in greater detail below with reference to the flowcharts and example screenshots and reports. The FlexETP system 120 operates in conjunction with the different databases 128 and is used by customers, investors or clients and associated personnel of FlexFunds, such as operating at FlexFunds Operations 152, FlexFunds Accounting 154, and FlexFunds Sales 156. The data processing and data storage and data workflow makes the computer operate better and its processing more efficient with the formation and tracking of any Notes, implementation of client reports, payments, receipts, and overall data tracking. A client may operate using a specific data workflow in the FlexETP system 128.

Generally, clients may generate new requests for an investment and send data via a term sheet to a FlexFunds operations group as part of the FlexETP system 120. The cloud-based storage network may operate in one example as an object storage database 128c such as from Amazon Web Services (AWS) and may keep track of client documentation such as legal documents and documents associated with long term storage. The non-relational or modular database 128a, i.e., a NoSQL database, which in the current preferred example is a Mongo database, may keep track of all client and investor data. The relational database 128b such as an SQL database may keep track of the issued Series data for maintenance purposes and maintain relevant data for all of the different Series maintenance requirements. This use of varied data management via the different databases, data generation and processing, and the relation of the client or investor 110 and the operation of the FlexETP system 120, allows the computer/server to operate better and enhances the issuance and maintenance of a FlexETP product or Note, allowing an efficient process with better computer operation. Enhanced and more efficient data processing and data transformation via the FlexETP system 120 and enhanced and more efficient database management and data retrieval and saving and manipulation permits more efficient display of data reports and the forwarding of data to different clients and the FlexFunds Operations, Accounting and Sales (152-156) operating with the FlexETP system 120 by all or most participants.

For example, the cloud-based storage network includes the database 128c and maintains track of the client documentation and may use a scalable level object storage that is accessible from a web-based interface at a FlexManager module interface 158 for the FlexETP Operations, Accounting or Sales and also for use by clients and investors via the Worldwide Web or other network. The interface design may depend on typical end-use devices. The FlexETP system 120 may include back-up/archiving, long term storage, and caching for any web applications interfacing the FlexETP system. Data is transformed when it is initially received from the client or investor. In parallel processing or at different sequences, the FlexETP system 120 monitors data in the database such as modular or non-relational database 128a, such as the Mongo database, storing data as a collection of adjacent files for the collected client data. For example, if a client issues a FlexETP Loan and there is a desire to add a guarantor or add different types of interest rates, the structure of the data may change significantly. The modular or non-relational aspect of this database 128a operates in an advantageous manner since it does not have a predefined structure and the adjacent files have a definite type of structure that is stored in the database. This allows an interplay with the client or investor 110 and the FlexETP system 120 and its Operations personnel for the data distribution, making the processing and computer functionality more efficient. The modular or non-relational database 128a, such as the Mango database, operates differently in its support of field and range queries and may use primary and secondary indexing and replica sets with some load balancing and data replication.

Juxtaposed to this modular or non-relational Mongo database is the relational database 128b, i.e., a Structured Query Language (SQL) database that maintains track of the issued Series data for maintenance purposes. It is not necessary to know every item of information because there is much specific information that is maintained. There may be a generic structure where the FlexETP system processing module 126 generates and uses in a well-defined extract of information and in a predefined format at the database. Reports may be generated from this data. The data exchange among all the databases 128 and the processing module 126 makes the overall FlexETP system 120 and the servers/computers more efficient and enhances control and computer functionality and its processing of many gigabytes of data.

The SQL database 128b may work with different languages, of course, as compared to the languages used at the non-relational, i.e., modular 128c or Mango Database and the cloud-based storage network database 128c, for example, within the cloud-based server module (or platform) as Amazon Web Services in an example or the Post GRE SQL database 128d. Data may be exchanged through the FlexETP system 120 and processed at a client computer and any FlexFunds Operations, Accounting or Sales (152-156) and the different interfaces and databases as part of the FlexETP system 120, including data processing to create different types of documents that can vary depending on the end user needs and requirements and the device on which the data is displayed. SQL is known to have a specific types of syntax with its clauses, expressions and different queries and will vary as compared to the client data at the modular or non-relational database and its documentation. Data exchange via the processing module 126 is created, manipulated, and converted to other formats, while processing or communication is made more efficient using this data transfer among the different databases.

The control panel 142 as described in greater detail below enhances the data processing, computer efficiency and management of a FlexETP Series to make reporting, accounting and data transfer among different units of the FlexETP system 120 more efficient. For example, in a non-limiting example, it is possible to use a secured File Transfer Protocol (sFTP) data feed as part of the communications data connection 130 associated with the control panel 142 as all the file transfers may be encrypted by an RSA key that only the recipient and sender have access in order to increase data security. Inventory data may be sent back to the data connection 130, control panel 142, and FlexETP system 120. Investment managers may operate with financial institutions such as Bank of New York Melon and Pershing or Interactive Brokers as financial data providers using the FlexETP system 120 and provide and process data using the hypertext pre-processing (HTTP). In one example, it is possible to use cron scripts to transform data and save it to one of the databases, for example, the SQL databases 128b. The FlexETP system 120 may retrieve FlexETP Series data from the databases to generate client reports, such as a fact sheet or transaction history, as is explained relative to the flowcharts and example reports, and the Control Panel 142 may be accessed by different FlexFunds groups and managers as part of FlexFunds Operations, Accounting and Sales. Data may be transformed and processed via the FlexFunds accounting module 144 that may use QuickBooks as an example to send wires (money) and invoices to different systems and process other items as necessary. It is possible to create specific types of scripts, e.g., Java scripts, specific to an application, including reading files and storing data. About 30 tables may be stored in one example to keep track of different reports and data objects. The scripts can be scheduled and it is possible to use an automated scripts module 126b having a Jenkins plug-in, for example, to schedule scripts and manage them in a unique manner so the data is saved to the necessary database on a daily basis. The scripts may be run on a daily basis and the scripts may notify in a specific manner about mistakes and other details.

The processing module 126 will process and forward data to different locations for further processing such as via the Control Panel 142 with the FlexManager module 140, the FlexFunds accounting module 144, or FlexInvest module 146 operating as associated processing centers of the FlexETP system 120 and each could have its own processing module functionality (140a, 144a and 146a). This bundle of information includes specific data about the Series and its type such as retrieval from the banking institution, e.g., Bank of New York Melon or Interactive Brokers, while also controlling the different transactions of the inventories for each of the Series. The processing module 126 is enhanced by the architecture with the specific scripts receiving the data feed from different sources and working in conjunction with the various databases.

The processing module 126 works in conjunction with the various databases and the FlexManager module 140 and the Control Panel 142 to implement the client reports. There is much data for each Series that a client may access, including of course a Bloomberg page. A client interface tool may be generated on a client terminal as a device such as a wireless communications device or client server and displays after receiving a prompt or code or other data from the FlexETP system 120 and the user may activate it by prompting and invoking a screen or GUI to receive reports or input data. On a periodic basis, client reports are transmitted based upon the transformation of data from the original data feed such as an sFTP feed and the Financial Data Providers such as Interactive Brokers or Bank of New York Melon, as an example, using the different scripts. The same occurs on the accounting side with the FlexFunds accounting module 144, where fees may be calculated using data that has been scripted. Invoices may be sent with reconciliation. Different devices may display different reports based on whether it is that of a client or Operations, Accounting or Sales or other managers at FlexFunds.

The FlexETP system 120 will process the KYC and engagement letters with the client and collect any KYC documents. There are other documents similar to the Series memorandum. Documents are sent to any trustees and attorneys, banks or other financial institutions and brokerages. The client documentation may include such items as the term sheet, KYC information, engagement letter and similar documents, which in one example are tracked by the cloud-based storage network database 128c, for example, an Amazon Web Services storage, and may also be stored in a hard drive or other storage 128a, 128b locally at the FlexETP system 120. The client data in one example is preferably stored within the non-relational database 128a, i.e., Mongo database, since that storage may be enhanced for that type of data as a collection of the adjacent modular files. For example, if a FlexETP Loan is being issued and a guarantor is to be added or a different interest rate structured, the structure of that data may change significantly. Since the non-relational database 128a does not have a pre-defined structure, this financial data may be formatted better. The FlexETP relational or SQL database 128b may keep track of the Series data for maintenance purposes. An advantage of that type of database is once the Series is issued, there is only so much specific financial information needed to maintain it. It is not necessary to know every single financial data item or part of it.

The client documentation as noted before is stored in the cloud-based storage network database 128c. That type of system may be an on-demand cloud computing platform that uses a Simple Stored Service (“S3”) or other similar functional storage system. It may provide a scalable object storage accessible from a cloud-based interface as part of the FlexETP system 120 and include backup/archiving, file and immediate storage and hosting, and the other functions. Storage may be provided through various web services interfaces for the databases, such as REST, SOAP, and Bit Torrent. Data may be managed using an object storage architecture where arbitrary objects or computer files may be organized into buckets with each bucket identified using a user-assigned key such as for individual clients. Buckets and objects may be created, listed, and retrieved, for example, by using a REST-style http interface or a SOAP interface, and objects downloaded using an http GET interface and Bit Torrent protocol. An access control list may be associated with each bucket and object and bucket names and keys chosen so that objects may be addressable using http URLs. Buckets may be configured to save http log information through a sibling bucket that can be used later in data mining operations.

An API as part of FlexETP system 120 is one technique for object storage, which is advantageous for maintaining track of client documentation. This type of object-based storage may manage data as objects as opposed to those other storage architectures having file systems that manage data as a file hierarchy and block storage within sectors and tracks. Objects may include the data itself, a variable amount of metadata, and a globally unique identifier. Some of the lower layers of storage may be abstracted away from any administrators of the FlexETP system 120 at FlexFunds Operations, Accounting or Sales (152-156) and applications with data managed as objects instead of files of blocks. Additional descriptive properties can be assigned to objects for better tracking, indexing or management. File metadata may be separated from the data as opposed fixed metadata and file systems with a filename, creation date, type, etc. Any object storage may provide for full function, custom and object-level metadata for the application that is specific or includes user-specific information and centralized management of storage, which is advantageous for the client documentation. Data may be organized into flexible-sized data containers as objects where each object may have data and metadata as the set of attributes describing the object and encapsulating both. A command interface may create delete objects and perform other functions.

It is possible for the file documentation to use a key/value store where data is identified by a key rather than a logical block number (LBN). It may be an arbitrary sequence of bytes of arbitrary length. Data may be stored by presenting the key and data (value) to the data store and data retrieved by presenting the key. The object store may be similar since an object identifier or URL as the equivalent of a key can be an arbitrary string and the data may be of an arbitrary size. An object store may allow one to associate a limited set of attributes as the metadata with each piece of data and the key, value and set of attributes may be referred to as an object.

The FlexETP non-relational, or in one example termed a NoSQL database 128a, such as the Mongo database, may use JSON (Java Script) Object Notation (ON) with those documents having schemas and support field and range queries and regular expression searches. Queries can return specific fields of documents and include the user-defined Java Script functions. This is advantageous for keeping track of client data and fields may be indexed with primary and secondary indices. Replica sets may be included with two or more copies of the data, each set acting in a primary or secondary replica. Load balancing may scale horizontally, using sharding. The user may choose a shard key to determine how the data in a collection will be distributed and split into ranges based on the shard key and distributed across multiple shards as a master with one or more slaves. One advantage of this modular database such as using a shard key is that it is possible to model the data the way it is naturally used such as for specific reports. There is still some flexible querying and it is possible to use rich, dynamic schema and easy scaling. For example, a data source may go through a JSON extractor program and have fewer JSON files.

This database 128a may include JSON with collections, tags, non-visible metadata and directory hierarchies. A preferred database interchange format is JSON that is language independent, but uses conventions similar to the C-family of languages. It may be built on two structures as a collection of names/value pairs and realized as an object, record, struct, dictionary, hash table, keyed list or associative array, and include an order list of values that is realized as an array, vector, or list of sequence. This may take on different forms in JSON as an object or as an unordered set of names/value pairs.

An object may begin with a left brace and end with a right brace, and each name followed by a colon. The names/value pairs may be separated by a comma. The array may be an ordered collection of values with an array beginning with a left bracket and ending with a right bracket and values separated by a comma. A value may be a string in double quotes or number or a true or false or null or an object or an array with the structures that could be nested. A string may be a sequence of zero or more unicode characters that are wrapped in double quotes and using backslash escapes. A character may be represented as a single character string similar to a C or Java string. The number may be similar to a “C” or Java number except octal and hexadecimal formats are not used. White space may be inserted between any pair of tokens. It is possible to use as Noted before the key-value store with the key concept of a document and crud operations. An example used with the FlexETP system is explained below.

The FlexETP relational database 128b, such as the SQL database, may keep track of issued series data for maintenance purposes. It uses the Structured Query Language (SQL) for querying and maintaining the database and organizes data into one or more tables or “relations” of columns and rows with a unique key identifying each row. The rows may be called records or tuples and each table/relation represents an entity type for an issued FlexETP. The rows represent instances of that type of entity and columns represent values attributed to that instance and related to the issued FlexETP, and in this current example, for example, data related to the FlexETP Series and similar entries. Each row in a table may have a unique key and rows in a table and can be linked to rows in other tables by adding a column for the unique key of the linked row. The SQL language is used as part of the programming and may include the clauses, expressions, predicates, queries, statements and significant white space that is usually ignored in SQL statements and inquiries. Different queries may include a from clause, where clause, grouping clause, having clause, bordered by clause, and distinct key words. An example server could be an SQL server such as from Microsoft as one non-limiting example.

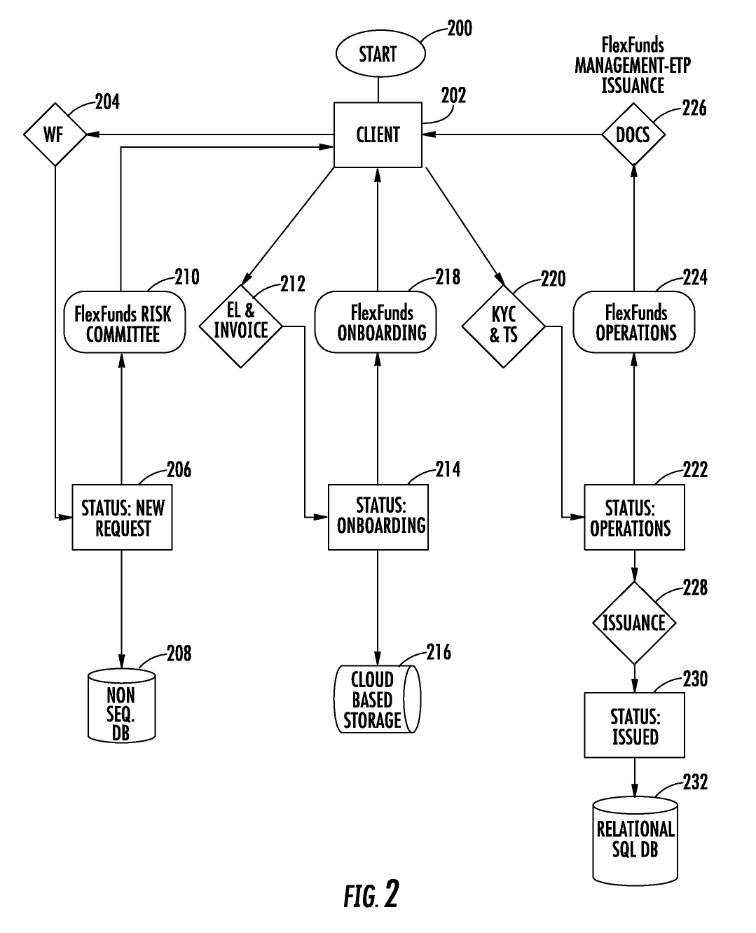

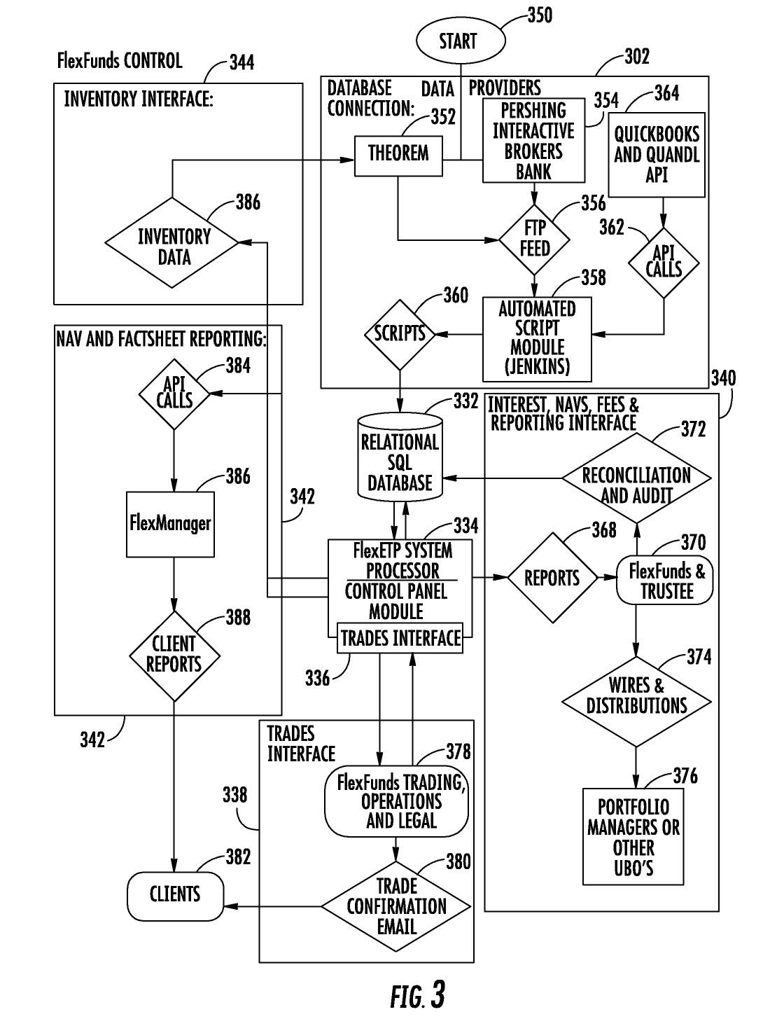

Referring now to FIGS. 2 and 3, there are shown the details of the data sequence and client actions related to the FlexManager module 140 as described above (FIG. 2) and in FIG. 3, the Control Panel 142. A brief summary of some of the logic, data flow and software processing is described, followed by a detailed analysis of the flowcharts. As noted before, the Control Panel 142 includes a communications data connection (database connection) 130 where data communication, in one non-limiting example, may be accomplished via PHP scripts. In an example, the automated scripts module 126b as an example that includes a Jenkins plug-in, for example, is written in Java and has continuous integration as a server-based system and may run in servlet containers. The automated scripts module 126b may have a node JS framework to increase the scalability of the automation and allow greater facility to parse CSV's/XLS (Excel) files to a respective database. The CSV files correspond to common-separated values that hold plain text as a series of values (cells) separated by commas and a series of lines and rows. The XLS, i.e., Excel (represented as XL) spreadsheet, or XLS as a workbook binary file that holds information about all worksheets in a workbook, includes both content and formatting for number masking, coloring, and conditional formatting and may hold additional information such as charts and images. It can be read by applications that have been especially written to read their format. This is advantageous for printouts and reports of the FlexETP system 120.

Using the automated scripts module 126b, it is possible to schedule different scripts and API calls to various providers such as Bank of New York Melon and Pershing and Interactive Brokers and Theorem as financial data providers, all which have communication capabilities similar to and with the FlexFunds accounting module and may include QuickBooks and Quandl platforms for financial, economic and alternative data to serve investment professionals. The financial data is accessible via an API that may be implemented through different multiple programming languages. It may include an Excel ad-in to allow access to data, including stock price information. Financial data may be acquired and formatted and errors removed and any aggregates made analysis-ready, and operate similar to a universal data parser. A BOT may return data in a standard format. It may run automated tasks (scripts) over the internet.

It is possible to host application software and a database in a One-and-One server. It has been found advantageous to use a cloud-based storage network database 128c as a file storage or depository for client documentation and have applications that may be built around containers, e.g., Docker containers, that improve significantly the flexibility and transferability of the backend of the overall application for the FlexETP system 120. Using Docker, it is possible to move from different cloud server providers if there is a necessity in the future.

Docker provides an additional layer of abstraction and automation such as for Windows and/or Linux and allows independent containers to run within a single instance to avoid the overhead of starting and maintaining virtual machines. Docker implements a high-level API to provide the lightweight containers, and thus, a single server or virtual machine can run several containers simultaneously.

Because the FlexETP system 120 requires financial security, the interface may interoperate with an Amazon Web Services Web Application Firewall (AWS WAF), which protects web applications from common web exploits that may compromise security or consume excessive resources. The FlexETP system 120 may control which data traffic to allow, block web applications, and define customizable web security rules. Custom rules may also be created. An operator or manager for the FlexETP system 120 may use an API to automate any creation and deployment in maintenance web security rules.

The AWS WAF may be integrated with a CloudFront program, which typically includes an application load balancer (ALB). The CloudFront operates as a web service that allows effective distribution of content with low latency and high data transfer speeds, and works with a Virtual Private Cloud and provisions logically isolated sections of the Cloud in order to launch various resources in a virtual network that the FlexETP system may define. This allows control over the virtual networking environment, including IP address ranges, subnets and configurations for route tables and network gateways. A hardware VPN connection could exist between the data providers and the virtual private cloud and leverage the AWS cloud as an extension of a corporate data center.

A Representational State Transfer (REST) Application Programming Interface (API) may provide interoperability among systems and may permit the FlexETP system to access and manipulate resources such as data from the different databases using a uniform and predefined set of stateless operations. The system may operate with an AWS Key Management Service (KMS) and manage encryption and provide key storage, management and auditing to encrypt data across the AWS services. An AWS CloudTrail may record API calls made on the account and delivers log files, for example, to an S3 bucket and provide visibility of the user activity since it records the API calls. The CloudTrail may record information about each API call, including the name of the API, the identity of the caller, the time and different parameters that may be requested or response elements returned by the service in order to track changes made to AWS resources and determine greater security and identity of users.

An Identity and Access Management (IAM) module could be implemented to allow the FlexETP system to control individual and group access in a secure manner and create and manage user identities and grant permissions for those users to access the different resources. The AWS Cloud HSM service may permit compliance with different requirements, including data security using a hardware security module appliance within the cloud. It may help manage cryptographic keys. A CONFIG module may permit compliance auditing, security analysis, change management, and operational troubleshooting. The different resources may be inventoried with changes in configurations and relationships reviewed. The REST API may interoperate with a loan rule engine and data warehouse in accordance with a non-limiting example.

Some of the FlexETP system applications may be built using node JS, angular JS, express and SQL framework. The node JS is a Java Script run-time environment for executing the Java Script code on the server-side instead of the client-side scripting to produce some web page content before the page is set for user's web browser. This is an advantage over PHP that functions in a PHP block until completion while functions in the node JS are designed to be non-blocking with commands executed in parallel and call backs to signal completion or failure. Threading may not be necessary in multiples because a simplified model of event-driven programming uses call backs. Thus, node JS may operate on a single thread using non-blocking input/output calls to support many concurrent connections. It may use a “libuv” library that uses a fixed-size thread pool. It may provide a unified API since a node JS can be combined with a browser and a database supporting JSON data such as a non-relational database 128a as a Mongo database, for example, and JSON for unified Java Script development stack. The angular JS may be a front-end web application framework and may read an HMTL page with embedded custom tag attributes and is part of the front-end for a MEAN stack that includes the non-relational database 128a as a Mongo database, for example, express JS web application server framework, angular JS, and the node JS server run time environment. The express JS may operate as the web application framework for the node JS and support the development of web applications such as for the client's side with the angular JS.

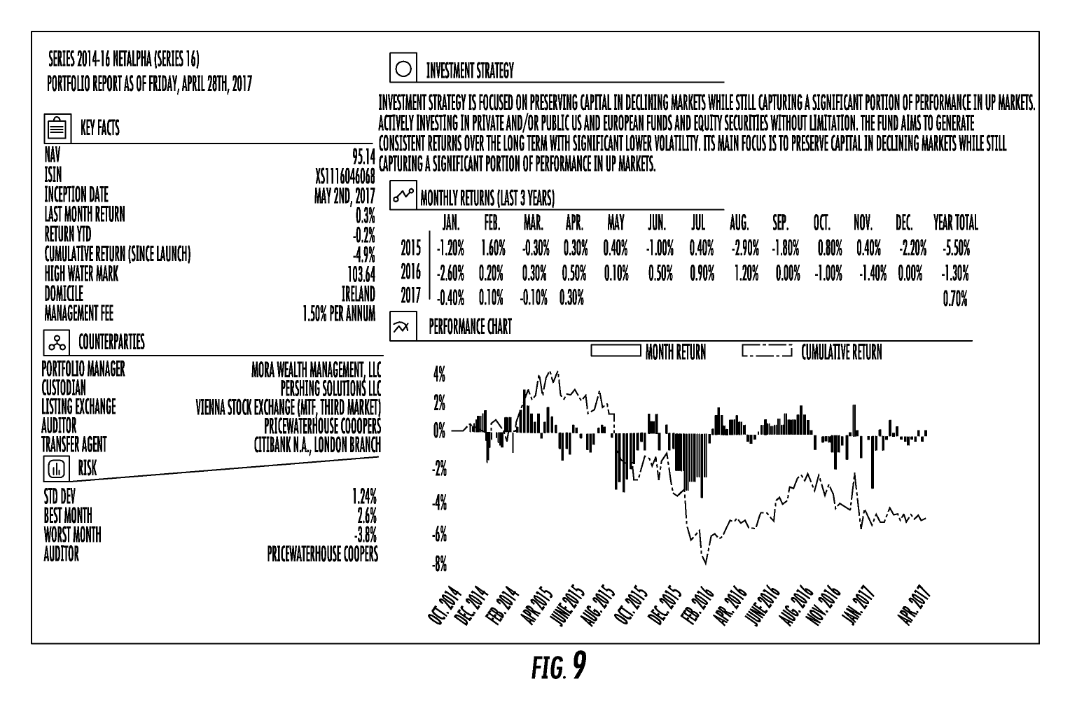

Several reports may be implemented and can be generated via the FlexETP system 120 to facilitate any annual audit and quarterly reporting to the Issuer 102 as an example, the Irish Central Bank as the FVC reporting of the Special Purpose Vehicles (SPVs) that the FlexETP system 120 manages. Thus, the reporting for the SPVs is automated. The representational state transfer (REST) API's can be used with FlexManager module 140 to access data from the SQL database 128b to generate factsheets and invoices and reports. The FlexManager module 140 may be aligned with information data flow and any sales made using the FlexETP system to allow factsheet generation using pricing data stored in the database. An example is shown and described below at FIG. 9.

There now follows details of a non-limiting example for the data flow and client interoperation with the FlexETP system 120 using the FlexManager module 140 as shown in the flowchart of FIG. 2 that may operate as an on-boarding tool for a client. Operators and managers using the FlexETP system 120, for example, part of the FlexFunds Operations 152, may log-in and at least one is an administrator and manages all users and clients. Specific examples are explained below and with reference to various screenshots.

The process starts (Block 200), and the client as an investor (Block 202) may fill out an initial workflow as an input for an interface to the FlexManager module 140. The client may operate from their desktop or office computer or even a wireless communications device, an iPad, for example, which displays the interface for data entry for the FlexManager module of the FlexETP system. A workflow (Block 204) is created at the FlexETP server 122, for example, via a FlexFunds sales department 156 operating with the FlexETP system, which may manage risk and term sheets and change information on a Series at a later date. A FlexFunds administrator may have full access and manage the FlexManager module 140 as part of the FlexETP system 120, while a client or investor would have limited access to various features except what is necessary for the client to conduct business and generate and receive data to complete transactions and view a Series and other details as explained below. As an example, there may be an unnamed Series that a client desires to enter into the system to create the workflow. It is not yet submitted, but the “Status” may be changed to New Request in progress (Block 206). The client submits information as part of the Workflow and the client receives a confirmation from the FlexManager module and information is saved in the non-relational database (Block 208), corresponding to the database 128a in FIG. 1, and in this example, the Mongo database.

The processing module 126 interoperates with the database 128a to adapt to the product and information that is asked the client as to the type of funds such as a FlexETP Fund or even a FlexETP Hybrid as including different parameters of a FLexETP Fund or Loan. The administrator of the FlexETP system and the client both have access and will view the data information as a new request. The Administrator may view the entire term sheet, Series information, administrative data and trustee information. When information is complete, the status changes to “new request (complete)” and is passed to a FlexFunds Risk Committee module such as an automated module that processes the data as to risk (although it could be a group) (Block 210), which will send an acknowledgement to the client. After studying the client data and risk, and if the issuance request is approved by the Risk Committee module, the FlexETP system 120 will process the request and an invoice and an engagement letter (EL) are sent to the client to be completed and invoicing occurs (Block 212). After the client pays the set-up invoice and signs the engagement letter, the status moves to Onboarding (Block 214) as part of data processing and data flow at the FlexETP system. It should be understood that the invoicing may be accomplished in one or two months. At the Onboarding stage after the Risk Committee module has approved, the client receives and signs the engagement letter and an invoice is generated automatically by the FlexETP system. Signatory and other information about who will be paying for the set-up may be maintained, which can be accomplished via the FlexFunds Accounting module 144.

When the invoice is paid, the engagement letter has been signed, and the KYC and similar details accomplished, any client documentation may be saved within the cloud-based storage network database (Block 216), corresponding to the storage database 128c of FIG. 1. This storage also provides an interface such as a web based interface for a FlexFunds Administrator as part of the FlexETP system. The client may also view some of the transactions and required documentation throughout the process and may upload the files. This would be helpful if the KYC security requirements and documentation changes with the underlying securities, of course.

The FlexFunds Onboarding process continues in conjunction with the client input (Block 218) and the FlexFunds Operations as part of the FlexETP system Onboarding and contacts the client to upload the KYC information and the FlexFund Sales as part of the FlexETP system finalizes the structure of the transaction. It is possible that the KYC may be done at a US broker in this instance. Once the KYC and TS (Term Sheet) are completed (Block 220), the status moves to FlexFunds Operations (Block 222) as part of the FlexETP system. The terms of the transaction are completed and when the KYC is done and the status is moved to FlexFunds Operations, the Series documentation is drafted by the Operations (Block 224) of FlexFunds using the FlexETP system, which drafts and outputs the complete Series documentation (Block 226).

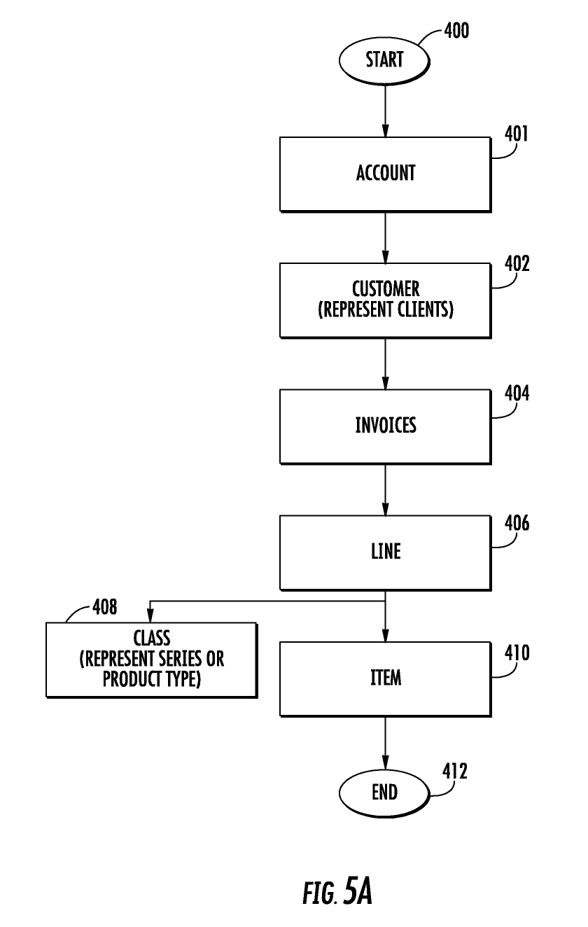

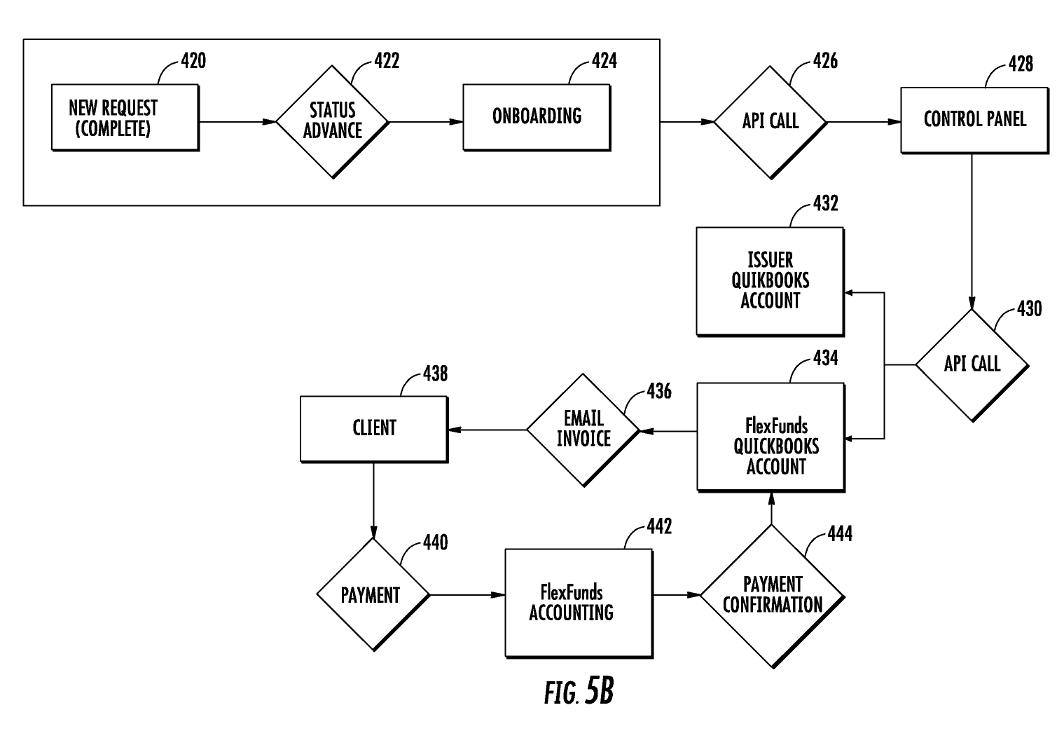

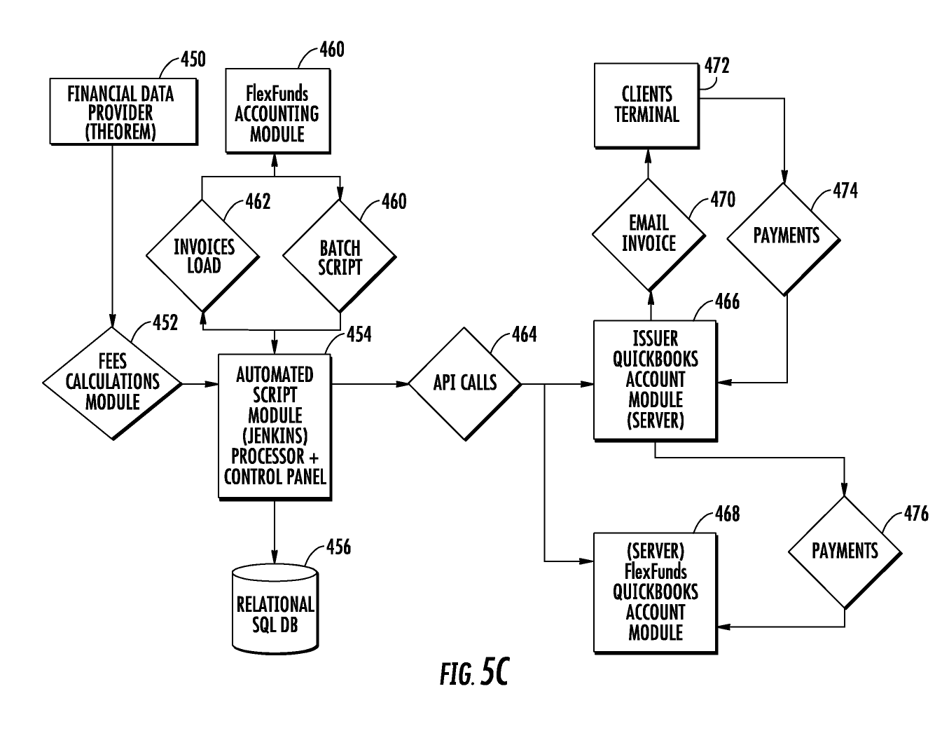

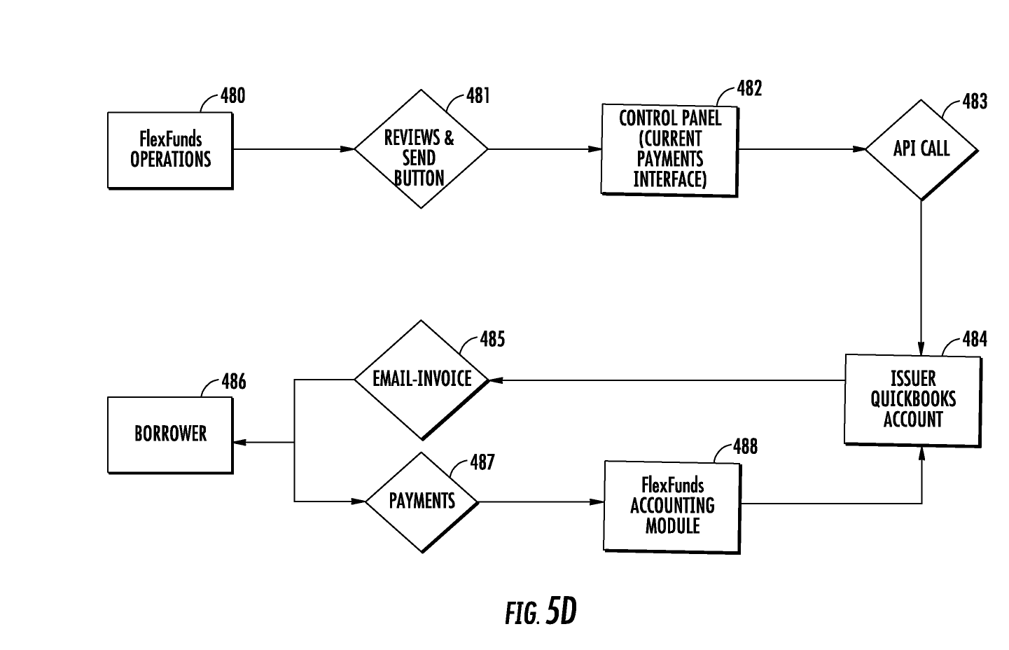

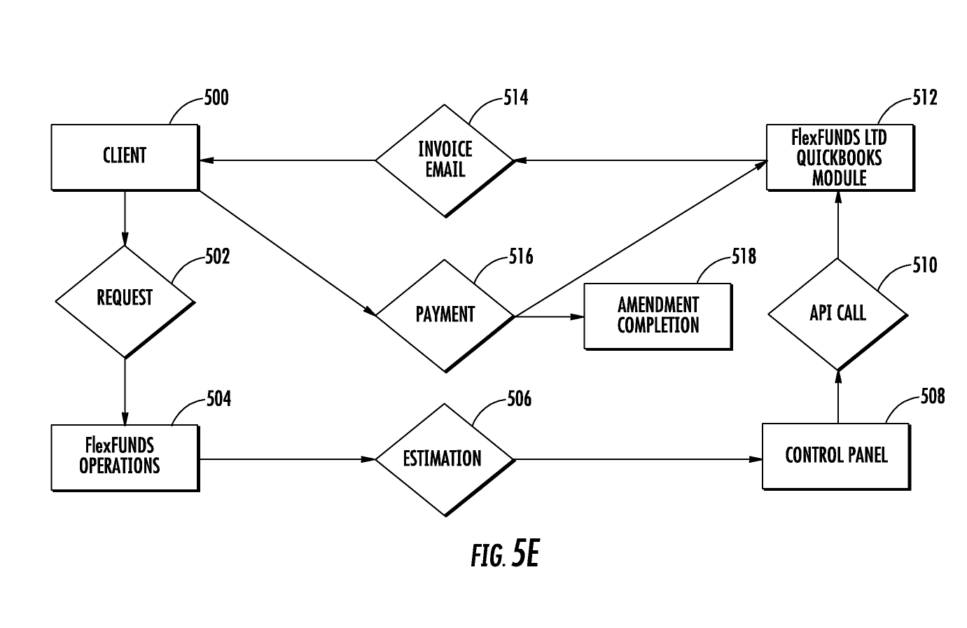

When the client is satisfied with the Series documentation, they may enter into the Series Issuance process (Block 228), which may occur over a period of two weeks. The securities will be dated and include an ISIN and a Bloomberg page. The Series issues and after issuance (Block 230), the client may begin trading. All relevant information regarding the issued series data is saved in the SQL database (Block 232) and the system automatically accomplishes that without manually inputting data. The documents from the client are stored into the cloud-based storage network database 128c having an appropriate application interface so that a FlexManager module 140 via the FlexETP system and/or client can view and/or retrieve any documentation. As explained relative to the explanation of the Control Panel in the next flowchart in FIG. 3, further details of the SQL database are explained. Accounting and invoicing are described in the flowcharts of FIGS. 5A to 5E.

Referring now to the flowchart of FIG. 3, the data flow and control among components for the Control Panel 142 as shown in FIG. 1 is described. The Control Panel helps manage the FlexETP Series or product as a Note in conjunction with the data flow and data management at the FlexETP system 120 and FlexManager module 140. A series manager and any administrator of the FlexETP system are able to view data and reports via an interface 158 connected to the FlexETP server and enter data to track and control the overall trade volume and the particular trades. It should be understood that an administrator works closely with a client or investor to draft Series documentation and finalize Series issuance, while relevant data for Series maintenance is stored in the SQL database 128b.

There now follows details regarding the flowchart (Block 300) for the Control Panel 142 illustrating the information flow and portions of the FlexETP system architecture. The Control Panel is also referred to by Block 334 in this flowchart and operates as an internal tool for the FlexETP system 120 used by the client as investor and FlexFunds Operations, Accounting and Sales (152-156) of the FlexETP system. Large amounts of data involved in the issuance of a FlexETP Series and any associated securities and it is difficult to keep track of these large amounts of data with numerous clients. The Control Panel (Block 334) operates as a centralized tool that the different departments, including the client and investors, may use. Naturally, it includes the processing capability of the processing module 126. Scripts, for example, Java Scripts, may read files and place data within the various databases as described, for example, the SQL relational database 128b, with various tables that keep track of different reports and the issued Series data to assist in maintenance of a large number of Series and clients. It is possible to use the automated scripts module 126b to schedule scripts and manage them in a unique manner. Data may be saved to the various databases on a daily basis and scripts run on a daily basis.

The different transactions from financial institutions and the inventories are maintained via the FlexManager module 140 and Control Panel 142 to track various orders and permit communications as the wires, monies or invoices that have been sent. Information regarding the legal documentation to support a transaction may be displayed on an interface and the Control Panel 142 as a tool allows communication between different departments operating the FlexETP system 120 and the client or investor via interface pages. It allows trade confirmations to be sent to a client or investor, which has access to much of the data regarding each Series not only from a Bloomberg perspective, but also via a client interface tool. On a periodic basis, the FlexETP system sends client reports. Any FlexFunds staff working from the FlexManager module 140 or FlexFunds Accounting module 144 may log into the system and via the Control Panel have the FlexETP system calculate fees and make payment reports. In a preferred embodiment, this is done automatically.

As noted at FIG. 3, showing the Control Panel 334 and information flow architecture, the communications data connection, i.e., database connection (Block 302) connects via internal components with the SQL database (Block 332) and operates in conjunction with the Control Panel (Block 334) that is associated as the processing module 126 (FIG. 1) and configured to send and receive data via a trades interface communications module (Block 336), which transmits and receives data and operates with a Trades Interface (Block 338). The Control Panel (Block 334) also interoperates with another fees and reporting interface (Block 340) that may show the interest, payment wires, some NAV data, and other fees. The Control Panel (Block 334) may also transmit and process data to generate a NAV and Factsheet reporting interface (Block 342) and an inventory interface (Block 344).

The process starts (Block 350) database connection (Block 302) allows the FlexETP system 120 to connect to different financial data providers such as Theorem (Block 352) that operates as a financial services provider and may calculate the NAV and also data providers like financial institutions such as Bank of New York Melon or Pershing or Interactive Brokers (Block 354). Different brokerage accounts may obtain statement data and data is received in one example using sFTP (File Transfer Protocol) (Block 356).

On a daily basis, financial data providers 352, 354 send FlexFunds files and data through an sFTP, for example, but other connections may be used. The components may interoperate with the automated scripts module 126b, for example, also including a Jenkins plug-in having code written in Java (Block 358). The automated scripts module 126b permits system efficiency and may run in servlet containers and schedule via a cron-like mechanism and request a specific billed URL. On a daily basis, the data providers, including Theorem or the interactive brokers such as Bank of New York Melon or Pershing, will send their data files via the sFTP feed in one non-limiting example for use by the FlexETP system 120.

The automated scripts module 126b (Block 358 in FIG. 3), including the Jenkins plug-in, is a framework where different scripts (Block 360) may be input and the FlexETP system and its operators may decide how they can be scheduled and what parameters are entered. Operators at the FlexETP system may develop the scripts while others may run them. Reports as data may be obtained from the data providers, such as Theorem or the interactive brokers such as Bank of New York Melon or Pershing, and the automated scripts module having the Jenkins plug-in may support API calls (Block 362) from the FlexFunds Accounting module 144, including QuickBooks and a Quandl application having an application programming interface (API) (Block 364) and the data is fed through API calls. The automated scripts module 126b as a Jenkins plug-in or service, may also send API calls to the FlexFunds accounting module and retrieve the data as explained in greater detail below with reference to the flowcharts of FIGS. 5A to 5E. The financial data providers, such as Theorem in this one example, may perform the calculation for the NAV for each of the securities and fees as part of a Series.

For example, some securities may have a portfolio management fee and performance fees such as an arranger fee. The conversion may occur through the scripts and data saved in the SQL database. The Control Panel (Block 334) interoperates with the fees and reporting interface (Block 340) for the interest, NAV's and that reports are generated (Block 368) regarding fees and other items as explained later. Through the fees and reporting interface (Block 340), operators at FlexFunds via the FlexETP system 120 and the trustee or issuer such as the Irish Bank in this example can see a record of interest and fee payments as well as the NAV's of each Series for auditing and reporting purposes. If any mistakes are found, the FlexETP system 120 can reconcile the data in the various databases as needed. With the data provided by the Control Panel (Block 334), FlexFunds accounting operating via the FlexFunds accounting module 144 can place wires via portfolio managers or other fees with accounting reconciliation for maintenance invoices and workflow as explained below. FlexFunds and the Trustee (Block 370) interoperate with a reconciliation and audit module (Block 372) that transfers the data to the relational or SQL database with any data reconciliation. The FlexFunds and Trustee (Block 370) may also send any necessary wires and distributions (Block 374) to the portfolio managers or other UBO's as Ultimate Beneficial Owners (Block 376).

The securities in some examples may not have daily NAV's and may be reported weekly or monthly. For example, if a real estate lot or land is wrapped within a FlexETP Wrapper, it is not necessary to calculate a daily NAV since the asset does not have liquidity. The daily NAV's, which can be established, would be more opportune for the liquid securities like stocks and mutual funds and the FlexETP system can generate that data.

Also, the FlexETP system 120 may calculate the NAV's instead of using any financial data provider such as Theorem financial services or other financial service providers. The client reporting is advantageous for annual audits and also quarterly reporting to the trustee such as the Irish Central Bank as an example, which uses the data and accounts information to keep track of the information. For each of the accounts, typically line-by-line reports can be made, indicating whether each portfolio bought or sold a specific security while also maintaining track of the countries of the securities and determining fair value and a series variation, thus keeping track of the Notes. The FlexETP system 120 may determine the opening position, sales, purchases, and closing positions, and generates reports so that not only managers of the FlexETP system, but also the client or investor may view the facts and results. Thus, raw data from the accounts are organized to coincide with the reporting standards of specific countries or even clients and for the requirements from the trustee. The assigned auditor for the FlexETP system may view the transactions. As to the wires and distribution based on the data, the FlexFunds accounting module and any associated personnel can know how much to wire to portfolio managers of certain fees and send invoices. Wires can be done manually and/or automatically and invoices generated automatically, of course.

At the trades interface (Block 338), the Control Panel (Block 334) interoperates with a FlexFunds trading, operations and legal module (Block 378). Through this interface, it is possible to view executed trades, manage the Notes inventory, confirm legal documentation and record wires and subscriptions data. The FlexETP system 120 may issue a trade confirmation (Block 380) that is emailed to the clients (Block 382). At this point, there may be some matters that have to be accomplished to finish the life cycle of the transaction, such as receiving the legal documentation for the transaction, for example, buying a FlexETP Wrapper where a subscription agreement must be signed.

Once the legal matters are accomplished and documents stored in the cloud-based storage network database 128c and client data stored in the non-relational database 128a such as the Mongo database, and any Series data in the relational database 128b if there are any possible changes or updates, the funds can be wired such as via a trading department. It is possible to use widgets or confirmatory buttons on an interface. A manager or automated system for the FlexETP system 120 can initiate wire payments or initiate an order such as when there are any subscription fees or any accrued interest payments or confirm legal documents. Once the life cycle for the transaction is over, the FlexETP system 120 can ratify with trade confirmations that a client bought “X” amount and have a receipt of the transaction generated and forward it by email.

At an NAV and Factsheet reporting interface (Block 342), the FlexETP system can retrieve performance data from the SQL database via API calls (Block 384) and operate with the FlexManager module (Block 386) as part of the FlexETP system via the interface. Also, via the FlexManager module 140 and its interface, the client can view and if necessary print a factsheet report and/or invoices report all as part of client reports (Block 388). Once transactions are fully completed, an email may be sent to the client. An API call may be sent to the Control Panel 334 in response to a client action to request performance data for their particular Series. It is possible the client may request via a call, such as an API call, a performance sheet that can be emailed. Sometimes a FlexETP product can have multiple accounts via a financial institution such as Bank of New York Melon or Pershing or Interactive Brokers and it is possible to obtain a final performance report or sheet that includes information the client requested or uses. All the costs could be billed into each Series that is issued. It is possible to generate a PDF file and download the disclosure and other reports. It is possible to see all the invoices as an invoice report such as a fees invoice. At the inventory interface (Block 344), the data providers such as the Theorem financial services or Interactive Brokers, may generate data that is processed and receive inventory data (Block 386) and via displays and interfaces, such as a GUI, view inventory data via the FlexETP system and any transactions may be processed and viewed relevant to the NAV calculation at the pricing and inventory interface.

An example of JavaScript financial data used in the non-relational database 128a for the FlexETP system 120 and an associated Series is explained below. This layout shows modular data units as an example. The names of individuals are removed, but the data layout shows such matters as account, administration, e.g., issuer or ranger, trustee, the issue agent, paying agent, auditor, placing and sales agent, the soliciting and calculation agent, and other financial data matters, including fees such as the management fees, and various currencies and investment restrictions and strategies, with containers as examples. This generic JavaScript layout is only a non-limiting example and the database will include substantially more details for particular clients, Series and other factors.

### Example: Stored Data

```
{
    “_id” : ObjectId(“599b621d9”),
    “type” : “fund”,
    “hasPortfolioManager” : true,
    “isDeleted” : false,
    “payerIsNotSigner” : false,
    “maintenancePayerIsNotSigner” : false,
    “periodicInterestPayments” : false,
    “ownerId” : ObjectId(“59944d58”),
    “companyId” : “5976c9”,
    “_multiPortfolioManagers” : [
        {
            “name” : “Example Portfolio Manager”,
            “address1” : “Example Portfolio Address”,
            “address2” : “Example Portfolio Address”,
            “isRegulatedEntity” : true,
            “countryOfJurisdiction” : “united_states_of america”,
            “description” : “Example Portfolio Manager Description”,
            “id” : ObjectId(“599b62a79b”),
            “ownerId” : ObjectId(“59944d5”),
            “_contacts” : [
                {
                    “name” : “Contact Example”,
                    “telephoneNumber” : “Telephone Example”,
                    “email” : “example@example.com”,
                    “description” : “Description 1”,
                    “id” : “daed7673-d91a”
                }
            ]
        }
    ],
    “_bank” : {
        “name” : “Example Portfolio Manager”,
        “address1” : “Example Portfolio Address”,
        “address2” : “Example Portfolio Address”,
        “isRegulatedEntity” : true,
        “countryOfJurisdiction” : “united_states_of america”,
        “description” : “Example Portfolio Manager Description”,
        “id” : ObjectId(“599b62a79b”),
        “ownerId” : ObjectId(“59944d5806”),
        “_contacts” : [
            {
                “name” : “Contact Example”,
                “telephoneNumber” : “Telephone Example”,
                “email” : “example@example.com”,
                “description” : “Description 1”,
                “id” : “daed7673-d91a”
            }
        ]
    },
    “trancheIds” : [ ],
    “_investmentStrategy” : {
        “horizon” : “10 years”,
        “objective” : “Example Investment Objective”,
        “strategy” : “Example Investment Strategy”,
        “isinExamples” : “XS1236316631”,
        “navCalculationFrequency” : “monthly”,
        “benchmarkIndex” : “N/A”,
        “navReportDate” : “week”
    },
    “_account” : {
        “swiftBicCode” : “Example Swift BIC”,
        “accountName” : “Example Bank Account Name”,
        “accountNumber” : “Example Routing Number”,
        “paymentAccountNumber” : “Example Account Number”
    },
    “_administration” : {
        “issuer” : “IA Capital Structures (Ireland) PLC.”,
        “arranger” : “FlexFunds Ltd.”,
        “trustee” : “Sanne Fiduciary Services Limited -
www.sannegroup.com”,
        “issueAgent” : “Bank of New York Melon N.A., London
        Branch”,
        “payingAgent” : “Bank of New York Melon N.A., London
        Branch”,
        “auditor” : “PriceWaterhouse Coopers”,
        “placingAndSalesAgent” : “Both GWM Group, Inc. and
        GWM LTD”,
        “listing” : “Vienna Stock Exchange (MTF, Third Market)”,
        “ratingAgency” : “Not Rated”,
        “calculationAgent” : “FlexFunds Ltd.”
    },
    “_furtherIssuances” : { },
    “_provisions” : {
        “fixedRateNoteProvisions” : false,
        “floatingRateNoteProvisions” : false,
        “zeroCouponRateNoteProvisions” : false,
        “dualCurrencyNoteProvisions” : false,
        “variableCouponRateNoteProvisions” : true
    },
    “_custody” : {
        “accountProvider” : “Interactive Brokers,Bank of New York
Mellon”,
        “accountNumber” : “Example Custody Account Number”,
        “custodian” : “Example Custodian”
    “_fees” : {
        “principalAmount” : “100,000.00”,
        “minimumInvestment” : NaN,
        “currency” : “USD”,
        “authorisedDenomination” : “USD 1,000”,
        “issuePrice” : “100% of the Authorised Denomination”,
        “arrangerFee” : “30 bps up to $50M; 25 bps up to $100M;
20 bps with Interactive Brokers Custody; Minimum €1,500 / month”,
        “setupFee” : “€ 12,000”,
        “administratorFee” : “”,
        “administrationFee” : “”,
        “sumArrangerAndAdministrator” : “”,
        “managementFee” : “2% ”,
        “performanceFee” : “20%”
    },
    “_information” : {
        “name” : “FlexETP Fund Example (Series 101)”,
        “lowerCaseName” : “flexetp fund example (series 101)”,
        “dueYear” : 2037,
        “number” : 101,
        “isin” : “Example ISIN”,
        “commonCode” : “Example Common Code”,
        “createdDate” : ISODate(“2017-08-21T22:43:41.756Z”),
        “issueDate” : ISODate(“2017-08-21T04:00:00.000Z”),
        “scheduledMaturityDate” : ISODate(“2017-08-
        22T04:00:00.000Z”),
        “requestedIssueDate” : ISODate(“2017-08-21T22:47:49.816Z”)
    },
    “_otherInformation” : {
        “optionalRedemption” : “Redemption at the option of the
Noteholder and at the option of the Issuer shall apply. Limited
periodic redemption depending on underlying securities.”,
        “formOfNotes” : “Temporary Global Notes exchangeable for
Permanent Global Notes, held with Bank of New York Melon as common
depositary on behalf of Euroclear & Clearstream.”,
        “mandatoryRedemption” : “Where applicable, as set out in the
Programme Memorandum and/or Series Memorandum.”,
        “deliveryMethod” : “Free of payment.”,
        “securityInterestDescription” : “Security is created over the
Charged Assets pursuant to a Trust Deed governed by Irish law.”,
        “governingLaw” : “Irish Law”
    },
    “_interest” : {
        “commencement” : “At the funding of the Series”
    },
    “_investmentRestrictions” : {
        “debtInstruments” : “0-100%”,
        “equities” : “0-100%”,
        “listedOptionsAndDerivatives” : “0-100%”,
        “fx” : “0-100%”,
        “ratingRestrictions” : “There are no restrictions on the
rating of the underlying investments.”,
        “maximumLeverage” : “100%”,
        “riskMeasurement” : “Value at Risk (VaR)”
    },
    “orderIds” : [ ],
    “_status” : {
        “status” : “onBoardingStarted”,
        “statusDate” : ISODate(“2017-08-21T22:47:49.816Z”),
        “statusOrder” : “2”,
        “contactIds” : [ ]
    },
    “seriesStatusIds” : [
        ObjectId(“599b621d9bcad81”),
        ObjectId(“599b63059bcad810”),
        ObjectId(“599b63159bcad8100”)
    ],
    “_signatory” : {
        “name” : “Example Signatory”,
        “email” : “example@example.com”,
        “cc” : “example2@example.com”,
        “company” : “Example Company”,
        “addressLine1” : “Example Address”,
        “addressLine2” : “Example Address”,
        “country” : “united_states_of america”
    }
}
```

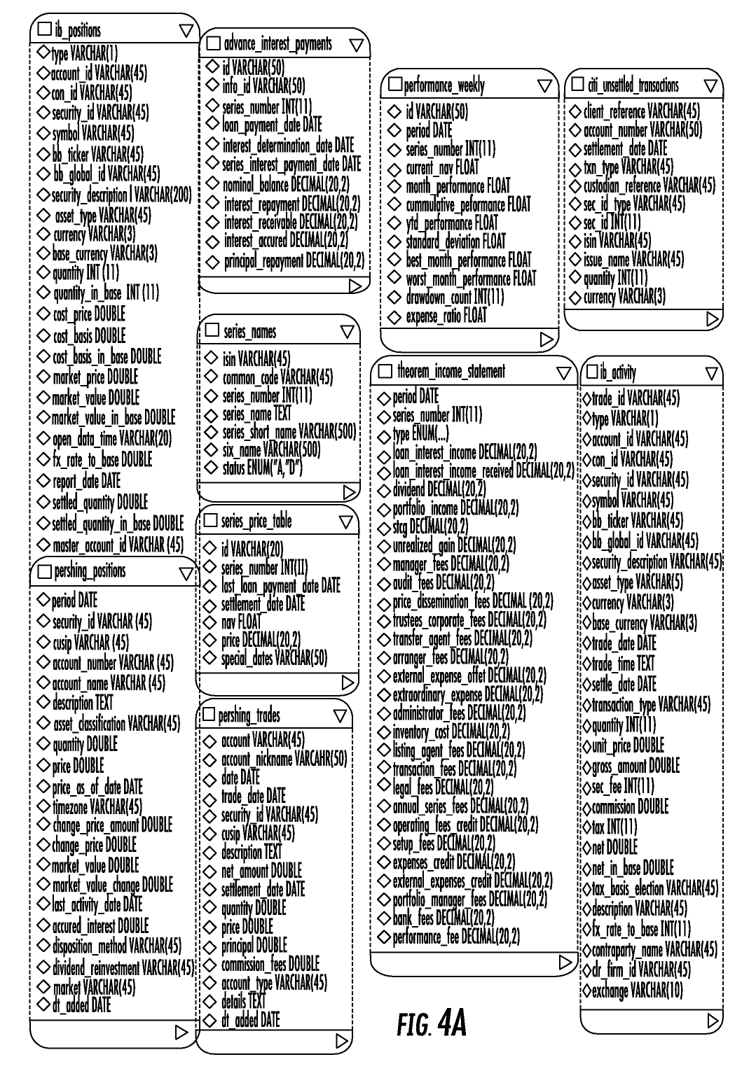

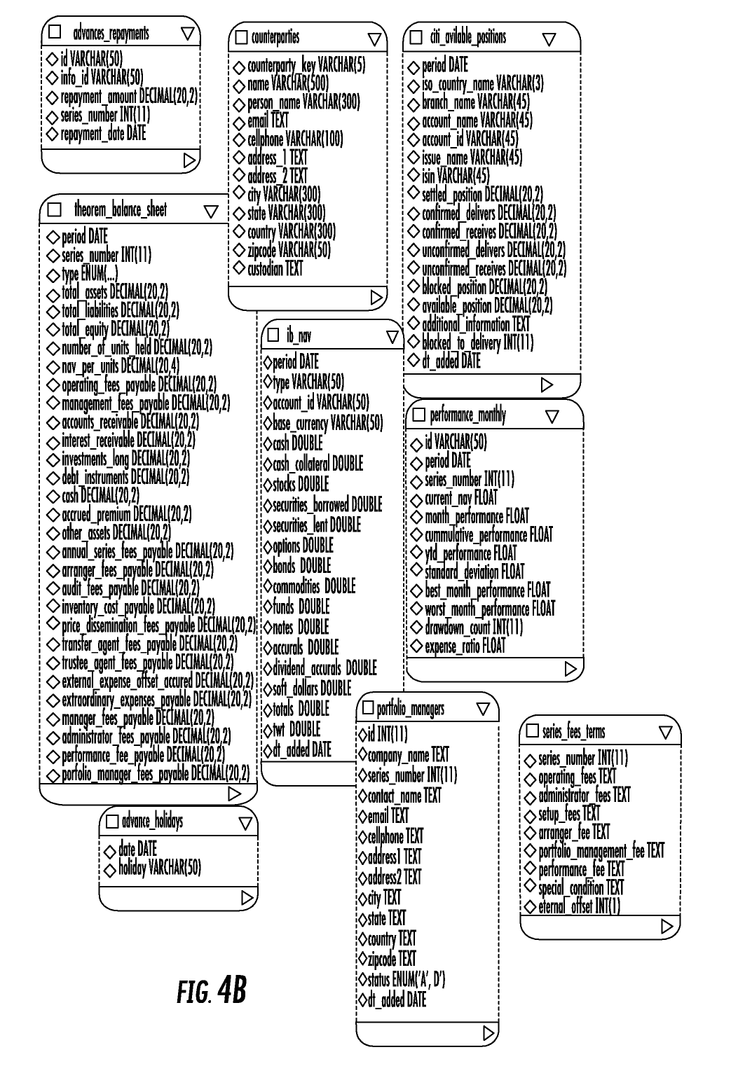

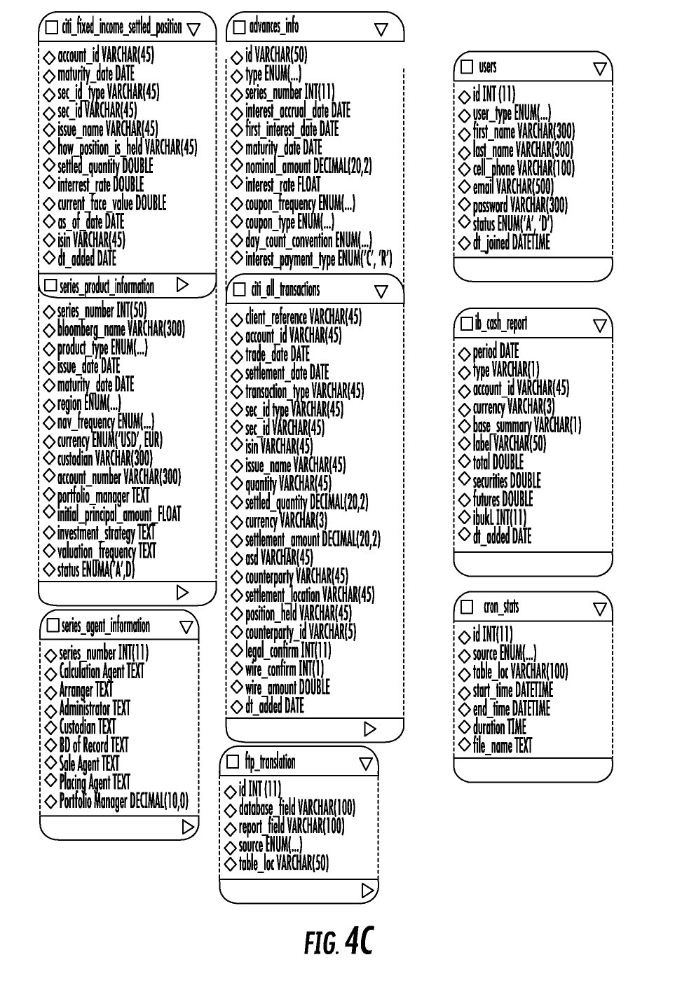

Referring now to FIGS. 4A, 4B and 4C, there is shown a partial entity relationship diagram (ERD) for the SQL database 128b as a relational database, showing an example of the data tracking for the FlexETP system 120 and an issued Series for maintenance and other data driven purposes and showing the type of data that may be maintained. Although this representation is partially incomplete as an ERD diagram, its purpose is to show as a non-limiting example the data that may be used for the positions and trades with performances and what kind of items, including the data from Theorem or Interactive Brokers for income and what repayments in the balance sheet occur, all as non-limiting examples.

Referring now to FIGS. 5A through 5E, there are illustrated details of the data flow and operation of the FlexFunds accounting module 144 and the different invoice processing with a general overview of the FlexFunds accounting model shown in FIG. 5A, and illustrating the basic data integration and control parameters. It should be understood that one of the inputs is accounts receivable as a basic balance sheet data item, with the balance sheet including assets, liabilities and equities as is known. There are a number of balance sheets with data to be provided, for example, the arranger as FlexFunds that operates the FlexETP system and a balance sheet could accrue for the issuer, in an example as IA Capital, and another such as ETPX. If there are a number of issuers and clients, then each issuer may have its own accounting module that includes a QuickBooks account, for example, to track balance sheets and income statements for reporting purposes. FlexFunds as the arranger operating the FlexETP system 120 may be a service provider to the issuer, and in one model includes modeling for hard assets such as from the issuer.

Databases include data received from financial data providers such as Interactive Brokers or Bank of New York Melon or Pershing, and can be entered to the accounting module. Issuers, financial data providers, customers and investors may have separate accounting modules that include data for any assets, liabilities and equity. One account could have multiple customers and the customers representing clients of the FlexETP system 120 in one example. Customers may have multiple invoices that are sent to them and invoices may have line-by-line items. An invoice may be for interest payments and from a customer with respect to multiple lines, where each item presents a specific service that is provided and stored in an accounting database and operative as a modular tool.

As shown in FIG. 5A, the process starts (Block 400) and every accounting module, e.g., using a QuickBooks account, may have many customers that are invoiced (Block 401). The customer represents the clients (Block 402) and a customer has objects that hold billing information of the client. The customers may have many invoices (Block 404), which have objects that hold information from specific transactions and invoices have many lines. Each line (Block 406) represents the breakdown of each variable of the invoice, and lines with amount values are linked to a class and item within the database.

The classes represent the actual product, which for the issuer may be the series number and for the FlexFunds management operating at the FlexETP system is a product type (Block 408). Thus, the class represents a series or product type. The items (Block 410) may represent the income statement field it represents and the process ends (Block 412). It is thus possible to create many different matters such as an interest payment or interest payable based from what is stored in the database. As noted, the class may represent series or product type, with the product type corresponding to what FlexFunds as the system is selling. For the issuer, it could be the Series number and the FlexETP system may keep track of everything that happens for one particular Series. Customers could have multiple Series as noted before and the item could be the product and service.

Referring now to FIG. 5B, the data flow and operations of the set-up process for invoice generation is shown. This data flow and processing may occur within the FlexManager module 140 and interoperate with the Control Panel as shown in FIG. 3. Automatic invoices are generated when the client passes from a New Request that is complete (Block 420) and the status advances (Block 422) to Onboarding (Block 424). Once a Series moves to this Onboarding (Block 424), a post-API call (Block 426) with the relevant data is forwarded to the Control Panel (referred to at Block 428 in this example), which receives the API call (Block 426) and processes the data and sends API calls (Block 430) to various accounting modules as shown by the Issuer accounting module (Block 432) as may include a QuickBooks account, as part of a FlexFunds account module and QuickBooks account (Block 434). The API call initially with the New Request (Block 420) and Onboarding (Block 424) is an API call from the FlexManager module to the Control Panel, which processes data to ensure that it is defined correctly and what the fees are that are stored by the Control Panel via the database. For each different type of product, there could be a different fee processed by the Control Panel, and thus, retrieve selected data from the database. With the API calls to the Issuer and FlexFunds accounting modules (Blocks 432 and 434), a new customer is inserted for a new client and a new invoice is inserted as to the FlexFunds accounting module.

As noted before, the Control Panel (Block 428) manipulates this data that it receives from the Onboarding with the client information and the type of product that it wants to issue and sends the API call (Block 430) to both the issuer accounting module (Block 432) and the FlexFunds accounting module (Block 434). At this stage, a customer account is created in the issuer accounting module for future maintenance purposes and both a customer account and invoice are created in the FlexFunds accounting module (Block 434) so that it can send an email invoice to the client (Block 436). Once the client (Block 438) makes the payment (Block 440), the FlexFunds accounting module (Block 442) will match the transaction with the payment and do so automatically such as through email in one non-limiting example. In the email there would be an option to pay. As illustrated, the FlexFunds accounting module emails an invoice (Block 436) to the client (Block 438), which makes payment (Block 440) through the FlexFunds accounting module (Block 442). The payment confirmation (Block 444) is accomplished when the payment is merged with the invoices and the transaction is complete.

Referring now to FIG. 5C, there is shown the architecture and data flow for the maintenance fees invoicing and processing. Every month, the financial data providers such as the financial services provider as Theorem (Block 450) in a non-limiting example or Interactive Brokers may send fee calculations to the FlexETP system (Block 452). As noted before, the FlexETP system incorporates the automated script modules such as including a Jenkins plug-in as a processing module (Block 454), which receives the fees calculation data that is saved or inserted to the SQL relational database (Block 456) using a “Jenkins billed in Theorem income statement file,” which is a particular file and format for saving this fees calculation data. Also the automated scripts module interoperates with the FlexFunds accounting module (Block 458) using a batch script from the FlexFunds accounting module (Block 460) and invoicing a load as data for invoices that are uploaded to the FlexFunds accounting module (Block 462). This data may be loaded into a temporary table in the relational database as an example where the FlexFunds accounting module can reconcile the data prior to running a script that would generate the report, e.g., as to a batch script.

The Control Panel may aggregate quarterly data and send invoice POST requests (Block 464) to the issuer accounting module (Block 466) that may include a QuickBooks account in this example. The invoices from the Issuer accounting module are payable by clients. Additionally, the Control Panel will generate POST requests as an API call to create invoices in the FlexFunds accounting module (Block 468) where the entity responsible for paying is the Issuer.

As is known to those skilled in the art, a POST request is a request method supported by the HTTP protocol where a web server is requested to accept the data enclosed in the body of the request message, such as for storing the data. The representation or data enclosed in the request is processed according to the resources' own specific semantics such as when uploading a file or submitting a completed web form. Many different amounts of data may be sent to the server in the body of the POST request message. In an example, the header field in the POST request indicates the internet media type for the message body.

The Issuer accounting module and via API calls will email an invoice (Block 470) to clients (Block 472). Once the payment (Block 474) is completed and recorded to the issuer accounting module (Block 466), the arranger fees (FlexFunds) can be forwarded to the FlexETP system via the FlexFunds accounting module. Payments are made (Block 474) to the account issuer accounting module (Block 466), which makes payment (Block 476) to the account of FlexFunds accounting module (Block 468). Once payments are received by FlexFunds, the invoice is closed.

This maintenance fee process as described is distinct from issuing the security. A financial data provider operating as a financial services provider such as Bank of New York Melon as the issuance paying agent has typically established due diligence for the FlexETP system to set up the security after listing the ISIN and creating a Bloomberg page for issuing the security. Once that security is issued and funded, the FlexFunds accounting module may receive from a financial data provider such as Theorem operating as a financial services provider or Interactive Brokers as a financial data provider the various fees to be paid.

Every month and every week, the FlexFunds accounting module receives data from the financial data providers such as the financial services provider, e.g., Theorem, or a financial data provider such as Interactive Brokers, a fee calculation using a communications protocol such as sFTP or other communications protocol. The fee may be calculated within a processor and the automated scripts module 126b stores the data in a database such as the relational database 128b. The FlexFunds accounting module 144 will retrieve the data from the database and produce an invoice load as an algorithm that manipulates the data to set it up as an invoice. The FlexFunds accounting module will load the data into a table via the Control Panel, which processes that data for accuracy, and may even include manual oversight. It is possible to generate a batch script and send an invoice for each one of the clients, and even for one script, it is possible to have the invoicing done for one client. The FlexETP automated scripts module that may include the Jenkins plug-in may generate an API call to the Issuer account at the Issuer accounting module and also the FlexFunds account at the FlexFunds accounting module. The fee is payable from the client to the Issuer, but also payable from the Issuer to the FlexFunds accounting because FlexFunds is the service provider of the Issuer and both have to be recorded. The fees may be reconciled, but only one record for the arranger fees and the client may receive an email and make a payment, which can be matched with the FlexFunds account.

FIG. 5D shows an interest invoicing and payment processing data flow. When loans are securitized, interest is paid to the Issuer and FlexFunds via the FlexETP system 120 as the arranger, which can notify the borrower when it is time to pay the interest. The FlexETP system 120 may calculate the interest and notify the borrower as calculation agents. Although there is no legal responsibility for notifying the borrower, as a service this may be provided. The borrower in the past may have calculated such payments, but the FlexETP system bypasses that task and calculates it for them, and may invoice 30 days before payment. In the relational database 128b and other databases possibly, the data is stored for the interest calculations together with other data that is used to calculate the interest rates for each one of the FlexETP products and any profits and how much is to be paid and current payments.

The FlexETP system 120 includes a current payment interface to review interest calculations and allow automatic or manual “send” actions to invoice the borrower. A tab could be implemented for manual confirmation and transmission. The FlexFunds Operations (Block 480) may automatically review and transmit automatically or via a “send button” (Block 481) to the Control Panel and a current payment interface (Block 482) and send an API call (Block 483) to the Issuer accounting module, e.g., a QuickBooks account, with details of the interest payment invoice (Block 484). The current payment interface is operative with the Control Panel and interoperates with the FlexFunds Operations. The borrower may receive an invoice with the instructions as to the interest payment via the API call that has occurred at the account of the Issuer accounting module. The invoice is emailed (Block 485) to the borrower (Block 486), which makes a payment (Block 487) to the FlexFunds accounting module (Block 488) that transmits payment to the Issuer accounting module (Block 484). A potential complexity is the outstanding principal may increase at different times on a day-to-day basis and change or increase with the interest repayment calculation. This would be recalculated automatically, of course.

Referring now to FIG. 5E, there is shown the data flow process for handling extraordinary fees and invoicing them. Sometimes extraordinary fees must be invoiced. For example, extraordinary legal fees may be invoiced as when a lawyer may charge more than agreed. The clients may be billed for that extra charge. An example is when a client wants to make an amendment to the Series. For example, with a FlexETP Loan, the client or customer may not be happy with the interest rate and may not be able to sell as much as they want because the interest rate was perhaps too low and an amendment has to be made. The client makes a request via the FlexETP system and Control Panel to make an estimate of the cost associated with amending a new Series. The name of the client can be entered with the series number and information added and thus confirmed. The Control Panel could make an API call to the FlexFunds accounting module or an LTD module and the transaction matched to the amendment.

As shown in FIG. 5E, the client (Block 500) may make a new request for an amendment to the Series (Block 502) that is sent the FlexFunds Operations as part of the FlexETP system (Block 504). The FlexETP system may calculate an “estimation” (Block 506) of the fees necessary to complete the amendment. If there is no Noteholder direction, for example, it may be $3,500, but with a Noteholder direction, it could be $7,000, or it could be made with tranche. This estimation is input into the Control Panel at the FlexETP system (Block 508) where it makes an API call (Block 510) to the FlexFunds accounting module (Block 512) (as a QuickBooks account in one example) and generates and transmits an email invoice (Block 514) to the client (Block 500). Once the client pays the invoice (Block 516), the FlexETP system such as working via the FlexFunds Operations is ready to move forward with the amendment completion (Block 518). The invoice is marked as complete by the FlexFunds accounting module with appropriate payment.

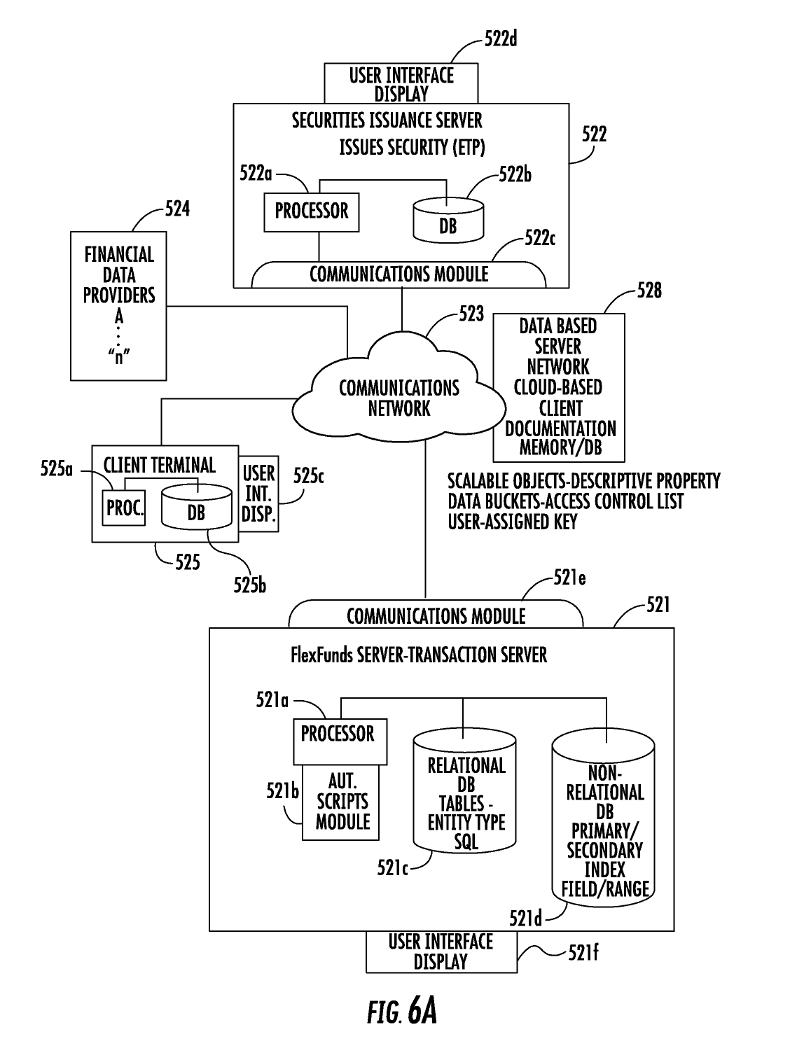

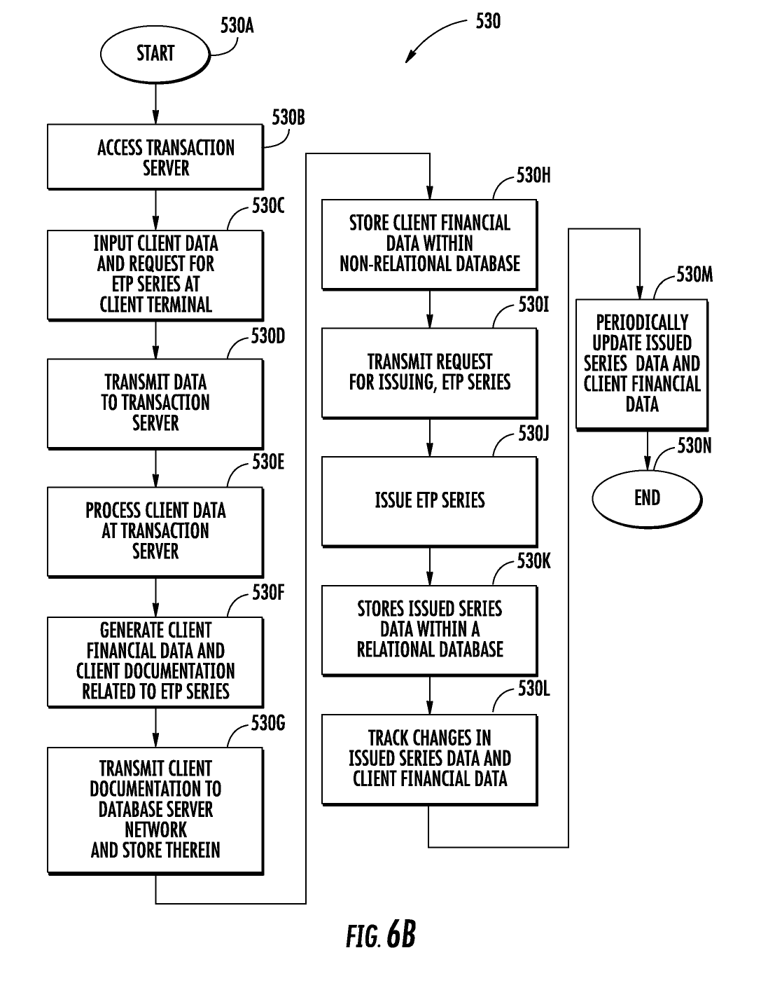

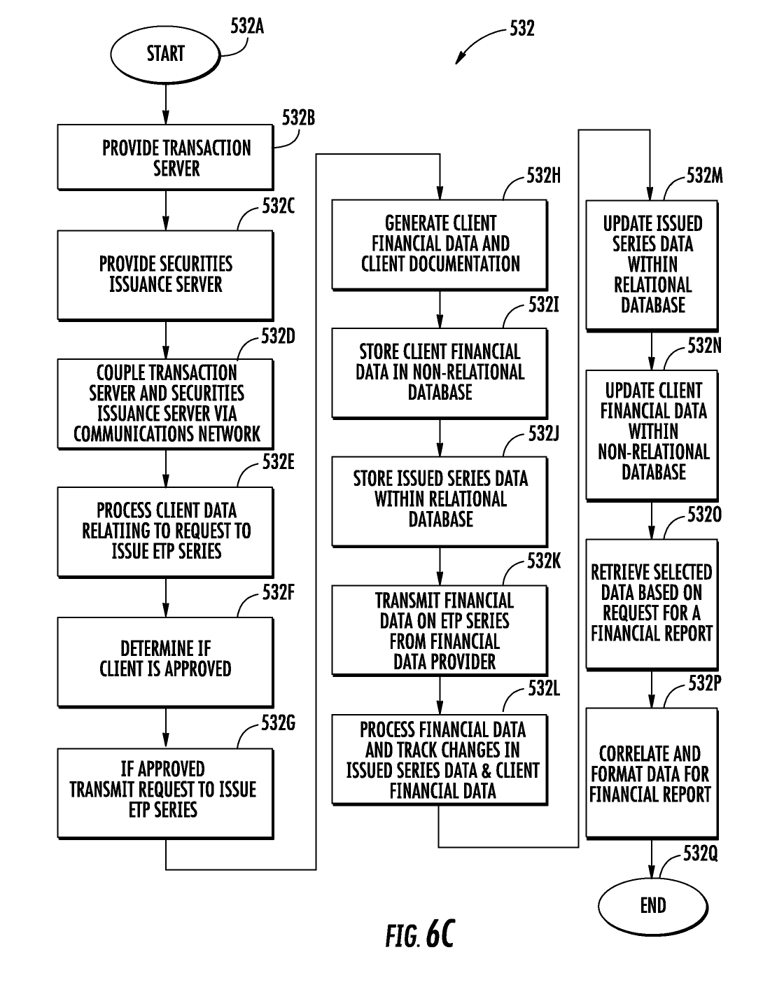

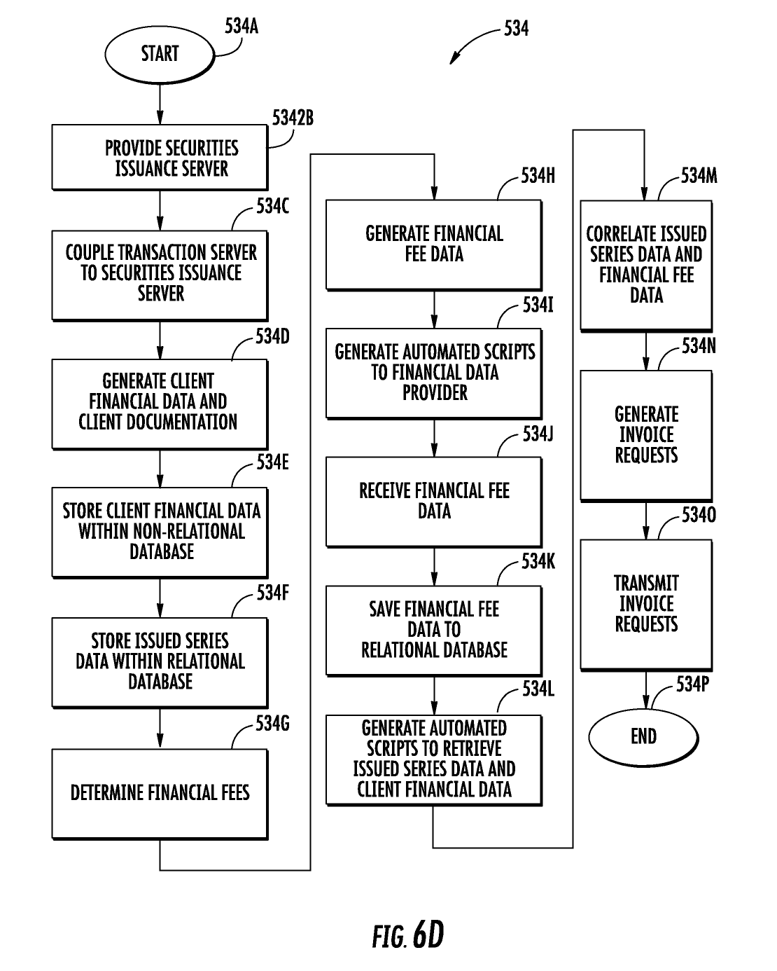

Referring now to FIG. 6A, there is illustrated another block diagram to show a simplified overall FlexETP system 520 that may be used for issuing and managing financial assets for a plurality of clients such as exchange traded products and also used for managing the financial assets and associated fees and issuing financial reports, and may be read in association with the flowcharts describing some of the data flow as in FIGS. 6B to 6D. The system 520 includes a FlexFunds server 521 that operates as a transaction server where the ETP series is arranged and includes a processor 521a with the automated scripts module 521b as noted above and a relational database 521c and non-relational database 521d. The processor 521a operates with a communications module 521e and communicates with a securities issuance server 522 such as for the trustee bank or other issuer via a communications network 523. The securities issuance server 522 also includes a processor 522a and database 522b and communications module 522c that communicate via the communications network 523 with a communications module 521e of the transaction server 521. The transaction server 521 also includes a user interface and display 521f and the securities issuance server 522 also includes a user interface and display 522d.

As noted before, financial data providers 524 communicate with the transaction server 521 and securities issuance server 522 via the communications network 523 and may include one or more financial data providers. A client terminal 525 communicates with the transaction server 521 via the communications network. The client terminal includes a processor 525a and memory 525b as display/interface 525c as is well known, for example, with a personal computer or other customer server. A database server network 528 communicates with the transaction server 521 and stores the client documentation and may include, but not be limited to, the legal documentation, term sheets and Know-Your-Client (KYC) information for an issued ETP series. The database server network 528 may be formed as an on-demand cloud computing platform have at least one memory and database structured to store the client documentation for the plurality of clients. It may be organized as scalable objects in the data buckets and each identified with the user-assigned key for individual clients. A descriptive property may be associated with objects to aid in tracking the client documentation for each client. This may include an access control list associated with each bucket and object and accessible via the user interface such as displayed at a user terminal in communication with the transaction server such as the client terminal or a user terminal at the securities issuance server or the transaction server.

As compared to the database server network 528, the relational database 521c at the transaction server 521 may include a plurality of tables, and in an example, each table having data for an entity type for the issued ETP series as explained above. The relational database 521c may be formed as a structured query language (SQL) database and the processor 521a at the transaction server 521 may access the issued series data by querying the relational database using a structured query language to retrieve the issued series data. The non-relational database 521d at the transaction server 521 may include client financial data configured into primary and secondary data categories, and including a primary and secondary index. The processor 521a may be configured to execute field and range queries on the primary and secondary indexes for retrieving selected client financial data.

Financial data such as provided by the financial data providers 524 may be updated in the databases so that issued series data and any related client financial data is updated within the relational database 521c and client financial data for each client is updated within the non-relational database 521d. The client or a user at the securities issuance server 522 or the transaction server 521 may request a financial report so that the processor 521a at the transaction server may correlate and format retrieved data for presentation in a financial report. That request for a financial report may be formed as an API call issued from a user terminal as a user interface and display for a GUI as an example. This could be at the client terminal 525 or a user terminal at the securities issuance server 522 or the transaction server 521. The data for presentation in a financial report as explained below could be one or more of a record of interest in fees, the NAV, an accounting reconciliation, a record of executed trades, a fact sheet, invoices, and performance data for one or more ETP series. The automated script module 521b may generate automated scripts to the relational and non-relational databases 521c, 521d and at least one financial data provider 524 and retrieve financial series data and client financial data from the relational and non-relational databases and retrieved financial data from the at least one financial data provider.

The transaction server 521 via its processor 521a may generate invoice requests for selected clients and transmit the invoice request to the securities issuance server 522. This can be based on the automated scripts module 521b generating automated scripts to the relational and non-relational databases 521c, 521d to retrieve therefrom issued series data and its related financial fee data and client financial data for an ETP series of selected clients and correlate the issued series data and its related financial data and client financial data to generate invoice requests.

The financial fee data could be data related to maintenance fees for each client and the security issuance server 522 could invoice the client for payment and credit the transaction server 521 once payment is received from a client. The financial fee data could also be data related to interest payments due on each ETP series and the invoice requests may be an invoice for an interest payment. The financial fee data may be data related to extraordinary fees.

Referring now to FIG. 6B, there is illustrated a flowchart of the example method of issuing and managing financial assets for a plurality of clients such as using the system shown in FIG. 6A. The flowchart is illustrated generally at 530 and the process starts (Block 530A) and continues by accessing the transaction server from a remote computer operated by a client as the client terminal. This transaction server may include the processor and communications module as described above (Block 530B). The method includes inputting at the remote computer client data in a request for an issuance of an Exchange Traded Product (ETP) series as a security for derivatively priced investment assets (Block 530C). The method further includes transmitting the client data and the client requests for the issuance of the ETP series from the remote computer of the client as the client terminal over a communications network to the transaction server (Block 530D). The method includes processing the client data in the processor at the transaction server (Block 530E) and generating client financial data and client documentation related to the ETP series based on the received client data (Block 530F).

The method includes transmitting the client documentation via the communications module over the communications network to a database server network and storing the client documentation therein (Block 530G) and storing the client financial data within a non-relational database structure within the memory of the transaction server (Block 530H). The method includes transmitting a request for issuing the ETP series from the transaction server via the communications module over the communications network to a securities issuance server (Block 530I), and in response, issuing the ETP series at the securities issuance server, wherein the issued ETP series comprises issued series data (Block 530J). The method includes storing the issued series data regarding the issued ETP series within a relational database structure within the memory of the transaction server (Block 530K) and tracking the changes in the issued series data and client financial data over time due to changes in the financial markets, the issued ETP series, or the client financial data (Block 530L). The method may conclude with periodically updating the issued series data and client financial data within the relational and non-relational databases for maintenance and report generation (Block 530M). The process ends (Block 530N).

Referring now to FIG. 6C, there is illustrated a flowchart that depicts an example of the method of managing the financial assets of a plurality of clients and issuing financial reports such as use with the system shown in FIG. 6A and the flowchart illustrated generally at 532. The process starts (Block 532A) by providing a transaction server comprising a processor, memory and communications module (Block 532B) and providing a securities issuance server operative as a trustee that issues an Exchange Traded Product (ETP) series as a security for derivatively priced investment assets, where an issued ETP series comprises issued series data (Block 532C). A communications network is coupled between the transaction server and securities issuance server (Block 532D) and the method includes processing within the processor at the transaction server client the data received from clients over the communications network and with the client data also relating to requests for the issuance of an ETP series (Block 532E).

The system determines if a client is approved for issuance of an ETP series (Block 532F), and if approved, the method includes transmitting via the communications module a request to the securities issuance server to issue an ETP series for the client (Block 532G) and generating client financial data and client documentation for each client's issued ETP series (Block 532H). The method includes storing in a non-relational database structured within the memory of the transaction server the client financial data for each client (Block 532I) and storing in a relational database structured within the memory of the transaction server the issued series data for each client (Block 532J). The method includes transmitting over the communications network to the transaction server financial data on the ETP series issued for each respective client from at least one financial data provider coupled to the communications network (Block 532K) and processing the financial data received for each ETP series within the processor at the transaction server while tracking the changes in the issued series data and client financial data over time due to changes in the financial markets, the issued ETP series for the client financial data (Block 532L). The system periodically updates the issued series data for each client within the relational database (Block 532M) and includes updating the client financial data for each client within the non-relational database (Block 532N). The method includes retrieving specific client financial data and issued series data from the respective non-relational and relational databases based on a request for a financial report received at the transaction server (Block 532O) and correlating and formatting the retrieved data for presentation in a financial report (Block 532P). The process ends (Block 532Q).

Referring now to FIG. 6D, there is illustrated a flowchart for an example method of managing the financial assets and associated fees for a plurality of clients and with the flowchart illustrated generally at 534. In this example, the process starts (Block 534A) by providing a securities issuance server operative as a trustee that issues an Exchange Traded Product (ETP) series as a security for derivatively priced investment assets, where an issued ETP series comprises issued series data (Block 534B). The method includes coupling a transaction server to the securities issuance server via a communications network wherein the transaction server may include a processor, memory and communications module and operative as an arranger for each ETP series issued for a client (Block 534C). The method includes generating within the processor client financial data and client documentation for each client's issued ETP series based on client data received from clients over the communications network relating to requests for the issuance of an ETP series for respective clients (Block 534D). The client financial data is stored within a non-relational database structured within the memory of the transaction server (Block 534E) and the issued series data of the ETP series for each client is stored within a relational database structured within the memory of the transaction server (Block 534F). The method includes determining financial fees for each ETP series issued for respective clients within at least one financial data provider coupled to the transaction server via the communications network (Block 534G). The system generates financial fee data related to the financial fees for each ETP series (Block 534H). The method includes generating automated scripts from an automated scrip module of the processor at the transaction server and transmitting the scripts to the at least one financial data provider (Block 534I), and in response, receiving financial fee data therefrom related to the ETP series for each client (Block 534J). The financial fee data is saved to the relational database as part of the issued series data (Block 534K) and the automated scripts are generated to the relational and non-relational databases to retrieve from the relational database issued series data and its related financial fee data and from the non-relational database client financial data for an ETP series of selected clients (Block 534L). The method further includes correlating the issued series data and its related financial fee data and the client financial data (Block 534M) and generating invoice requests for each selected client (Block 534N) and transmitting the invoice requests to the securities issuance server (Block 534O). The process ends (Block 534P).

The FlexETP system 120 in FIG. 1 includes a FlexInvest server or module 146, which could be a designated server or processor that operates as a tool to connect investors and content providers, without the need of a financial vehicle such as a mutual fund or Exchange-Traded Fund. Investors can subscribe to a content provider's strategies and the FlexInvest module 146 as a tool allows for automatic rebalancing of a strategy. Trades may be placed directly into an investor's brokerage account such as Interactive Brokers, E-trade, etc. after they pay a monthly/annual subscription to follow the strategy. Through a widget or an explore page as part of an interface, investors can browse through different strategies and make investment decisions. An explore page may act as a centralized portal to display multiple content provider strategies. On the other hand, a widget may allow content providers to have a link to their strategies directly in the websites. For example, a “Trade Now” button could be activated the investor for initiating the trade.

Once the investors decide which strategy to invest, an investor will be prompted by the FlexInvest module 146 to select either the broker where they already have an account or create a brokerage account with one of the partner brokers. After log-in by the investor to their account, the FlexInvest module will send an authorization request to the broker. An authorization code is sent from the broker to the investor's preferred method of delivery. The investor inputs the authorization code into the system and finishes the form with the details needed to complete the investment, such as the amount to be invested. With this information, the FlexInvest module 146 calculates what would be the most optimal allocation to each stock in the strategy. Because the investment account of most retail investors is generally small, it is challenging to balance a portfolio with stocks that have a large stock price such as Amazon (AMZN) or Berkshire Hathaway (BRBK) as examples at the current time.

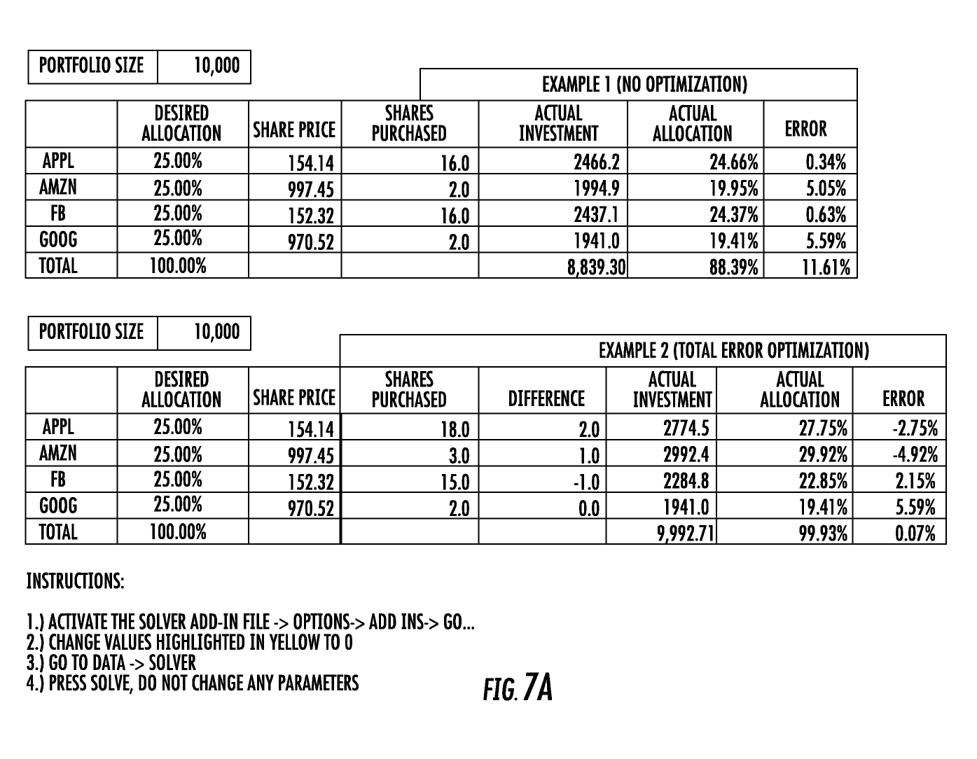

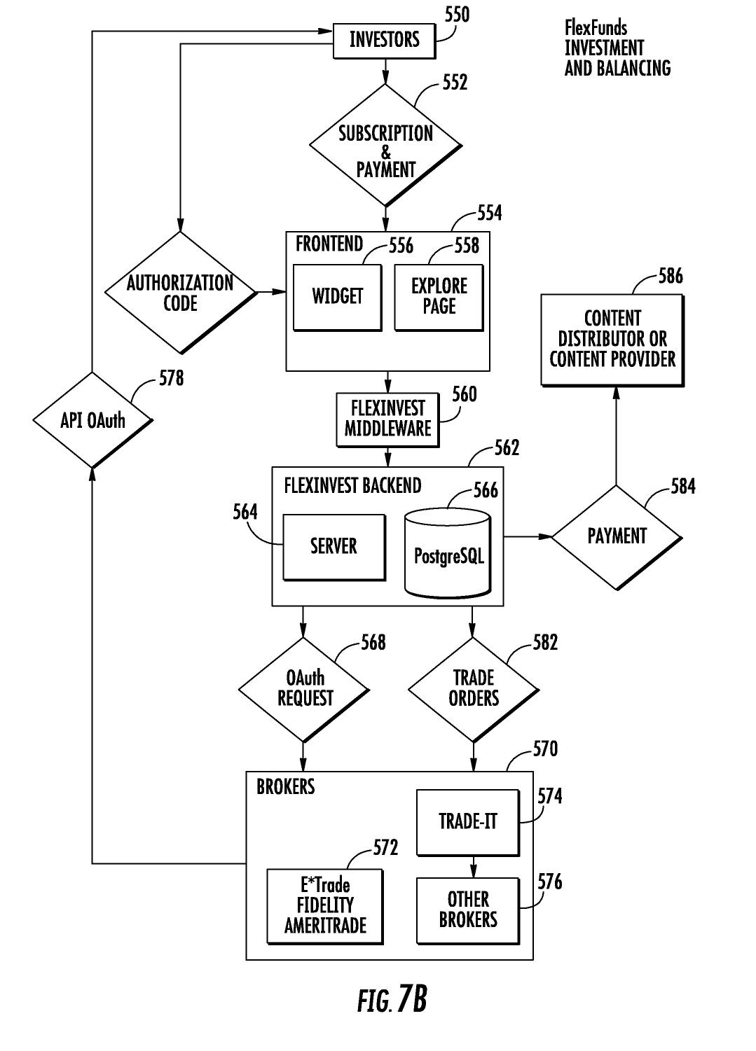

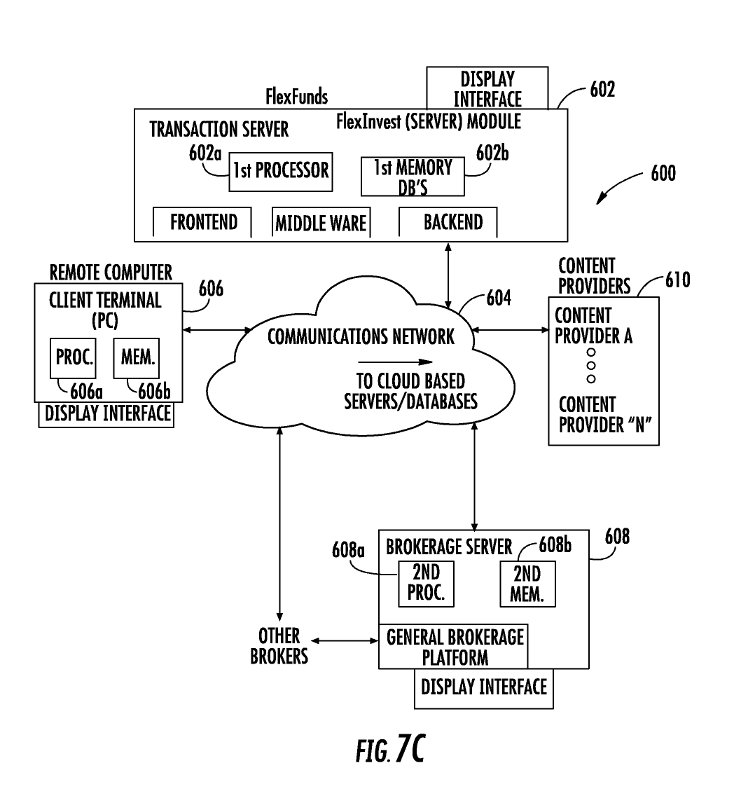

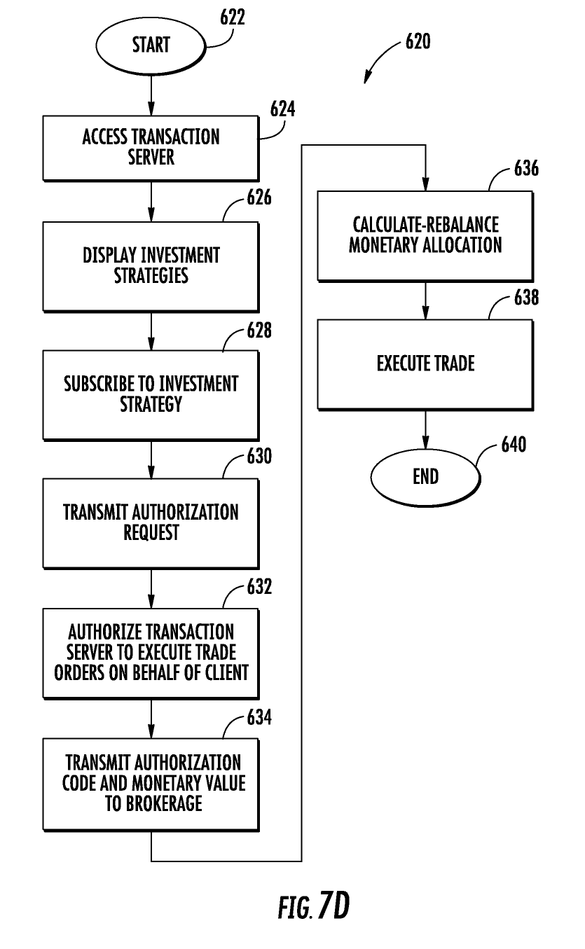

The rebalancing algorithm minimizes the difference between the content provider's desired allocation and the investor's actual allocation. When a list of trades computed by the algorithm, the orders may be sent to the investor brokerage account through API calls. Connections can be made to E-Trade, Fidelity and/or Ameritrade. For other brokers, it is possible to use a trading service such as “Trade It” as explained below, which allows generalized trading when an investor has no brokerage account. After trades are completed, the investors may be prompted to insert their credit card information and continue to receive updates from the strategy. Subscription payments at a certain percentage can be distributed back to the content distributors. The rebalancing formula can vary, but in one example, the formula is a minimal error formula and may use an Excel solver function such as the example spreadsheet shown in FIG. 7A.

With the system, a portfolio may have a fixed or desired percent allocation. In many cases, it may not be possible to meet the desired allocation due to the imperfection of stock prices and because fractional shares may not be available. Without optimization, the portfolio actually purchased by the investor would have a large discrepancy and the investor would either have to purchase less than the desired portfolio size or more. To reach the closest investment to the actual amount that the investor wants to invest, the system will have to manipulate each variable highlighted by the arrow “Y” in the chart shown in FIG. 7A using a non-linear solver until it finds the minimum investment error. In order to limit the scope of the algorithm, the system sets the initial parameters to equal the non-optimized formula and limits the changes in number of units to plus or minus two (2) in this example.

Strategies can be rebalanced monthly/quarterly depending on how the strategies are defined in the strategy set-up. To initiate a rebalance, the content provider is notified such as by email 5 days in advance that the strategy will be rebalanced and whether the content provider would like to change any of the holdings of the portfolio. If the portfolio manager does not accept the email the strategy is not rebalanced in one example.

Investors receive an email or SMS (generated from the FlexETP system's FlexInvest module back-end) on the day the strategy is set to be rebalanced. In an email, the investor may receive data that implements a button or other graphic or indicia for “Rebalance Now.” This could be on an interface such as displayed on a wireless communications device. If the investor has multiple strategies in the same brokerage account, the investor could receive a single email. It is possible that the emails may not be sent on a per strategy basis, but may be sent on a per brokerage basis to limit investor friction. When the investor presses the graphic or button, the FlexInvest module 146 prompts the investor to “log in” to his broker (the same way it is done when initiating a new strategy). The investor copies and pastes, for example, an OAuth code (although different actions could be done), which gives the FlexInvest module 146 access to execute trades on behalf of the investor or client. The FlexInvest module 146 calculates the trades using the rebalancing formula and executes them for the investor or client. Trades can be executed using logic and a data flow as described below either through a third party general trade broker such as the “Trade It” platform or directly with one of the broker's connections. After the trades are executed, a confirmation email may be sent to the client.

The “Trade It” platform or similar general broker service for executing trades for investors has an interface and may include a script loader for a widget to function. Tickets can be launched via Java Script and include an HTMP element. Content providers create data and information. The content provider is presumed to be a specialist in the subject and fills the requirements for those clients and investors in need of financial services news, and thus, would come up with an investment strategy. The “Trade It” or similar platform operates as a proprietary order management system that securely routes trade orders to brokers to facilitate securities order execution. A widget as part of a GUI may operate as a control element, e.g., a button or scroll bar, and may facilitate a specific type of user interaction defined by the theme and rendered by a rendering engine. The FlexETP system 120 may enable or disable widgets at any time. Common but non-limiting widgets may include a button, check boxes, sliders, spinners, drop-down lists, menus, menu bars, toolbars, icons or grid views. A built-in solver may be used, for example, such as provided by a spreadsheet program, e.g., Excel.

As indicated above, the client or client terminal may copy and paste or automatically invite an OAuth code when using the FlexInvest system module to activate a function via an OAuth code. OAuth may operate and be configured for access delegation to allow a client to grant websites or applications access to information on other websites without giving a password. This allows users to share information about their accounts with third-party applications to websites. It may operate as a form of secured and delegated access and work with HTTP. It allows access for tokens to be issued to third-party clients by an authorization server, with the approval of the resource owner. A third party then uses the access token to access the protected resources hosted by the resource server. It is possible to combine OAuth with XACML as a policy-based, attribute-based access control authorization framework to provide an access control architecture and policy language and a deliver more comprehensive approach to authorization.

As will be explained relative to the flowchart of FIG. 7B, is possible for the FlexInvest module to also work with a POSTGRE SQL database 128b as an object-relational database management system. This type of database may operate as a database server to store data securely and return data in response to requests from other software applications. The POSTGRE SQL database 128b may manage concurrency through a Multi-Version Concurrency Control (MVCC) that gives each transaction a “snapshot” of the database, allowing changes to be made without being visible to other transactions until changes are committed. It helps maintain database consistency and includes a built-in binary replication and operates with a mixture of synchronous and asynchronous standby servers and support regular and hash indexes for access methods such as generalized search trees, generalized inverted indexes, space-petition and block range indexes. Different interfaces may be used.

Referring now to FIG. 7B, a flowchart for operating the algorithm for the FlexInvest module is described. Typically, only accepted content providers can create new strategies. An investor (Block 550) may desire to make a subscription and payment (Block 552) via a front-end of the FlexInvest module (Block 554), which as described above may include a widget (Block 556) or explore page (Block 558). Different investors view the content provider strategies and may subscribe to a desired strategy. The content providers will publish strategies such as on an explorer page 558. The FlexInvest module 146 will accept a specific content provider and display on the explorer page different content providers that may be selected to view appropriate strategies.

Located before a FlexInvest module back-end is the FlexInvest module middleware (Block 560), which provides services to software applications beyond those available from an operating system so there may be proper input/output between the front-end of the FlexInvest module and the FlexInvest back-end (Block 562). This creates a more efficient data flow and makes the server/computer operate better. The FlexInvest back-end (Block 562) includes a FlexInvest server (Block 564) and the POSTGRE SQL database (Block 566). The server could be a separate server from the FlexETP server that implements the FlexManager module and Control Panel on the same server. This arrangement of components allows better distribution of communication and management of data and those services not above the transport layer, i.e., over the TCP/IP, but below the application environment. The middleware 560 lies between the operating system software and each side of a distributed computing system in this example.

The investor initiates the subscription perhaps by pressing a button or entering the brokerage account such as an E-trade account. When the subscription process is initiated, the FlexInvest back-end sends an API call such as the OAuth request (Block 568) to a respective broker (Block 570) such as E-trade, Fidelity or Ameritrade (Block 572) to generate an OAuth API key. As noted before, it is possible to use the general trading platform such as Trade It (Block 574) that works with other brokers (Block 576). The broker sends the API key to the investor's preferred method of delivery such as email or SMS (Block 578) and the investor inputs the authorization code so that FlexInvest module can send the trade orders on the investor's behalf (Block 580). It could be a message to copy a page or other specific direction.

Once the investor inputs the authorization code, the FlexInvest module 146 will have access to place a trade on the client's behalf. Depending on the situation or circumstances, a terms agreement may have to be signed. Based on a strategy defined by the content provider and the invested amount by the investor, the FlexInvest module 146 calculates the orders necessary to reach the defined portfolio (Block 582) and a list of orders is submitted to the broker for execution such as by E-trade, Fidelity or Ameritrade are routed through the FlexInvest direct connection to the broker while other broker trades may be directed to the Trade It platform and its API (Block 574) and to the other brokers (Block 576). After the order is initiated, the investor is prompted to insert his credit card information to continue the strategy and payment is made (Block 584) to the content distributor or content provider (Block 586). In a non-limiting example, 80% of subscription fees may be distributed back to content distributors or content providers, while FlexFunds that operates the FlexInvest module keeps 20% of the fees. Each broker may have different API rules.

The general brokerage platform, such as the “Trade It” platform, may implement function calls and JSON request/response objects. The application programming interface (API) may be architected around a JSON-pure approach and use standard HTTP to communicate and use JSON responses to indicate status and errors with the API served over HTTP's to ensure data privacy. The FlexInvest module may take advantage of OAuth to create a user token that authenticates the user and establishes a set time period session, e.g., a 30 minute session. Successful authentication may return a session token for use with subsequent API calls. A user OAuth token may be generated to give credentials to a broker. After using the OAuth page to create a user token, that token can be used and exchanged for a session token to be used for subsequent requests.

It is possible to use automated payments such as a series such as “Stripe” since it also uses tokens as a form of data substitution by keeping tokens such as in a credit card number field and use the token to support internal business processes. For example, a customer could interact with merchants, in this case, the broker and FlexFunds and the FlexETP system, and pass tokens. In this process, a content provided page may have different views, followers, subscribers and strategies that can be shared on different social media such as Facebook, Twitter and other applications. The content product provider would be able to see all of the strategies and could make a dashboard page, if necessary, and implement the rebalancing process as described.

Referring now to FIG. 7C, there is illustrated a block diagram of basic components such as described relative to the flowchart of FIG. 7B and showing the system 600 that may include a transaction server 602 as part of the FlexFunds system that communicates via a communications network 604 with a brokerage server 608. Content providers 610 such as content providers A through “N” communicate via the communications network 604 with the transaction server 602. A client terminal 606 communicates via the communications network 604 with the transaction server 602.

In one example, the transaction server 602 includes a first processor 602a such as corresponding to the FlexETP processor in FIG. 1 and first memory 602b that may include several different databases as described before. The brokerage server 608 includes a second processor 608a and second memory 608b and may operate as a general brokerage platform. The client terminal 606 may be a personal computer and operated from their home or other server or computer platform, including a mobile wireless communications device and includes a third processor 606a and third memory 606b. The transaction server 602, brokerage server 608, and client terminal 606 each include respective display/interfaces for displaying data and reports and inputting data.

Referring now to FIG. 7D, another flowchart is illustrated for the method of conducting and balancing in a secure transaction a financial investment of a client and illustrated generally at 620 and showing the basic flow data as explained relative to FIGS. 7B and 7C. The process starts (Block 622) and a transaction server is accessed from a remote computer as a client terminal operated by the client (Block 624). The transaction server 602 as noted before includes the first processor 602a and first memory 602b that stores a plurality of investment strategies provided by one or more investment content providers. As an alternative, the client via the transaction server may download investment strategies directly from the content providers. Each investment strategy may include a selected portfolio of investment securities. The plurality of investment strategies are displayed on an interface at the remote computer (Block 626). An investment strategy is subscribed to by selecting at the remote computer an investment strategy to invest and transmitting the selection over a communications network to the transaction server (Block 628).

The process continues by transmitting an authorization request from the transaction server over the communications network to the brokerage server (Block 630). This brokerage server 608 includes the second processor 608a and second memory 608b and configured to execute trade orders for investment securities. In response to the client's selection of an investment strategy and in response to receiving the authorization request, the process continues by generating and transmitting from the brokerage server to the client an authorization code that authorizes the transaction server to execute trade orders on behalf of the client (Block 632). The transaction server communicates the authorization code and any monetary investment value chosen by the client to invest within the client selected investment strategy (Block 634). The transaction server calculates an optimal rebalanced monetary allocation for each investment security within the investment strategy based on the client's monetary investment value to minimize the difference between the content provider's desired allocation and the client's actual allocation (Block 636). The transaction server executes on behalf of the client a trade order with the brokerage server that is in accordance with the optimal rebalanced monetary allocation for each investment security (Block 638). The process ends (Block 640).

Throughout this process, the investment securities may comprise stocks, bonds, exchange traded products or any combination thereof. The optimal rebalanced monetary allocation may be calculated with a non-linear minimal error formula to find a minimum investment error. A timeframe may be established at the transaction server for updating each investment strategy and transmitting a request to investment content providers for updating respective investment strategies. An investment strategy may be transmitted from the remote computer operated by a content provider over the communications network to the transaction server and saving the investment strategy within the first memory. The authorization code may be formed as a secure access token created at the first processor of the transaction server to give credentials to the brokerage server. The brokerage server may be a general brokerage platform that implements trades based on a secure token for communicating and implementing a trade with a broker when the client does not have an account with that broker.

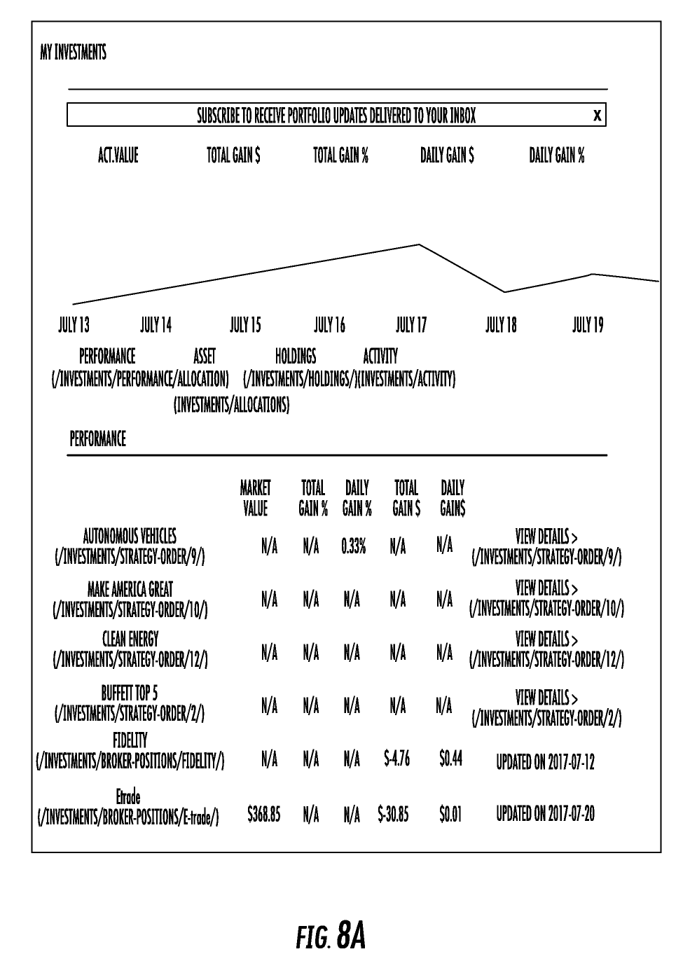

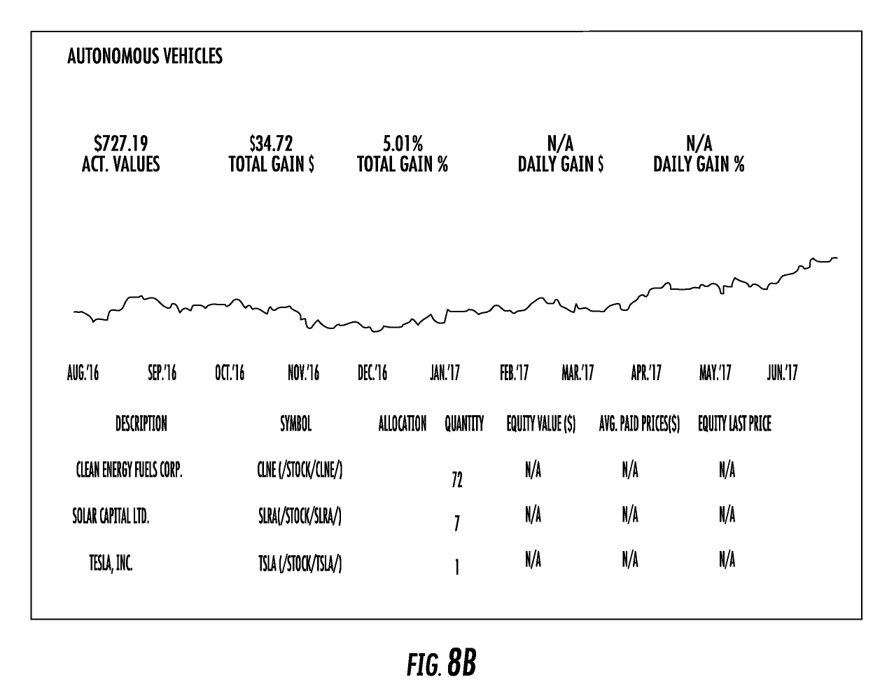

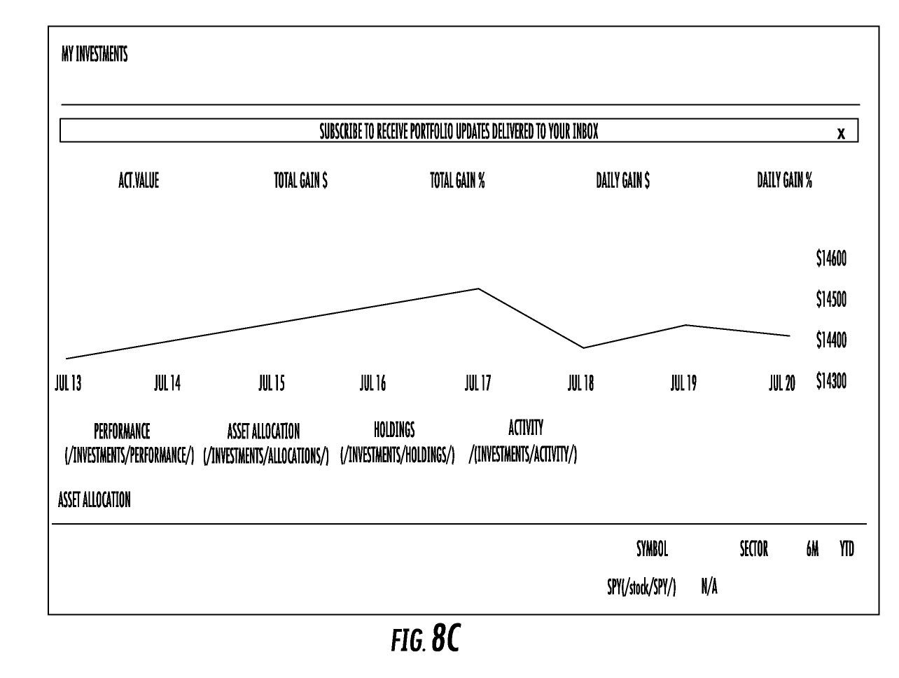

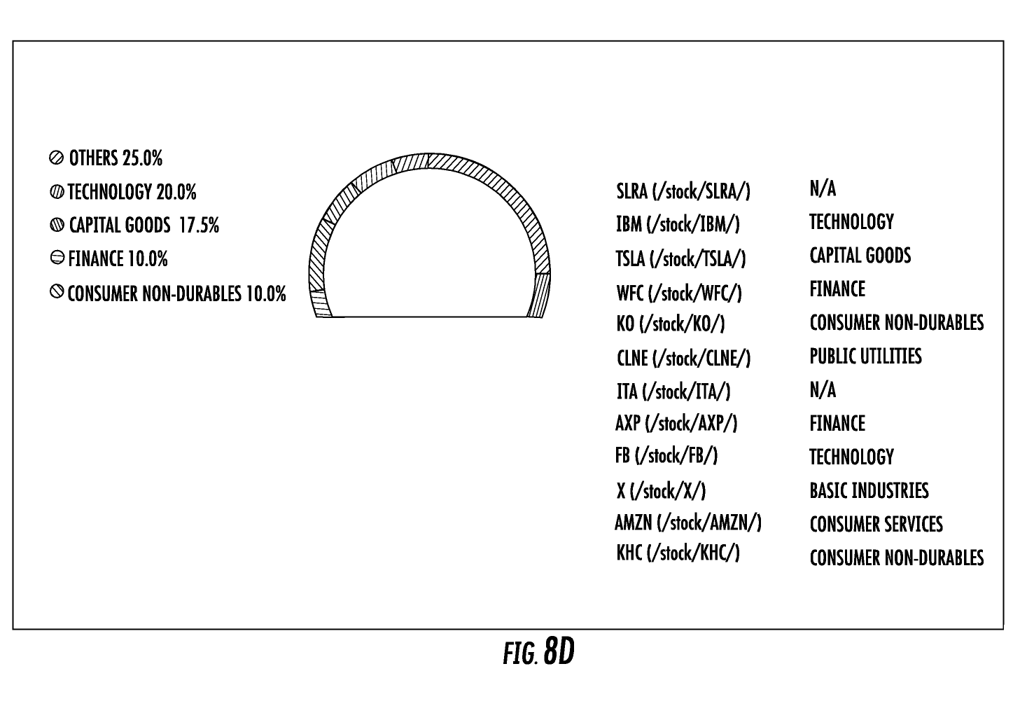

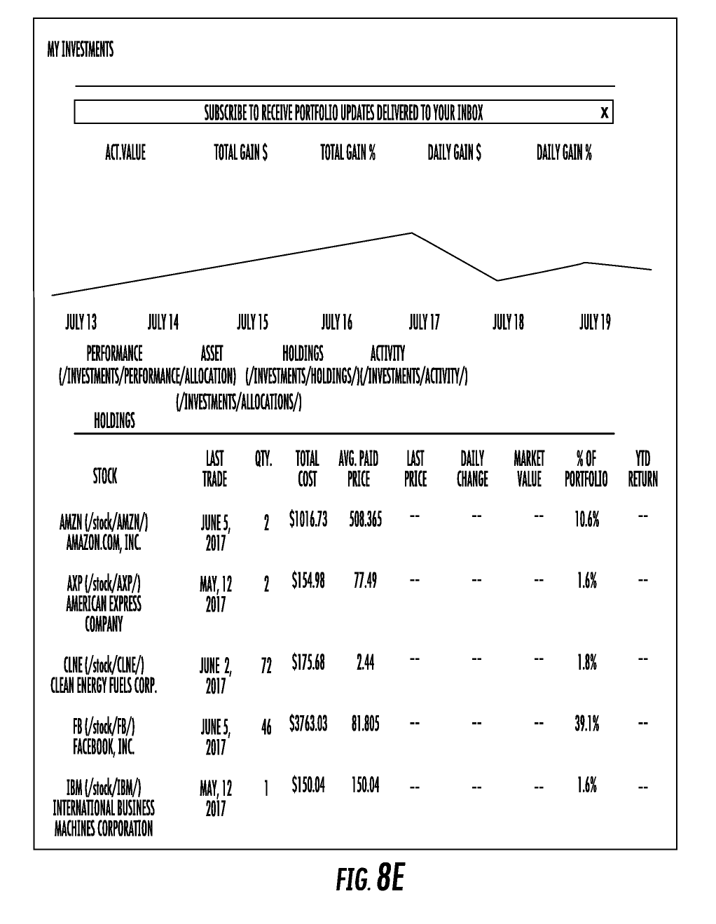

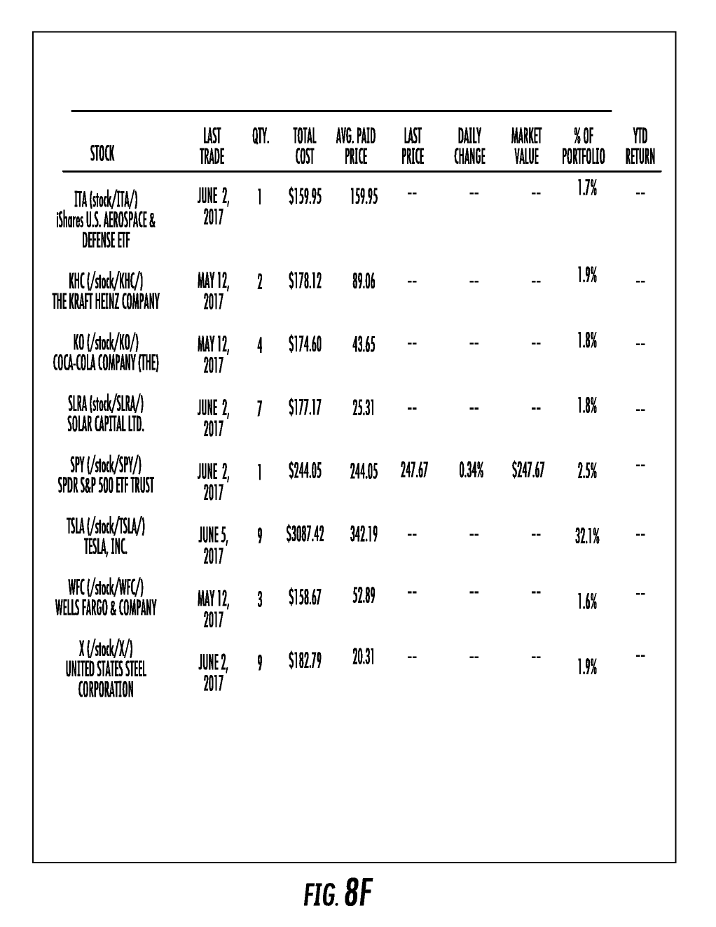

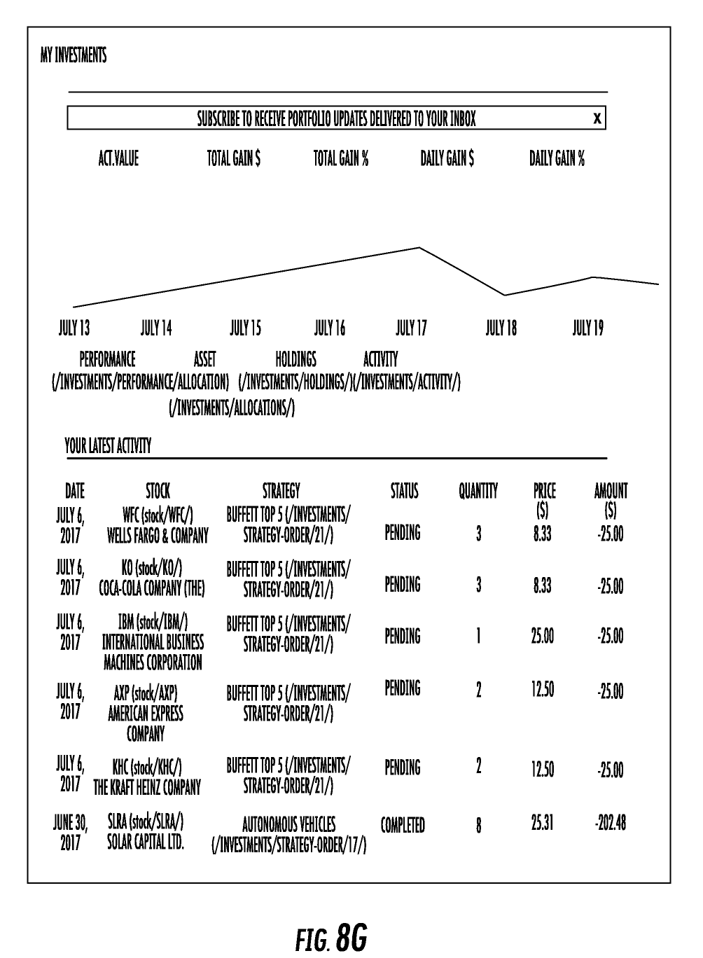

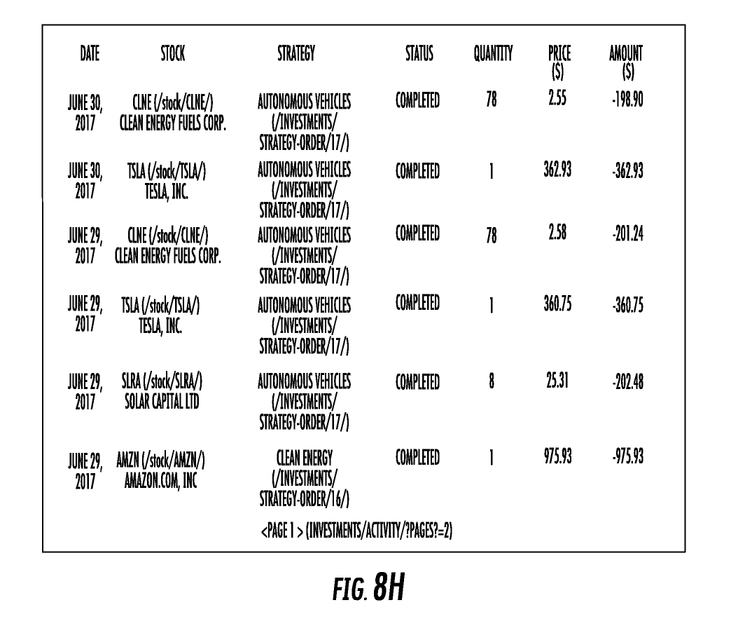

Referring now to FIGS. 8A through 8H, there are shown screenshots of what a client or investor would view once they enter their account from the FlexInvest module. For example, FIG. 8A shows the portfolio performance using a graph and lists the various strategies by content providers, such as “autonomous vehicles” and the performance of each of the strategies with a graph. The strategy “autonomous vehicles” can be clicked to show the account value and the holdings as shown in the screenshot of FIG. 8B. FIGS. 8C and 8D are examples of screenshots showing the asset allocation. FIGS. 8E and 8F show screenshots of the holdings and FIGS. 8G and 8H show screenshots of their latest activity. Each of these charts and screenshots may be selected from the subject headings for performance, asset, holdings and activity as illustrated in the screenshot for FIG. 8A showing the “my investments” page. The FlexInvest module 146 could be linked to the FlexManager module 140 and Control Panel 142 and operate with those interfaces and displays as explained below concerning a Flex Panel.

As noted before, the FlexManager may generate Factsheets from the financial data stored in the FlexETP system databases. An example of a FlexETP Fund Factsheet is shown in FIG. 9. The information in the Factsheet may be displayed on one screen and may include key facts such as the NAV, the ISIN, inception date, the last month return, the return for the year-to-date, a cumulative return since the FlexETP product launch, a high watermark for the highest value, domicile such as Ireland, since the trustee was the Irish Bank as noted above in one example, and a management fee as non-limiting examples. The counterparties operating with the FlexETP system and FlexFunds may be included and list a portfolio manager, the custodian, the listing exchange as a Vienna stock exchange, for example, the auditor and transfer agent. The risk may be shown with the standard deviation, a best and worst month, and the auditor. The investment strategy gives details, for example, indicating that this is not a high risk strategy, but focuses on preserving capital in declining markets while still capturing a significant portion of performance in up markets. Monthly returns are shown for the last three years in a performance chart graph.

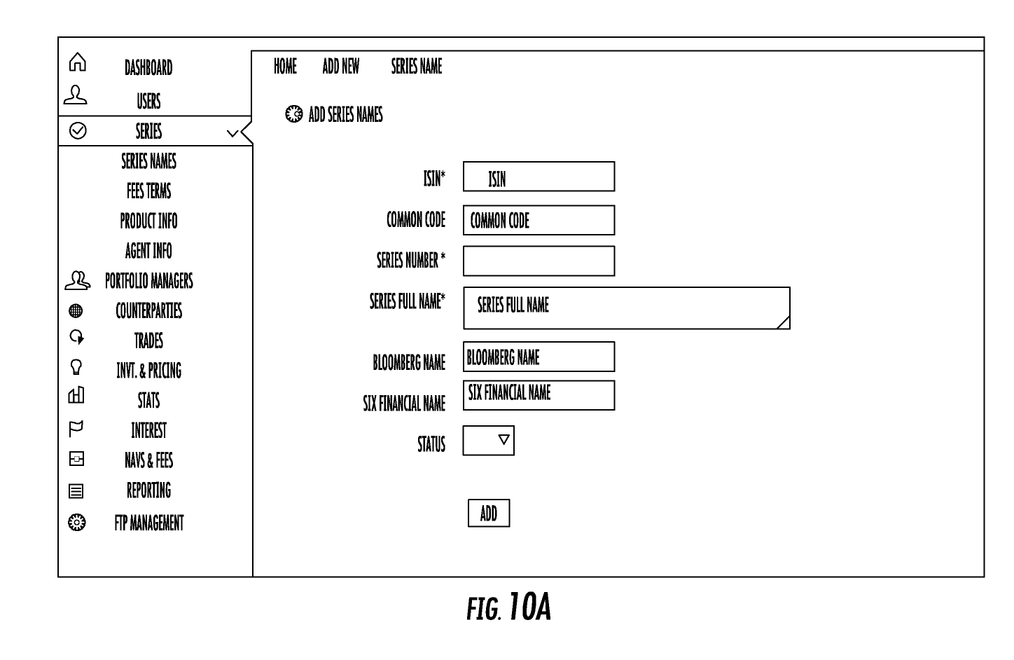

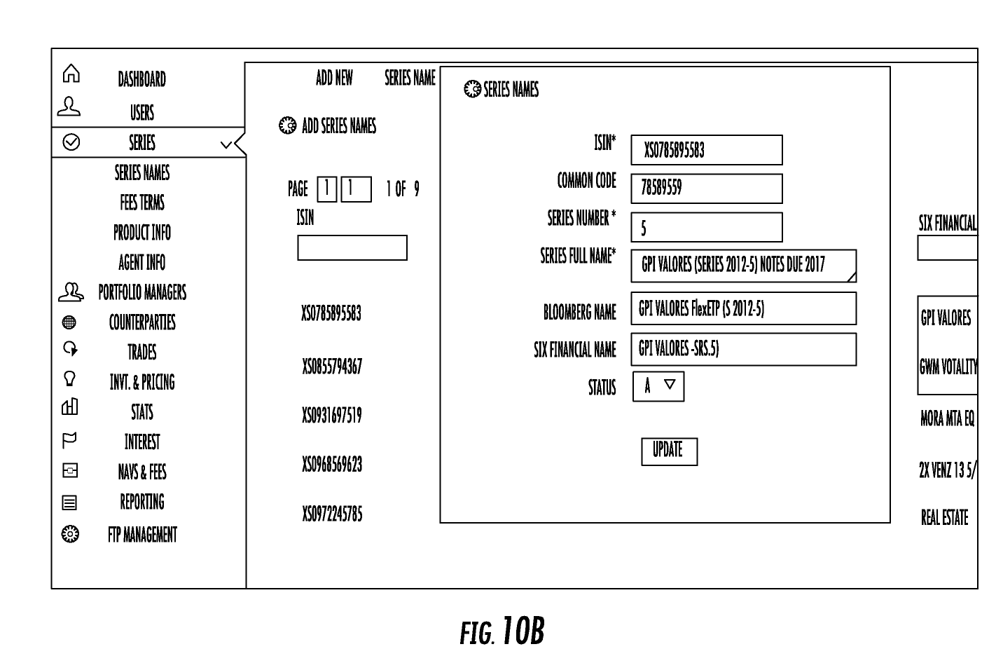

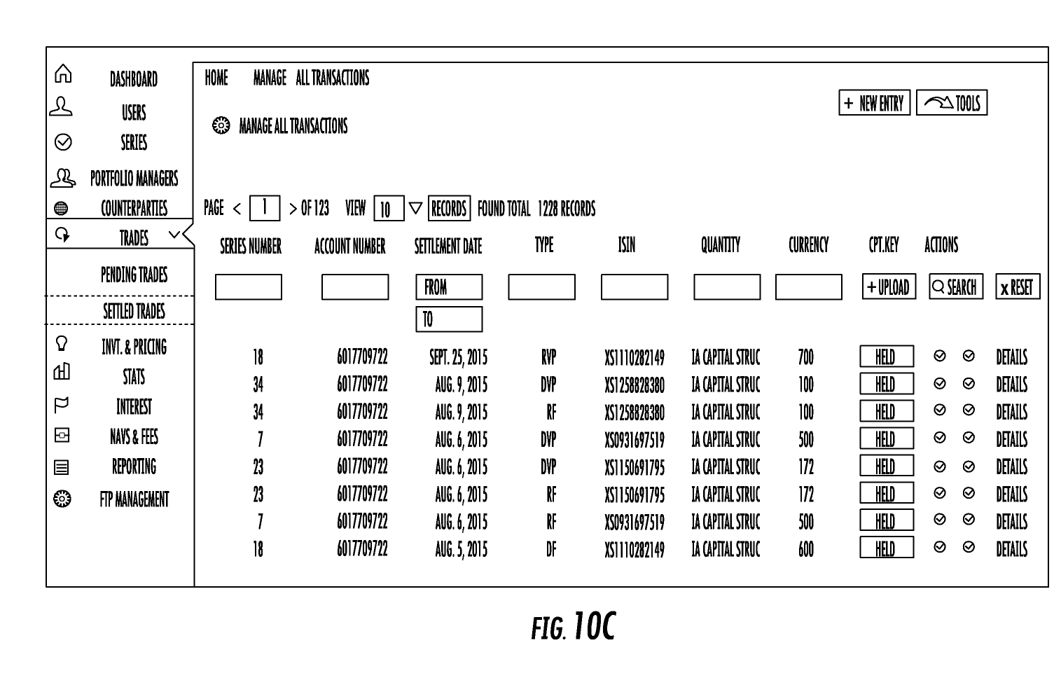

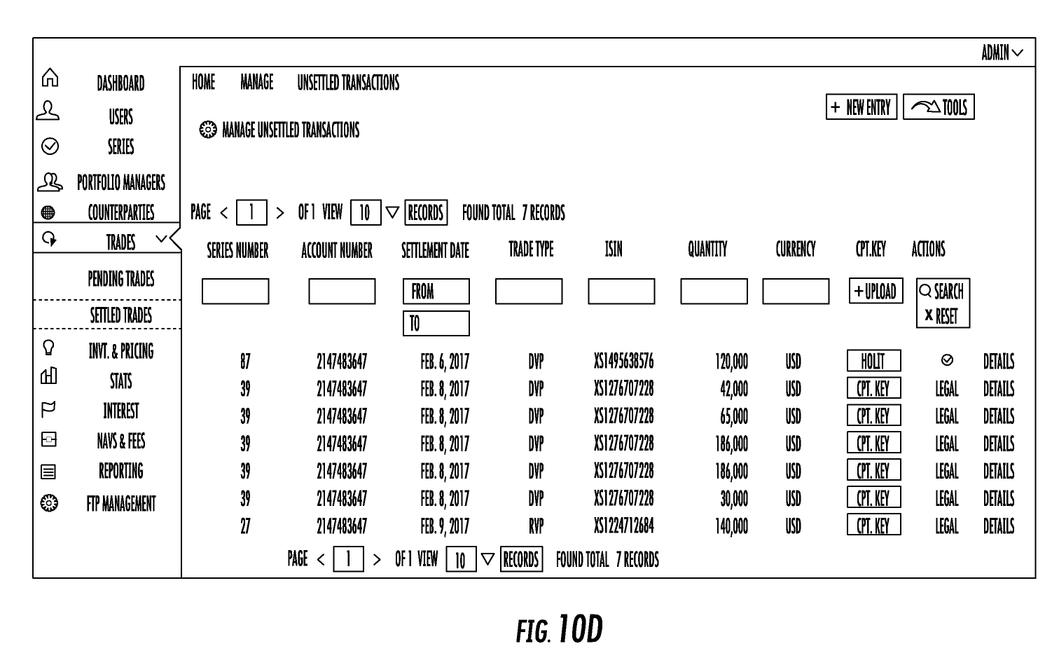

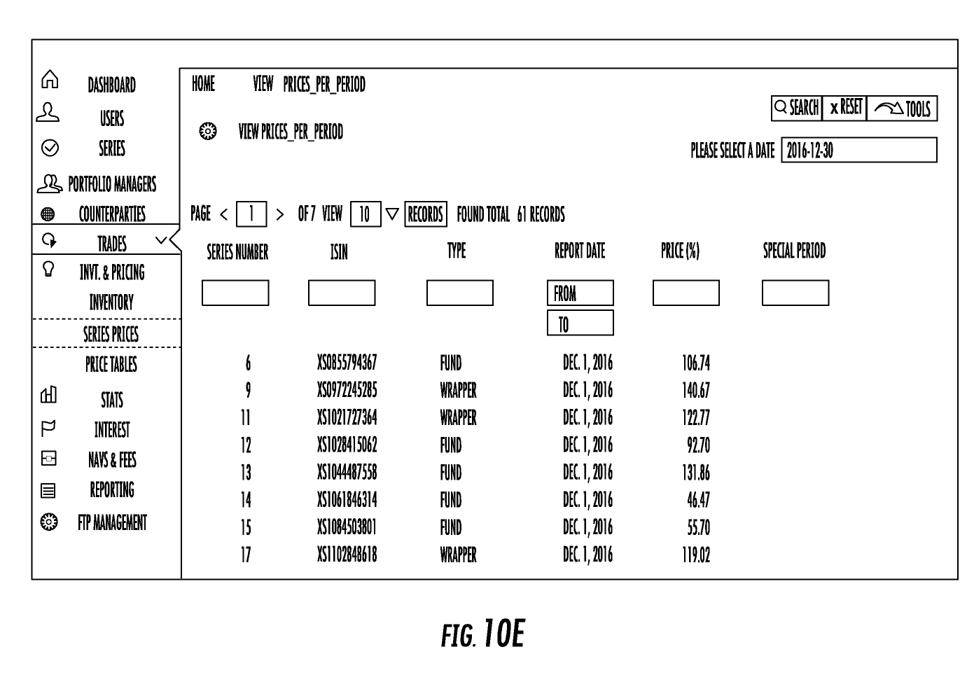

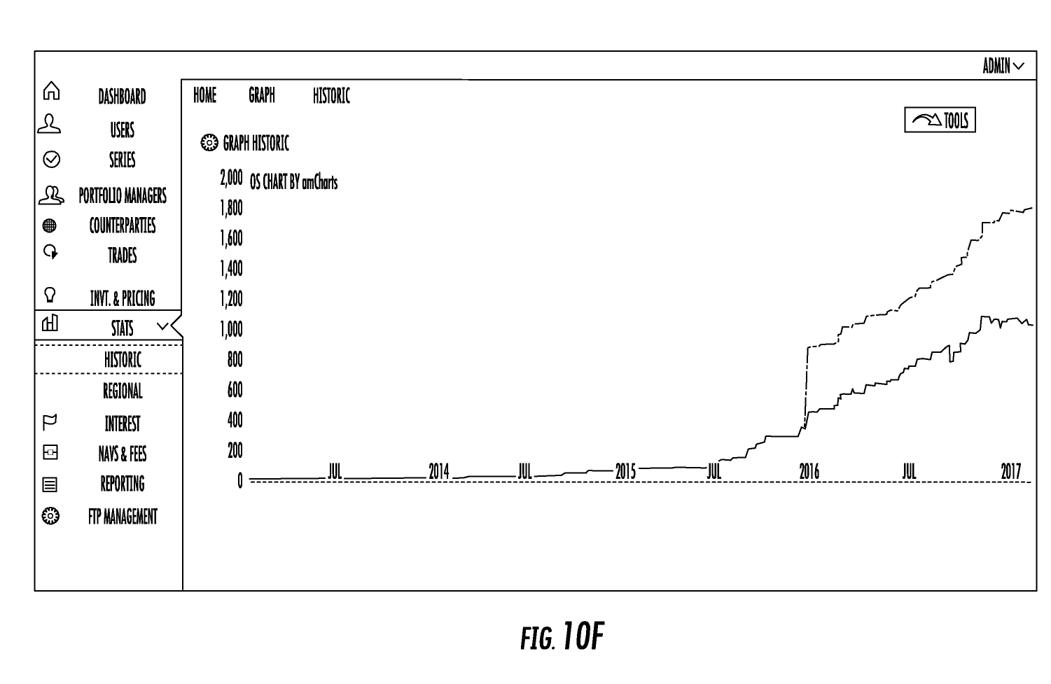

Referring now to FIGS. 9A through 9F, there are shown screenshots of how the FlexETP system may look and be profiled to a client that enters and uses the system. For example, FIG. 9A shows a screenshot for an “add series names” in which a series may be added that includes information such as the ISIN, common code, series number, series full name, Bloomberg name, Six Financial name and status. The series name screenshot is shown in FIG. 10B showing the information that will be included in the boxes of FIG. 10A.

A screenshot for managing all transactions is shown in FIG. 10C and shows information such the Series number, the account number, settlement date, the Series type, the ISIN, the quantity, and the currency. Details may be located by initiating data entry with the appropriate details button to show the type of trades and further information. As shown on the left side of the screenshot, basic details could be selected from a general dashboard menu as an example, and from an administrative point of view. Interaction may occur with the different users and series, portfolio managers, counterparties and information regarding trades, the inventory and pricing, different statistics, the interest, the NAV's and fees, reporting and sFTP manager for the File Transfer Protocol as discussed previously. A screenshot to manage unsettled transactions is shown in FIG. 10D. A screenshot for viewing prices per period for the inventory and pricing selection is shown in FIG. 10E. A statistics graph is selected to show the historic graph as shown in FIG. 10F.

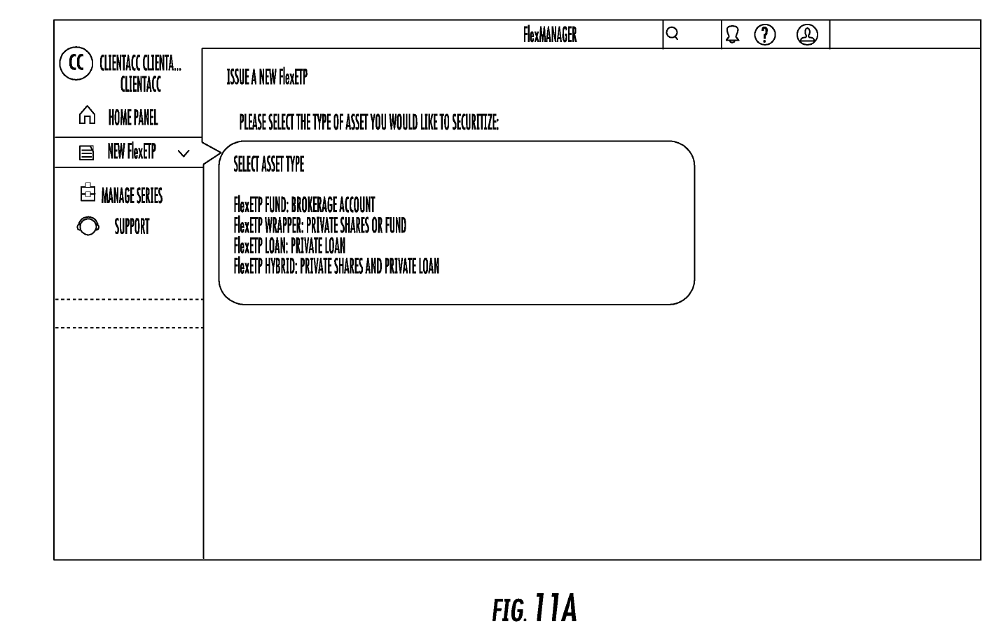

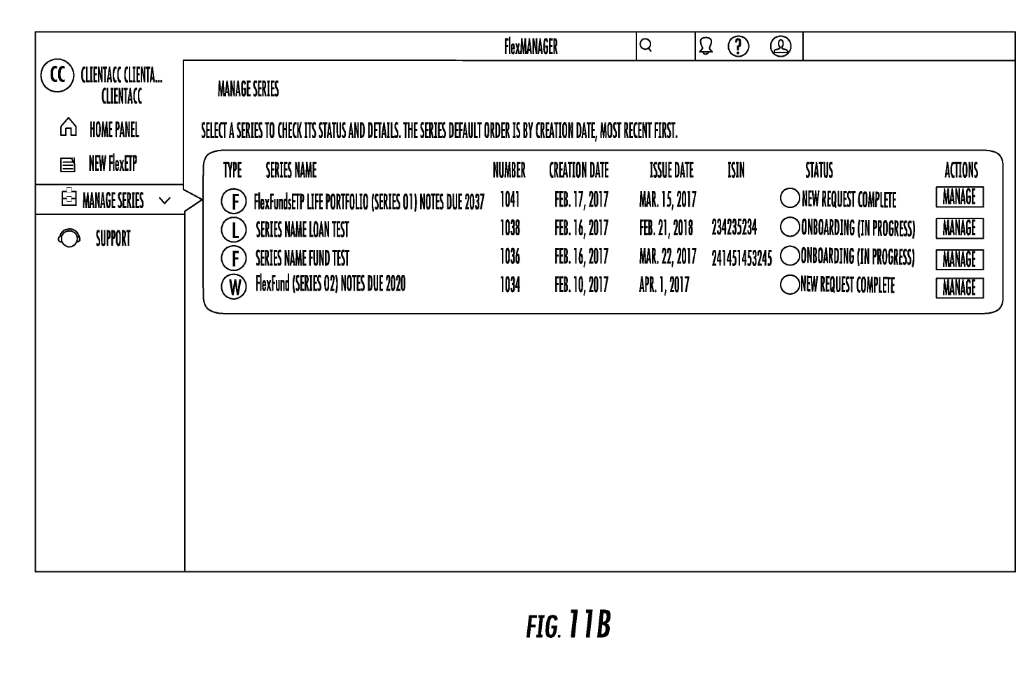

Referring now to FIGS. 11A and 115, there are illustrated two screenshots from the FlexManager module that a client could use when creating a new accounts and logging in and issuing a new FlexETP product. Although many screenshots would be included within a tutorial that the client would use, and are representative of the actual screenshots when the FlexManager module is being used, a description will proceed relative to a tutorial description to obtain a better idea of the type of actions that can be accomplished when setting up a FlexETP and the action that a client can accomplish using the FlexManager module.

The user would first access the FlexManager module by visiting a website, such as www.flexfunds.com, and clicking on a FlexManager tab that may be located, for example, at the top right of the page, although other locations or types of initiations for the FlexManager could be used. The user will be directed to a log-in page where the user will be able to log in to an existing account if the user is an existing client or new account.

In the FlexManager users may be created internally. Once the user has verified their account and has successfully logged in to the FlexManager interface for the FlexManager module, the user will be directed to a Home Panel specific to the user, which may be designed as a dashboard and from there, the user can issue a new FlexETP Series or manage a FlexETP Series or access a support section for general help. The user could download PDF documents that are pertinent to the user.

On the left side of the Home Panel in one example, the user (client) would see different tabs such as: New FlexETP, Manage Series, and Support. In one interface example, on the top right, the user will see three icons. The bell icon may be for Notifications regarding the statuses of the Series and support tickets. The Question Mark icon may download a FlexManager Client Tutorial. The User Profile icon may be for the account settings. By clicking on a Support tab, the client may be able to ask questions that the client may have or troubleshoot any issue by creating a New Ticket. The client may input questions or enter data regarding any support issues. If the client has any ticket (Open/Pending/Closed) and the client wants to view the Ticket History and the status of the Active Tickets, the client must go to the right side of the support section and click on the ticket that the client wants to review.

If the client clicks on any ticket, the Support Panel will be displayed. The client can click on a box identified with the name View Ticket Details and all the information about the ticket will be presented. A Support Panel may provide information about the status of the ticket and a dialogue box may streamline communication with personnel at the FlexFunds Operations or FlexETP system about an inquiry. Once the client has finished writing their message, they may click on Send.

Using the FlexManager, it is possible to issue a new FlexETP product. The client could click the New FlexETP tab and may begin the process of issuing a FlexETP Product. The client clicks on the drop down (Select asset type) and selects a product and then the list of products will be displayed. As shown in the screenshot of FIG. 11A, the client can click on the product that the client desires, such as the FlexETP Funds as a brokerage account, a FlexETP Wrapper or Private Shares or Fund, a FlexETP Loan as a private loan or a FlexETP Hybrid as private shares or private loan.

The client may fill out every key field at all sections of the Setup Process (Series Information, Administration, Figures and Fees, Investment Strategy Information, Interest, Signatory Information, Additional Comments and Notes). If the client is unsure as to what information to provide, the client may fill out the key field with “TBD.” Once the client has finished filling out all of the information pertaining to that step, the client may click on Submit New Request at the end of the page.

At this point, the client has established the FlexETP product. Once the client has completed the New FlexETP process, the client may view the information pertaining to that Series in the Manage Series tab. Under the Manage Series section such as shown in FIG. 11B, the client will be able to view a list of Series pertaining to their overall account. If the client does not have any Series, this section will be blank. Once the client has clicked on the Series, the client can view the tabs Series Details, Documentation and Series Status. A Series Details tab may provide the information about the series that the client has submitted.

It is possible to obtain documentation and reports using the FlexManager. The Documentation tab will allow the client to download a file, such as an Excel spreadsheet file, with the term sheet of the client's current series. While the series advance will be able to download more related documents, including example NAV sheets, fact sheets and other documents. A Series Status tab will allow the client to see the status of the FlexETP product such as what phase it is in and other details.

In the second phase of the process, the client may upload a signed engagement letter. The client would click on current Series, then click on the Documentation tab and click Upload Files (signed engagement letter section). At the end of the page, the client selects the Signed Engagement Letter file in their computer and clicks on Submit Documentation.

Referring now to FIGS. 12A through 12F, there is illustrated an example term sheet that shows details that can be included and displayed and printed such as Series information, dates, administration, figures and fees, an investment strategy and related information, the interest, any financial provisions, investment restrictions (if any), payment account information, other financially related information, further issuances and any data providers as interactive broker's account information.

This application is related to copending patent applications entitled, “SYSTEM FOR CONTROLLING DATA AND ISSUING CLIENT REPORTS ON EXCHANGE TRADED PRODUCTS AND ASSOCIATED METHOD” (Attorney Docket No. 0126959), and “SYSTEM FOR MANAGING FEES AND PAYMENTS ON EXCHANGE TRADED PRODUCTS AND ASSOCIATED METHOD” (Attorney Docket No. 0127326), and “SYSTEM FOR CONDUCTING AND BALANCING A SECURE FINANCIAL INVESTMENT OF A CLIENT AND ASSOCIATED METHOD” (Attorney Docket No. 0127352), which are filed on the same date and by the same assignee and inventors, the disclosures which are hereby incorporated by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system of issuing and managing financial assets for a plurality of clients, comprising:
a transaction server comprising a processor, memory and communications module;
a securities issuance server;
a communications network coupling the transaction server and securities issuance server;
wherein said transaction server is configured to receive over the communications network client data relating to a client request for an issuance of an exchange traded product (ETP) series as a security for derivatively priced investment assets, wherein said processor is configured to process the client data and generate client financial data and client documentation related to the request for the issuance of the ETP series based on the client data;
a database server network connected to said communications network and located remote from said transaction server, wherein said processor at the transaction server is configured to transmit via the communications module the client documentation over the communications network to the database server network and store the client documentation therein;
a non-relational database structured within the memory of the transaction server into which the client financial data is stored;
wherein said processor at the transaction server is configured to transmit via the communications module a request to the securities issuance server to issue the ETP series for the client, and in response, said securities issuance server issues the ETP series, wherein said issued ETP series comprises issued series data;
a relational database structured within the memory of the transaction server into which the issued series data regarding the issued ETP series is stored; and
wherein said processor is configured to track the changes in the issued series data and client financial data over time due to changes in the financial markets, the issued ETP series or the client financial data and periodically update the issued series data and client financial data within the relational and non-relational databases for maintenance and report generation.

2. The system according to claim 1 wherein said client documentation comprises legal documentation, Term Sheets, and Know-Your-Client (KYC) information for the issued ETP series.

3. The system according to claim 1 wherein said database server network comprises an on-demand cloud computing platform comprising at least one memory and database structured to store the client documentation for the plurality of clients, wherein data corresponding to client documentation is organized as scalable objects into data buckets and each identified with a user-assigned key for individual clients, and wherein a descriptive property is associated with objects to aid in tracking the client documentation for each client.

4. The system according to claim 3 wherein said database server network further comprises an access control list associated with each bucket and object and accessible via a user interface displayed at a user terminal in communication with said transaction server.

5. The system according to claim 1 wherein said relational database comprises a plurality of tables, wherein each table comprises an entity type for the issued ETP series.

6. The system according to claim 5 wherein said relational database comprises a structured query language database, wherein said processor at the transaction server is configured to access the issued series data by querying the relational database using a structured query language to retrieve the issued series data.

7. The system according to claim 1 wherein said non-relational database comprises client financial data configured into primary and secondary data categories, and including a primary and secondary index, wherein said processor is configured to execute field and range queries on the primary and secondary index for retrieving selected client financial data.

8. The system according to claim 1 wherein said securities issuance server comprises a server operated by a trustee authorized to issue an ETP series, wherein said issued ETP series includes an assigned ISIN.

9. A method of issuing and managing financial assets for a plurality of clients, comprising:
receiving over a communications network from each client and within a transaction server comprising a processor, memory, and communications module, client data relating to a client request for an issuance of an exchange traded product (ETP) series as a security for derivatively priced investment assets;
processing the client data within the processor at the transaction server and generating client financial data and client documentation related to the request of the ETP series based on the received client data;
transmitting the client documentation via the communications module over the communications network to a database server network located remote from the transaction server and storing the client documentation therein;
storing the client financial data within a non-relational database structured within the memory of the transaction server;
issuing the ETP series for each client, wherein the issued ETP series for each client comprises issued series data;
storing the issued series data regarding the issued ETP series within a relational database structured within the memory of the transaction server; and
tracking the changes in the issued series data and client financial data over time due to changes in the financial markets, the issued ETP series, or the client financial data and periodically updating the issued series data and client financial data within the relational and non-relational database for maintenance and report generation.

10. The method according to claim 9 wherein said client documentation comprises legal documentation, Term Sheets, and Know-Your-Client (KYC) information for the issued ETP series.

11. The method according to claim 9 comprising transmitting the client data from a remote client computer over the communications network to the transaction server.

12. The method according to claim 9 wherein said database server network comprises an on-demand cloud computing platform comprising at least one memory and database structured to store the client documentation for the plurality of clients, wherein data corresponding to client documentation is organized as scalable objects into data buckets and each identified with a user-assigned key for individual clients, and wherein a descriptive property is associated with objects to aid in tracking the client documentation for each client.

13. The method according to claim 12 wherein said database server network further comprises an access control list associated with each bucket and object and accessible via a user interface displayed at a user terminal in communication with said transaction server.

14. The method according to claim 9 wherein said relational database comprises a plurality of tables, wherein each table comprises an entity type for the issued ETP series.

15. The method according to claim 14 wherein said relational database comprises a structured query language database, wherein said processor at the transaction server is configured to access the issued series data by querying the relational database using a structured query language to retrieve the issued series data.

16. The method according to claim 9 wherein the ETP series is issued by transmitting from the transaction server via the communications module a request for issuing the ETP series over the communications network to a securities issuance server, and in response, issuing the ETP series at the securities issuance server.

17. The method according to claim 9 wherein the non-relational database comprises client financial data configured into primary and secondary data categories, and including a primary and secondary index, the method further comprising executing by the processor field and range queries on the primary and secondary index for retrieving selected client financial data.

18. A method of issuing and managing financial assets for a client, comprising:
accessing a transaction server from a remote computer operated by a client, wherein the transaction server comprises a processor, memory and communications module;
inputting at the remote computer client data and a request for an issuance of an exchange traded product (ETP) series as a security for derivatively priced investment assets;
transmitting the client data and the client request for the issuance of the ETP series from the remote computer of the client over a communications network to the transaction server;
processing the client data in the processor at the transaction server and generating client financial data and client documentation related to the ETP series based on the received client data;
transmitting the client documentation via the communications module over the communications network to a database server network and storing the client documentation therein;
storing the client financial data within a non-relational database structured within the memory of the transaction server, wherein the client financial data is configured into primary and secondary data categories and including primary and secondary indexes accessible via field and range queries;
transmitting a request for issuing the ETP series from the transaction server via the communications module over the communications network to a securities issuance server, and in response, issuing the ETP series at the securities issuance server, wherein the issued ETP series comprises issued series data;
storing the issued series data regarding the issued ETP series within a relational database structured within the memory of the transaction server, said relational database comprising a plurality of tables, each table comprises an entity type for an issued ETP series and accessible via a structured query language; and
tracking the changes in the issued series data and client financial data over time due to changes in the financial markets, the issued ETP series, or the client financial data and periodically updating the issued series data and client financial data within the relational and non-relational databases for maintenance and report generation.

19. The method according to claim 18 wherein said client documentation comprises legal documentation, Term Sheets, and Know-Your-Client (KYC) information for the ETP series.

20. The method according to claim 18 wherein said database server network comprises an on-demand cloud computing platform comprising at least one memory and database structured to store the client documentation for the plurality of clients, wherein data corresponding to client documentation is organized as scalable objects into data buckets and each identified with a user-assigned key for individual clients, and wherein a descriptive property is associated with objects to aid in tracking the client documentation for each client.

21. The method according to claim 20 wherein said database server network further comprises an access control list associated with each bucket and object and accessible via a user interface displayed at a user terminal in communication with said transaction server.
